(19) United States
(12) Patent Application Publication
(10) Pub. No.: US 2017/0164071 A1
(43) Pub. Date: Jun. 8, 2017

(54) BROADCAST SIGNAL TRANSMISSION APPARATUS, BROADCAST SIGNAL RECEPTION APPARATUS, BROADCAST SIGNAL TRANSMISSION METHOD, AND BROADCAST SIGNAL RECEPTION METHOD

(71) Applicant: LG ELECTRONICS INC., Seoul (KR)

(72) Inventors: Seungjoo AN, Seoul (KR); Minsung KWAK, Seoul (KR); Seungryul YANG, Seoul (KR); Kyoungsoo MOON, Seoul (KR); Jinwon LEE, Seoul (KR); Woosuk KO, SEOUL (KR); Sungryong HONG, Seoul (KR)

(73) Assignee: LG ELECTRONICS INC., Seoul (KR)

(21) Appl. No.: 15/433,801

(22) Filed: Feb. 15, 2017

Related U.S. Application Data
(63) Continuation of application No. PCT/KR2015/008593, filed on Aug. 18, 2015.
(60) Provisional application No. 62/039,423, filed on Aug. 20, 2014.

(51) Int. Cl. H04N 21/8358; H04N 21/2365; H04N 21/61

(52) U.S. Cl. CPC H04N 21/8358; H04N 21/6131; H04N 21/615; H04N 21/2365

(57) ABSTRACT

The present invention provides a method for providing mobile broadcast service in a TV receiver. The method may be a broadcast service providing method comprising the steps of: paring with a mobile device which is currently playing mobile broadcast contents; receiving audio and video components of the mobile broadcast contents from the mobile device and playing the components; extracting a watermark from the audio component or the video component; and obtaining signaling information associated with the mobile broadcast contents by using the watermark.

### TECHNICAL FIELD

The present invention relates to a broadcast signal transmission apparatus, a broadcast signal reception apparatus, and broadcast signal transmission and reception methods.

### BACKGROUND ART

As analog broadcast signal transmission is terminated, various technologies for transmitting and receiving a digital broadcast signal have been developed. A digital broadcast signal is capable of containing a larger amount of video/audio data than an analog broadcast signal and further containing various types of additional data as well as video/audio data.

### DISCLOSURE

### Technical Problem

That is, a digital broadcast system may provide a high definition (HD) image, multi channel audio, and various additional services. However, for digital broadcast, network flexibility obtained by considering data transmission efficiency for a large amount of data transmission, robustness of a transceiving network, and a mobile receiving apparatus needs to be enhanced.

### Technical Solution

To accomplish the object of the present invention, there is provided a method for providing mobile broadcast services by a TV receiver, which includes: pairing with a mobile device reproducing mobile broadcast content; receiving audio and video components of the mobile broadcast content from the mobile device and reproducing the audio and video components; extracting a watermark from the audio component or the video component; and acquiring signaling information related to the mobile broadcast content using the watermark.

The watermark may include URL information related to a signaling server, and the acquiring of the signaling information using the watermark may include generating a URL of the signaling server using the URL information.

In another aspect, the present invention provides a broadcast reception apparatus. The broadcast reception apparatus includes: a pairing module for pairing with a mobile device reproducing mobile broadcast content; an AV sharing module for receiving audio and video components of the mobile broadcast content from the mobile device; a display module for reproducing the received audio and video components; and an ACR module for extracting a watermark from the audio component or the video component, wherein the ACR module acquires signaling information related to the mobile broadcast content using the watermark.

The watermark may include URL information related to a signaling server, and the ACR module may generate a URL of the signaling server using the URL information.

### Advantageous Effects

As is apparent from the above description, the embodiments of the present invention can process data according to service characteristics to control QoS (Quality of Service) for each service or service component, thereby providing various broadcast services.

The embodiments of the present invention can achieve transmission flexibility by transmitting various broadcast services through the same radio frequency (RF) signal bandwidth.

The embodiments of the present invention can provide a method and apparatus, which are configured to receive digital broadcast signals without errors even with mobile reception equipment or in an indoor environment, for transmitting and receiving broadcast signals.

### DESCRIPTION OF DRAWINGS

FIG. 1 illustrates a structure of an apparatus for transmitting broadcast signals for future broadcast services according to an embodiment of the present invention;

FIG. 2 illustrates a BICM block according to an embodiment of the present invention;

FIG. 3 illustrates a frame building block according to one embodiment of the present invention;

FIG. 4 illustrates an OFDM generation block according to an embodiment of the present invention;

FIG. 5 is a block diagram illustrating the network topology according to the embodiment;

FIG. 6 is a block diagram illustrating a watermark based network topology according to an embodiment;

FIG. 7 is a ladder diagram illustrating a data flow in a watermark based network topology according to an embodiment;

FIG. 8 is a view illustrating a watermark based content recognition timing according to an embodiment;

FIG. 9 is a block diagram illustrating a fingerprint based network topology according to an embodiment;

FIG. 10 is a ladder diagram illustrating a data flow in a fingerprint based network topology according to an embodiment;

FIG. 11 is a view illustrating an XML schema diagram of ACR-Resulttype containing a query result according to an embodiment;

FIG. 12 is a block diagram illustrating a watermark and fingerprint based network topology according to an embodiment;

FIG. 13 is a ladder diagram illustrating a data flow in a watermark and fingerprint based network topology according to an embodiment;

FIG. 14 is a block diagram illustrating the video display device according to the embodiment;

FIG. 15 is a flowchart illustrating a method of synchronizing a playback time of a main AV content with a playback time of an enhanced service according to an embodiment;

FIG. 16 is a conceptual diagram illustrating a method of synchronizing a playback time of a main AV content with a playback time of an enhanced service according to an embodiment;

FIG. 17 is a block diagram illustrating a structure of a fingerprint based video display device according to another embodiment;

FIG. 18 is a block diagram illustrating a structure of a watermark based video display device according to another embodiment;

FIG. 19 is a diagram showing data which may be delivered via a watermarking scheme according to one embodiment of the present invention;

FIG. 20 is a diagram showing the meanings of the values of the time stamp type field according to one embodiment of the present invention;

FIG. 21 is a diagram showing meanings of values of a URL protocol type field according to one embodiment of the present invention;

FIG. 22 is a flowchart illustrating a process of processing a URL protocol type field according to one embodiment of the present invention;

FIG. 23 is a diagram showing the meanings of the values of an event field according to one embodiment of the present invention;

FIG. 24 is a diagram showing the meanings of the values of a destination type field according to one embodiment of the present invention;

FIG. 25 is a diagram showing the structure of data to be inserted into a WM according to embodiment #1 of the present invention;

FIG. 26 is a flowchart illustrating a process of processing a data structure to be inserted into a WM according to embodiment #1 of the present invention;

FIG. 27 is a diagram showing the structure of data to be inserted into a WM according to embodiment #2 of the present invention;

FIG. 28 is a flowchart illustrating a process of processing a data structure to be inserted into a WM according to embodiment #2 of the present invention;

FIG. 29 is a diagram showing the structure of data to be inserted into a WM according to embodiment #3 of the present invention;

FIG. 30 is a diagram showing the structure of data to be inserted into a WM according to embodiment #4 of the present invention;

FIG. 31 is a diagram showing the structure of data to be inserted into a first WM according to embodiment #4 of the present invention;

FIG. 32 is a diagram showing the structure of data to be inserted into a second WM according to embodiment #4 of the present invention;

FIG. 33 is a flowchart illustrating a process of processing the structure of data to be inserted into a WM according to embodiment #4 of the present invention;

FIG. 34 is a diagram showing the structure of a watermark based image display apparatus according to another embodiment of the present invention;

FIG. 35 is a diagram showing a data structure according to one embodiment of the present invention in a fingerprinting scheme;

FIG. 36 is a flowchart illustrating a process of processing a data structure according to one embodiment of the present invention in a fingerprinting scheme;

FIG. 37 is a view showing a broadcast receiver according to an embodiment of the present invention;

FIG. 38 is a diagram illustrating an ACR transceiving system in a multicast environment according to an embodiment of the present invention;

FIG. 39 is a diagram of an ACR transceiving system via a WM in a multicast environment according to an embodiment of the present invention;

FIG. 40 is a diagram illustrating an ACR transceiving system via an FP scheme in a multicast environment according to an embodiment of the present invention;

FIG. 41 is a flowchart of performing of signaling associated with broadcast via an ACR scheme in a multicast environment by a receiver according to an embodiment of the present invention;

FIG. 42 is a diagram illustrating an ACR transceiving system in a mobile network environment according to an embodiment of the present invention;

FIG. 43 is a diagram illustrating a process of receiving signaling information through a mobile broadband by a receiver according to another embodiment of the present invention;

FIG. 44 is a diagram illustrating the concept of a hybrid broadcast service according to an embodiment of the present invention.

FIG. 45 is a diagram illustrating an ACR transceiving system in a mobile network environment according to another embodiment of the present invention;

FIG. 46 is a view showing an UPnP type Action mechanism according to an embodiment of the present invention;

FIG. 47 is a view showing a REST mechanism according to an embodiment of the present invention;

FIG. 48 illustrates an ACR (Auto Content Recognition) procedure using a watermark in an AV (Audio Video) sharing environment according to an embodiment of the present invention;

FIG. 49 illustrates an ACR procedure using a watermark/fingerprint in an AV sharing environment according to an embodiment of the present invention;

FIG. 50 is a diagram illustrating an ACR procedure using a fingerprint in an AV sharing environment according to an embodiment of the present invention;

FIG. 51 illustrates an ACR procedure using a watermark in an AV sharing environment according to another embodiment of the present invention;

FIG. 52 illustrates an ACR procedure using a watermark/fingerprint in an AV sharing environment according to another embodiment of the present invention;

FIG. 53 illustrates an ACR procedure using a watermark/fingerprint in an AV sharing environment according to another embodiment of the present invention;

FIG. 54 is a diagram illustrating an ACR procedure using a fingerprint in an AV sharing environment according to an embodiment of the present invention;

FIG. 55 illustrates a method of providing mobile broadcast services by a TV receiver according to an embodiment of the present invention; and

FIG. 56 illustrates a broadcast reception apparatus providing mobile broadcast services according to an embodiment of the present invention.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

Although most terms of elements in this specification have been selected from general ones widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings.

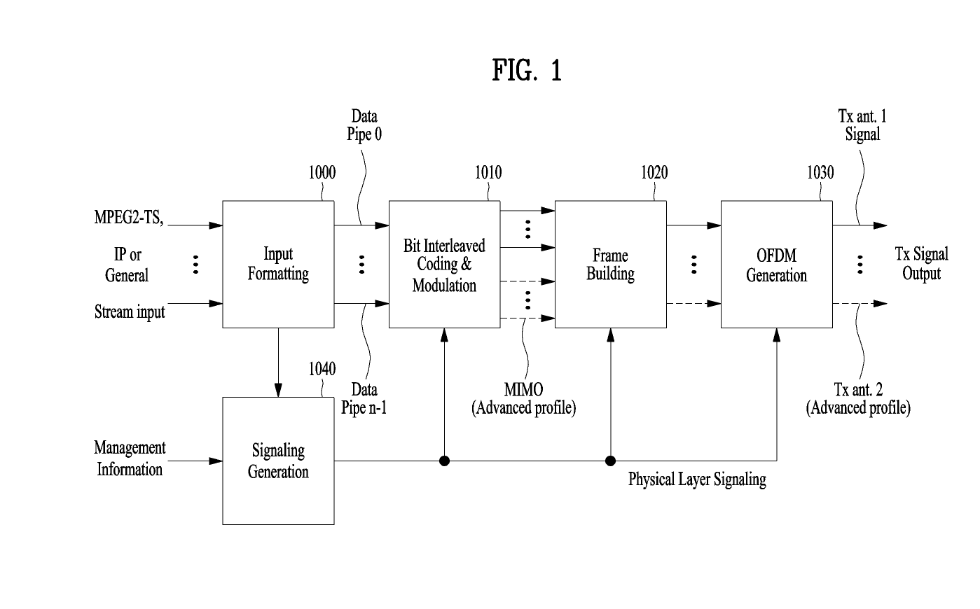

The present invention provides apparatuses and methods for transmitting and receiving broadcast signals for future broadcast services. Future broadcast services according to an embodiment of the present invention include a terrestrial broadcast service, a mobile broadcast service, a UHDTV service, etc. FIG. 1 illustrates a structure of an apparatus for transmitting broadcast signals for future broadcast services according to an embodiment of the present invention.

The apparatus for transmitting broadcast signals for future broadcast services according to an embodiment of the present invention can include an input formatting block 1000, a BICM (Bit interleaved coding & modulation) block 1010, a frame building block 1020, an OFDM (Orthogonal Frequency Division Multiplexing) generation block 1030 and a signaling generation block 1040. A description will be given of the operation of each module of the apparatus for transmitting broadcast signals.

IP stream/packets and MPEG2-TS are the main input formats, other stream types are handled as General Streams. In addition to these data inputs, Management Information is input to control the scheduling and allocation of the corresponding bandwidth for each input stream. One or multiple TS stream(s), IP stream(s) and/or General Stream(s) inputs are simultaneously allowed.

The input formatting block 1000 can demultiplex each input stream into one or multiple data pipe(s), to each of which an independent coding and modulation is applied. The data pipe (DP) is the basic unit for robustness control, thereby affecting quality-of-service (QoS). One or multiple service(s) or service component(s) can be carried by a single DP. Details of operations of the input formatting block 1000 will be described later.

The data pipe is a logical channel in the physical layer that carries service data or related metadata, which may carry one or multiple service(s) or service component(s).

Also, the data pipe unit: a basic unit for allocating data cells to a DP in a frame.

In the BICM block 1010, parity data is added for error correction and the encoded bit streams are mapped to complex-value constellation symbols. The symbols are interleaved across a specific interleaving depth that is used for the corresponding DP. For the advanced profile, MIMO encoding is performed in the BICM block 1010 and the additional data path is added at the output for MIMO transmission. Details of operations of the BICM block 1010 will be described later.

The Frame Building block 1020 can map the data cells of the input DPs into the OFDM symbols within a frame. After mapping, the frequency interleaving is used for frequency-domain diversity, especially to combat frequency-selective fading channels. Details of operations of the Frame Building block 1020 will be described later.

After inserting a preamble at the beginning of each frame, the OFDM Generation block 1030 can apply conventional OFDM modulation having a cyclic prefix as guard interval. For antenna space diversity, a distributed MISO scheme is applied across the transmitters. In addition, a Peak-to-Average Power Reduction (PAPR) scheme is performed in the time domain. For flexible network planning, this proposal provides a set of various FFT sizes, guard interval lengths and corresponding pilot patterns. Details of operations of the OFDM Generation block 1030 will be described later.

The Signaling Generation block 1040 can create physical layer signaling information used for the operation of each functional block. This signaling information is also transmitted so that the services of interest are properly recovered at the receiver side. Details of operations of the Signaling Generation block 1040 will be described later.

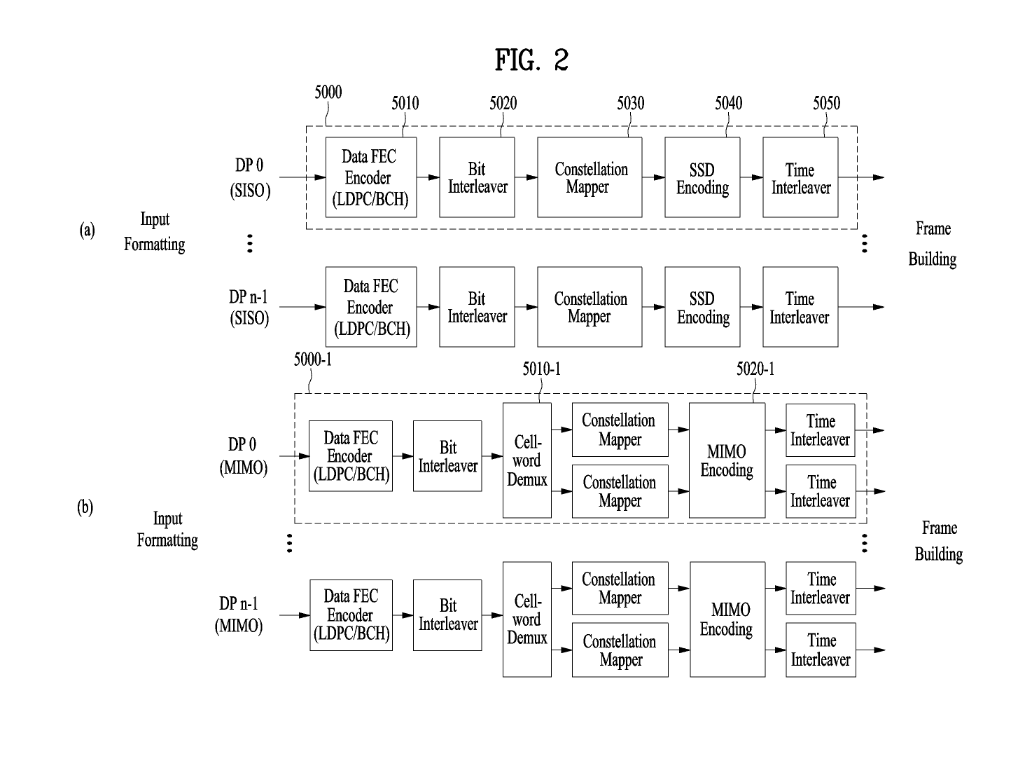

FIG. 2 illustrates a BICM block according to an embodiment of the present invention.

The BICM block illustrated in FIG. 2 corresponds to an embodiment of the BICM block 1010 described with reference to FIG. 1.

As described above, the apparatus for transmitting broadcast signals for future broadcast services according to an embodiment of the present invention can provide a terrestrial broadcast service, mobile broadcast service, UHDTV service, etc.

Since QoS (quality of service) depends on characteristics of a service provided by the apparatus for transmitting broadcast signals for future broadcast services according to an embodiment of the present invention, data corresponding to respective services needs to be processed through different schemes. Accordingly, the a BICM block according to an embodiment of the present invention can independently process DPs input thereto by independently applying SISO, MISO and MIMO schemes to the data pipes respectively corresponding to data paths. Consequently, the apparatus for transmitting broadcast signals for future broadcast services according to an embodiment of the present invention can control QoS for each service or service component transmitted through each DP.

(a) shows the BICM block shared by the base profile and the handheld profile and (b) shows the BICM block of the advanced profile.

The BICM block shared by the base profile and the handheld profile and the BICM block of the advanced profile can include plural processing blocks for processing each DP.

A description will be given of each processing block of the BICM block for the base profile and the handheld profile and the BICM block for the advanced profile.

A processing block 5000 of the BICM block for the base profile and the handheld profile can include a Data FEC encoder 5010, a bit interleaver 5020, a constellation mapper 5030, an SSD (Signal Space Diversity) encoding block 5040 and a time interleaver 5050.

The Data FEC encoder 5010 can perform the FEC encoding on the input BBF to generate FECBLOCK procedure using outer coding (BCH), and inner coding (LDPC). The outer coding (BCH) is optional coding method. Details of operations of the Data FEC encoder 5010 will be described later.

The bit interleaver 5020 can interleave outputs of the Data FEC encoder 5010 to achieve optimized performance with combination of the LDPC codes and modulation scheme while providing an efficiently implementable structure. Details of operations of the bit interleaver 5020 will be described later.

The constellation mapper 5030 can modulate each cell word from the bit interleaver 5020 in the base and the handheld profiles, or cell word from the Cell-word demultiplexer 5010-1 in the advanced profile using either QPSK, QAM-16, non-uniform QAM (NUQ-64, NUQ-256, NUQ-1024) or non-uniform constellation (NUC-16, NUC-64, NUC-256, NUC-1024) to give a power-normalized constellation point, e1. This constellation mapping is applied only for DPs. Observe that QAM-16 and NUQs are square shaped, while NUCs have arbitrary shape. When each constellation is rotated by any multiple of 90 degrees, the rotated constellation exactly overlaps with its original one. This “rotation-sense” symmetric property makes the capacities and the average powers of the real and imaginary components equal to each other. Both NUQs and NUCs are defined specifically for each code rate and the particular one used is signaled by the parameter DP_MOD filed in PLS2 data.

The time interleaver 5050 can operates at the DP level. The parameters of time interleaving (TI) may be set differently for each DP. Details of operations of the time interleaver 5050 will be described later.

A processing block 5000-1 of the BICM block for the advanced profile can include the Data FEC encoder, bit interleaver, constellation mapper, and time interleaver.

However, the processing block 5000-1 is distinguished from the processing block 5000 further includes a cell-word demultiplexer 5010-1 and a MIMO encoding block 5020-1.

Also, the operations of the Data FEC encoder, bit interleaver, constellation mapper, and time interleaver in the processing block 5000-1 correspond to those of the Data FEC encoder 5010, bit interleaver 5020, constellation mapper 5030, and time interleaver 5050 described and thus description thereof is omitted.

The cell-word demultiplexer 5010-1 is used for the DP of the advanced profile to divide the single cell-word stream into dual cell-word streams for MIMO processing. Details of operations of the cell-word demultiplexer 5010-1 will be described later.

The MIMO encoding block 5020-1 can processing the output of the cell-word demultiplexer 5010-1 using MIMO encoding scheme. The MIMO encoding scheme was optimized for broadcasting signal transmission. The MIMO technology is a promising way to get a capacity increase but it depends on channel characteristics. Especially for broadcasting, the strong LOS component of the channel or a difference in the received signal power between two antennas caused by different signal propagation characteristics makes it difficult to get capacity gain from MIMO. The proposed MIMO encoding scheme overcomes this problem using a rotation-based pre-coding and phase randomization of one of the MIMO output signals.

The above-described blocks may be omitted or replaced by blocks having similar or identical functions.

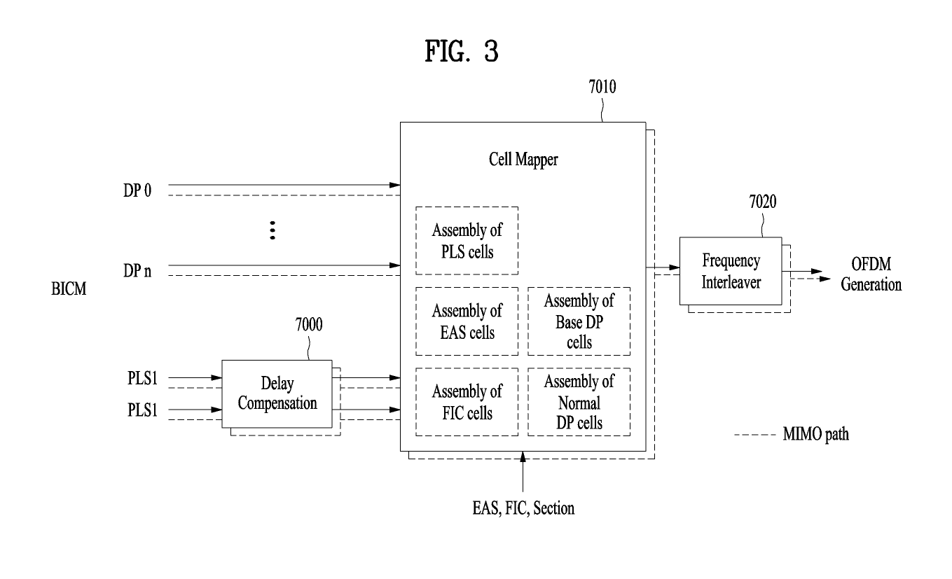

FIG. 3 illustrates a frame building block according to one embodiment of the present invention.

The frame building block illustrated in FIG. 3 corresponds to an embodiment of the frame building block 1020 described with reference to FIG. 1.

Referring to FIG. 3, the frame building block can include a delay compensation block 7000, a cell mapper 7010 and a frequency interleaver 7020. Description will be given of each block of the frame building block.

The delay compensation block 7000 can adjust the timing between the data pipes and the corresponding PLS data to ensure that they are co-timed at the transmitter end. The PLS data is delayed by the same amount as data pipes are by addressing the delays of data pipes caused by the Input Formatting block and BICM block. The delay of the BICM block is mainly due to the time interleaver 5050. In-band signaling data carries information of the next TI group so that they are carried one frame ahead of the DPs to be signaled. The Delay Compensating block delays in-band signaling data accordingly.

The cell mapper 7010 can map PLS, EAC, FIC, DPs, auxiliary streams and dummy cells into the active carriers of the OFDM symbols in the frame. The basic function of the cell mapper 7010 is to map data cells produced by the TIs for each of the DPs, PLS cells, and EAC/FIC cells, if any, into arrays of active OFDM cells corresponding to each of the OFDM symbols within a frame. Service signaling data (such as PSI (program specific information)/SI) can be separately gathered and sent by a data pipe. The Cell Mapper operates according to the dynamic information produced by the scheduler and the configuration of the frame structure. Details of the frame will be described later.

The frequency interleaver 7020 can randomly interleave data cells received from the cell mapper 7010 to provide frequency diversity. Also, the frequency interleaver 7020 can operate on very OFDM symbol pair comprised of two sequential OFDM symbols using a different interleaving-seed order to get maximum interleaving gain in a single frame.

The above-described blocks may be omitted or replaced by blocks having similar or identical functions.

FIG. 4 illustrates an OFDM generation block according to an embodiment of the present invention.

The OFDM generation block illustrated in FIG. 4 corresponds to an embodiment of the OFDM generation block 1030 described with reference to FIG. 1.

The OFDM generation block modulates the OFDM carriers by the cells produced by the Frame Building block, inserts the pilots, and produces the time domain signal for transmission. Also, this block subsequently inserts guard intervals, and applies PAPR (Peak-to-Average Power Radio) reduction processing to produce the fmal RF signal.

Referring to FIG. 4, the OFDM generation block can include a pilot and reserved tone insertion block 8000, a 2D-eSFN encoding block 8010, an IFFT (Inverse Fast Fourier Transform) block 8020, a PAPR reduction block 8030, a guard interval insertion block 8040, a preamble insertion block 8050, other system insertion block 8060 and a DAC block 8070.

The other system insertion block 8060 can multiplex signals of a plurality of broadcast transmission/reception systems in the time domain such that data of two or more different broadcast transmission/reception systems providing broadcast services can be simultaneously transmitted in the same RF signal bandwidth. In this case, the two or more different broadcast transmission/reception systems refer to systems providing different broadcast services. The different broadcast services may refer to a terrestrial broadcast service, mobile broadcast service, etc.

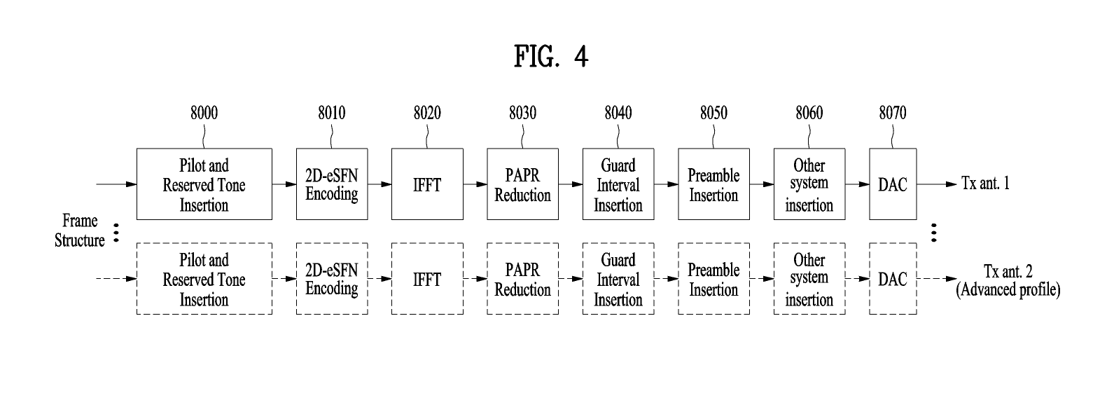

FIG. 5 is a block diagram illustrating the network topology according to the embodiment.

As shown in FIG. 5, the network topology includes a content providing server 10, a content recognizing service providing server 20, a multi channel video distributing server 30, an enhanced service information providing server 40, a plurality of enhanced service providing servers 50, a broadcast receiving device 60, a network 70, and a video display device 100.

The content providing server 10 may correspond to a broadcasting station and broadcasts a broadcast signal including main audio-visual contents. The broadcast signal may further include enhanced services. The enhanced services may or may not relate to main audio-visual contents. The enhanced services may have formats such as service information, metadata, additional data, compiled execution files, web applications, Hypertext Markup Language (HTML) documents, XML documents, Cascading Style Sheet (CSS) documents, audio files, video files, ATSC 2.0 contents, and addresses such as Uniform Resource Locator (URL). There may be at least one content providing server.

The content recognizing service providing server 20 provides a content recognizing service that allows the video display device 100 to recognize content on the basis of main audio-visual content. The content recognizing service providing server 20 may or may not edit the main audio-visual content. There may be at least one content recognizing service providing server.

The content recognizing service providing server 20 may be a watermark server that edits the main audio-visual content to insert a visible watermark, which may look a logo, into the main audio-visual content. This watermark server may insert the logo of a content provider at the upper-left or upper-right of each frame in the main audiovisual content as a watermark.

Additionally, the content recognizing service providing server 20 may be a watermark server that edits the main audio-visual content to insert content information into the main audio-visual content as an invisible watermark.

Additionally, the content recognizing service providing server 20 may be a fingerprint server that extracts feature information from some frames or audio samples of the main audio-visual content and stores it. This feature information is called signature.

The multi channel video distributing server 30 receives and multiplexes broadcast signals from a plurality of broadcasting stations and provides the multiplexed broadcast signals to the broadcast receiving device 60. Especially, the multi channel video distributing server 30 performs demodulation and channel decoding on the received broadcast signals to extract main audio-visual content and enhanced service, and then, performs channel encoding on the extracted main audio-visual content and enhanced service to generate a multiplexed signal for distribution. At this point, since the multi channel video distributing server 30 may exclude the extracted enhanced service or may add another enhanced service, a broadcasting station may not provide services led by it. There may be at least one multi channel video distributing server.

The broadcasting device 60 may tune a channel selected by a user and receives a signal of the tuned channel, and then, performs demodulation and channel decoding on the received signal to extract a main audio-visual content. The broadcasting device 60 decodes the extracted main audio-visual content through H.264/Moving Picture Experts Group-4 advanced video coding (MPEG-4 AVC), Dolby AC-3 or Moving Picture Experts Group-2 Advanced Audio Coding (MPEG-2 AAC) algorithm to generate an uncompressed main audio-visual (AV) content. The broadcast receiving device 60 provides the generated uncompressed main AV content to the video display device 100 through its external input port.

The enhanced service information providing server 40 provides enhanced service information on at least one available enhanced service relating to a main AV content in response to a request of a video display device. There may be at least one enhanced service providing server. The enhanced service information providing server 40 may provide enhanced service information on the enhanced service having the highest priority among a plurality of available enhanced services.

The enhanced service providing server 50 provides at least one available enhanced service relating to a main AV content in response to a request of a video display device. There may be at least one enhanced service providing server.

The video display device 100 may be a television, a notebook computer, a hand phone, and a smart phone, each including a display unit. The video display device 100 may receive an uncompressed main AV content from the broadcast receiving device 60 or a broadcast signal including an encoded main AV content from the contents providing server 10 or the multi channel video distributing server 30. The video display device 100 may receive a content recognizing service from the content recognizing service providing server 20 through the network 70, an address of at least one available enhanced service relating to a main AV content from the enhanced service information providing server 40 through the network 70, and at least one available enhanced service relating to a main AV content from the enhanced service providing server 50.

At least two of the content providing server 10, the content recognizing service providing server 20, the multi channel video distributing server 30, the enhanced service information providing server 40, and the plurality of enhanced service providing servers 50 may be combined in a form of one server and may be operated by one provider.

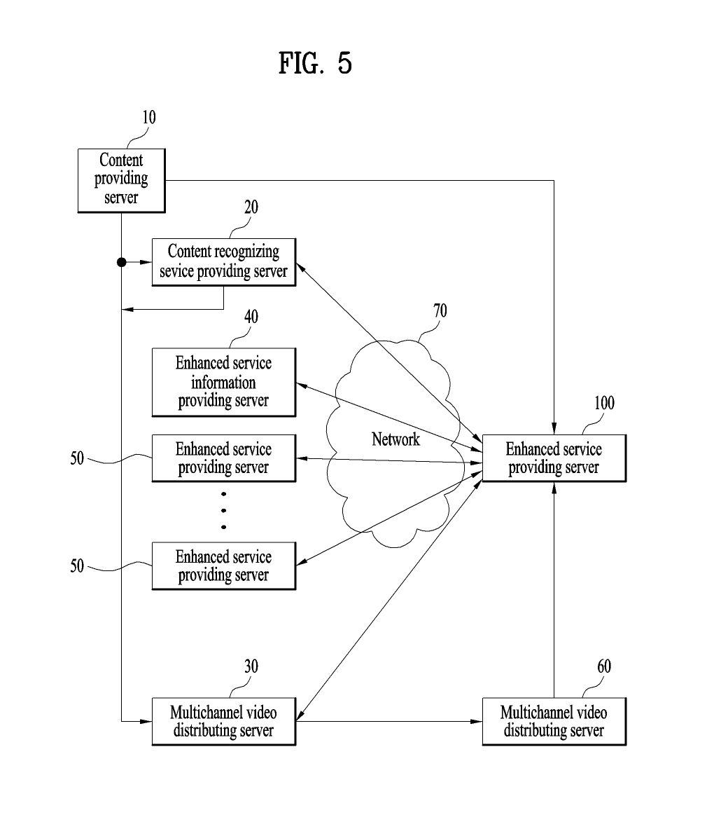

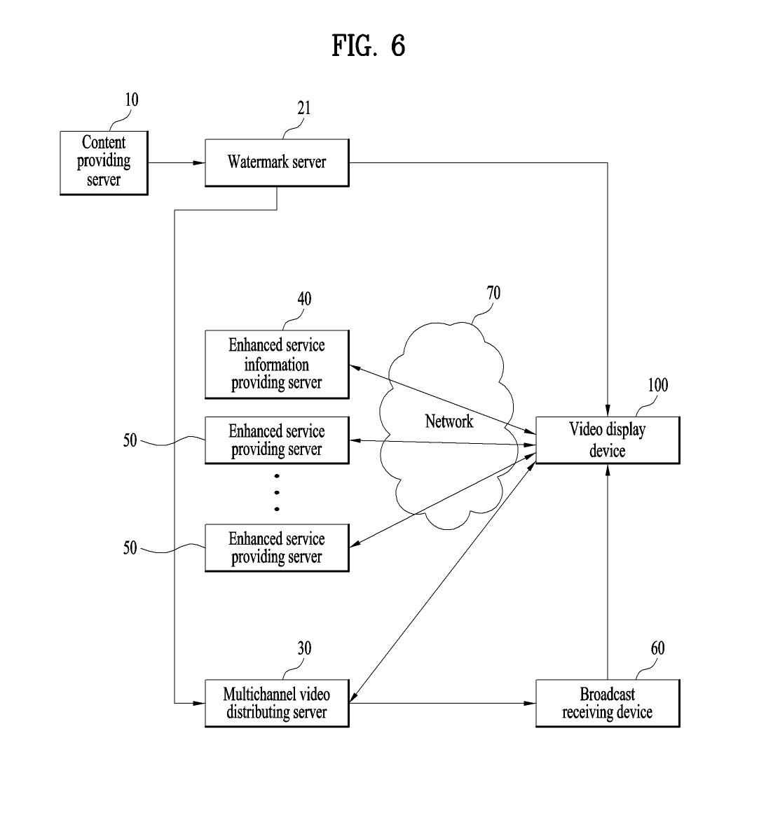

FIG. 6 is a block diagram illustrating a watermark based network topology according to an embodiment.

As shown in FIG. 6, the watermark based network topology may further include a watermark server 21.

As shown in FIG. 6, the watermark server 21 edits a main AV content to insert content information into it. The multi channel video distributing server 30 may receive and distribute a broadcast signal including the modified main AV content. Especially, a watermark server may use a digital watermarking technique described below.

A digital watermark is a process for inserting information, which may be almost undeletable, into a digital signal. For example, the digital signal may be audio, picture, or video. If the digital signal is copied, the inserted information is included in the copy. One digital signal may carry several different watermarks simultaneously.

In visible watermarking, the inserted information may be identifiable in a picture or video. Typically, the inserted information may be a text or logo identifying a media owner. If a television broadcasting station adds its logo in a corner of a video, this is an identifiable watermark.

In invisible watermarking, although information as digital data is added to audio, picture, or video, a user may be aware of a predetermined amount of information but may not recognize it. A secret message may be delivered through the invisible watermarking.

One application of the watermarking is a copyright protection system for preventing the illegal copy of digital media. For example, a copy device obtains a watermark from digital media before copying the digital media and determines whether to copy or not on the bases of the content of the watermark.

Another application of the watermarking is source tracking of digital media. A watermark is embedded in the digital media at each point of a distribution path. If such digital media is found later, a watermark may be extracted from the digital media and a distribution source may be recognized from the content of the watermark.

Another application of invisible watermarking is a description for digital media.

A file format for digital media may include additional information called metadata and a digital watermark is distinguished from metadata in that it is delivered as an AV signal itself of digital media.

The watermarking method may include spread spectrum, quantization, and amplitude modulation.

If a marked signal is obtained through additional editing, the watermarking method corresponds to the spread spectrum. Although it is known that the spread spectrum watermark is quite strong, not much information is contained because the watermark interferes with an embedded host signal.

If a marked signal is obtained through the quantization, the watermarking method corresponds to a quantization type. The quantization watermark is weak, much information may be contained.

If a marked signal is obtained through an additional editing method similar to the spread spectrum in a spatial domain, a watermarking method corresponds to the amplitude modulation.

FIG. 7 is a ladder diagram illustrating a data flow in a watermark based network topology according to an embodiment.

First, the content providing server 10 transmits a broadcast signal including a main AV content and an enhanced service in operation S101.

The watermark server 21 receives a broadcast signal that the content providing server 10 provides, inserts a visible watermark such as a logo or watermark information as an invisible watermark into the main AV content by editing the main AV content, and provides the watermarked main AV content and enhanced service to the MVPD 30 in operation S103.

The watermark information inserted through an invisible watermark may include at least one of a watermark purpose, content information, enhanced service information, and an available enhanced service. The watermark purpose represents one of illegal copy prevention, viewer ratings, and enhanced service acquisition.

The content information may include at least one of identification information of a content provider that provides main AV content, main AV content identification information, time information of a content section used in content information acquisition, names of channels through which main AV content is broadcasted, logos of channels through which main AV content is broadcasted, descriptions of channels through which main AV content is broadcasted, a usage information reporting period, the minimum usage time for usage information acquisition, and available enhanced service information relating to main AV content.

If the video display device 100 uses a watermark to acquire content information, the time information of a content section used for content information acquisition may be the time information of a content section into which a watermark used is embedded. If the video display device 100 uses a fingerprint to acquire content information, the time information of a content section used for content information acquisition may be the time information of a content section where feature information is extracted. The time information of a content section used for content information acquisition may include at least one of the start time of a content section used for content information acquisition, the duration of a content section used for content information acquisition, and the end time of a content section used for content information acquisition.

The usage information reporting address may include at least one of a main AV content watching information reporting address and an enhanced service usage information reporting address. The usage information reporting period may include at least one of a main AV content watching information reporting period and an enhanced service usage information reporting period. A minimum usage time for usage information acquisition may include at least one of a minimum watching time for a main AV content watching information acquisition and a minimum usage time for enhanced service usage information extraction.

On the basis that a main AV content is watched for more than the minimum watching time, the video display device 100 acquires watching information of the main AV content and reports the acquired watching information to the main AV content watching information reporting address in the main AV content watching information reporting period.

On the basis that an enhanced service is used for more than the minimum usage time, the video display device 100 acquires enhanced service usage information and reports the acquired usage information to the enhanced service usage information reporting address in the enhanced service usage information reporting period.

The enhanced service information may include at least one of information on whether an enhanced service exists, an enhanced service address providing server address, an acquisition path of each available enhanced service, an address for each available enhanced service, a start time of each available enhanced service, an end time of each available enhanced service, a lifetime of each available enhanced service, an acquisition mode of each available enhanced service, a request period of each available enhanced service, priority information each available enhanced service, description of each available enhanced service, a category of each available enhanced service, a usage information reporting address, a usage information reporting period, and the minimum usage time for usage information acquisition.

The acquisition path of available enhanced service may be represented with IP or Advanced Television Systems Committee-Mobile/Handheld (ATSC M/H). If the acquisition path of available enhanced service is ATSC M/H, enhanced service information may further include frequency information and channel information. An acquisition mode of each available enhanced service may represent Push or Pull.

Moreover, the watermark server 21 may insert watermark information as an invisible watermark into the logo of a main AV content.

For example, the watermark server 21 may insert a barcode at a predetermined position of a logo. At this point, the predetermined position of the logo may correspond to the first line at the bottom of an area where the logo is displayed. The video display device 100 may not display a barcode when receiving a main AV content including a logo with the barcode inserted.

For example, the watermark server 21 may insert a barcode at a predetermined position of a logo. At this point, the log may maintain its form.

For example, the watermark server 21 may insert N-bit watermark information at each of the logos of M frames. That is, the watermark server 21 may insert M*N watermark information in M frames.

The MVPD 30 receives broadcast signals including watermarked main AV content and enhanced service and generates a multiplexed signal to provide it to the broadcast receiving device 60 in operation S105. At this point, the multiplexed signal may exclude the received enhanced service or may include new enhanced service.

The broadcast receiving device 60 tunes a channel that a user selects and receives signals of the tuned channel, demodulates the received signals, performs channel decoding and AV decoding on the demodulated signals to generate an uncompressed main AV content, and then, provides the generated uncompressed main AV content to the video display device 100 in operation S106.

Moreover, the content providing server 10 also broadcasts a broadcast signal including a main AV content through a wireless channel in operation S107.

Additionally, the MVPD 30 may directly transmit a broadcast signal including a main AV content to the video display device 100 without going through the broadcast receiving device 60 in operation S108.

The video display device 100 may receive an uncompressed main AV content through the broadcast receiving device 60. Additionally, the video display device 100 may receive a broadcast signal through a wireless channel, and then, may demodulate and decode the received broadcast signal to obtain a main AV content. Additionally, the video display device 100 may receive a broadcast signal from the MVPD 30, and then, may demodulate and decode the received broadcast signal to obtain a main AV content. The video display device 100 extracts watermark information from some frames or a section of audio samples of the obtained main AV content. If watermark information corresponds to a logo, the video display device 100 confirms a watermark server address corresponding to a logo extracted from a corresponding relationship between a plurality of logos and a plurality of watermark server addresses. When the watermark information corresponds to the logo, the video display device 100 cannot identify the main AV content only with the logo. Additionally, when the watermark information does not include content information, the video display device 100 cannot identify the main AV content but the watermark information may include content provider identifying information or a watermark server address. When the watermark information includes the content provider identifying information, the video display device 100 may confirm a watermark server address corresponding to the content provider identifying information extracted from a corresponding relationship between a plurality of content provider identifying information and a plurality of watermark server addresses. In this manner, when the video display device 100 cannot identify a main AV content the video display device 100 only with the watermark information, it accesses the watermark server 21 corresponding to the obtained watermark server address to transmit a first query in operation S109.

The watermark server 21 provides a first reply to the first query in operation S111. The first reply may include at least one of content information, enhanced service information, and an available enhanced service.

If the watermark information and the first reply do not include an enhanced service address, the video display device 100 cannot obtain enhanced service. However, the watermark information and the first reply may include an enhanced service address providing server address. In this manner, the video display device 100 does not obtain a service address or enhanced service through the watermark information and the first reply. If the video display device 100 obtains an enhanced service address providing server address, it accesses the enhanced service information providing server 40 corresponding to the obtained enhanced service address providing server address to transmit a second query including content information in operation S119.

The enhanced service information providing server 40 searches at least one available enhanced service relating to the content information of the second query. Later, the enhanced service information providing server 40 provides to the video display device 100 enhanced service information for at least one available enhanced service as a second reply to the second query in operation S121.

If the video display device 100 obtains at least one available enhanced service address through the watermark information, the first reply, or the second reply, it accesses the at least one available enhanced service address to request enhanced service in operation S123, and then, obtains the enhanced service in operation S125.

FIG. 8 is a view illustrating a watermark based content recognition timing according to an embodiment.

As shown in FIG. 8, when the broadcast receiving device 60 is turned on and tunes a channel, and also, the video display device 100 receives a main AV content of the turned channel from the broadcast receiving device 60 through an external input port 111, the video display device 100 may sense a content provider identifier (or a broadcasting station identifier) from the watermark of the main AV content. Then, the video display device 100 may sense content information from the watermark of the main AV content on the basis of the sensed content provider identifier.

At this point, as shown in FIG. 8, the detection available period of the content provider identifier may be different from that of the content information. Especially, the detection available period of the content provider identifier may be shorter than that of the content information. Through this, the video display device 100 may have an efficient configuration for detecting only necessary information.

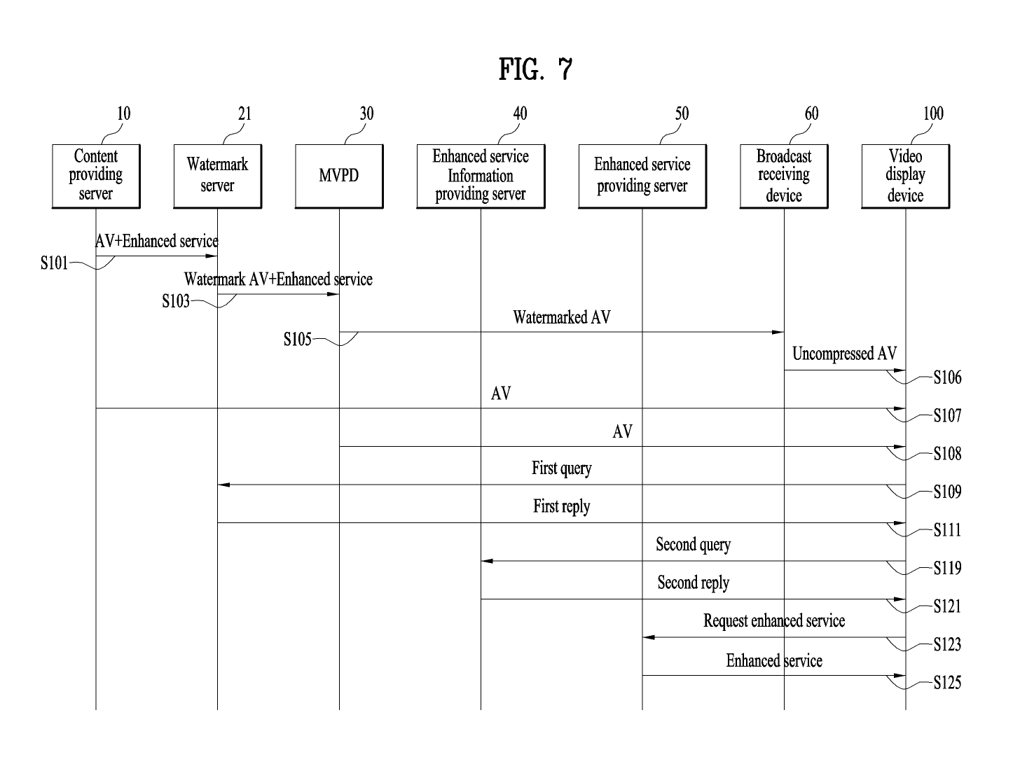

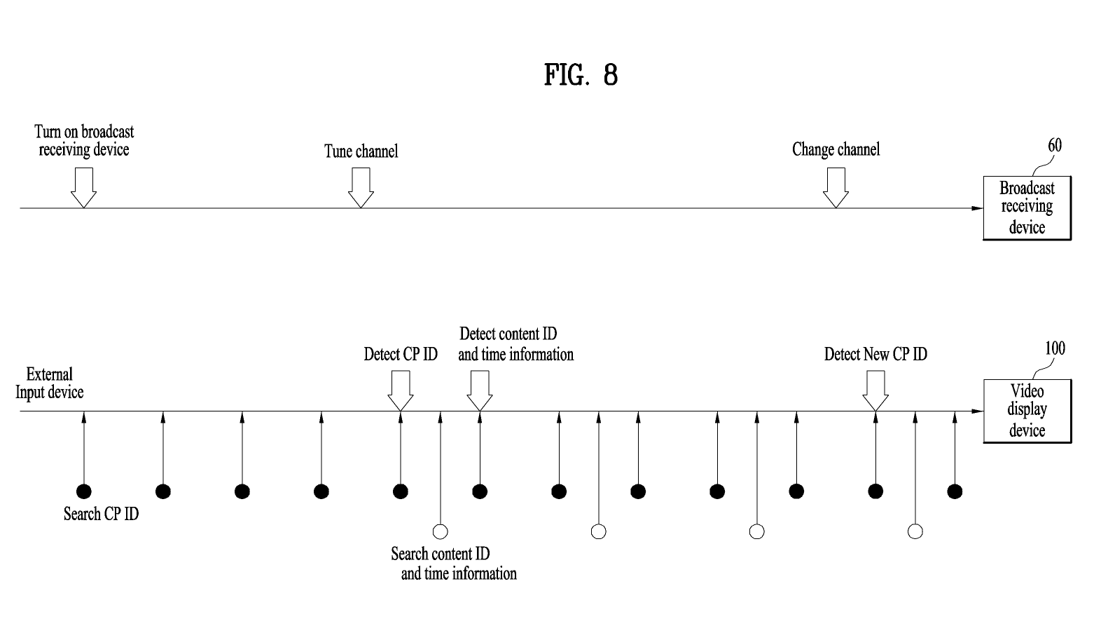

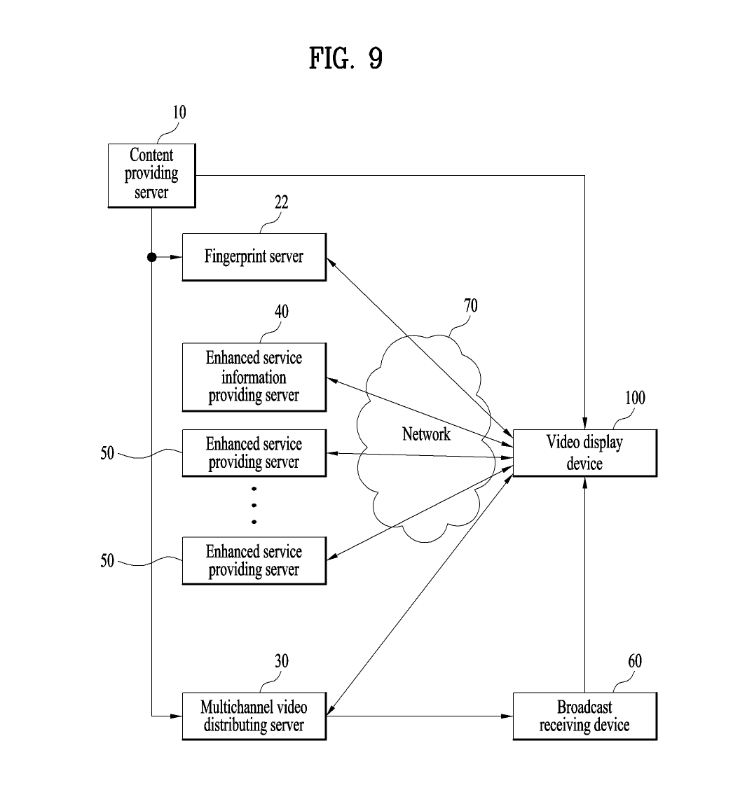

FIG. 9 is a block diagram illustrating a fingerprint based network topology according to an embodiment.

As shown in FIG. 9, the network topology may further include a fingerprint server 22.

As shown in FIG. 9, the fingerprint server 22 does not edit a main AV content, but extracts feature information from some frames or a section of audio samples of the main AV content and stores the extracted feature information. Then, when receiving the feature information from the video display device 100, the fingerprint server 22 provides an identifier and time information of an AV content corresponding to the received feature information.

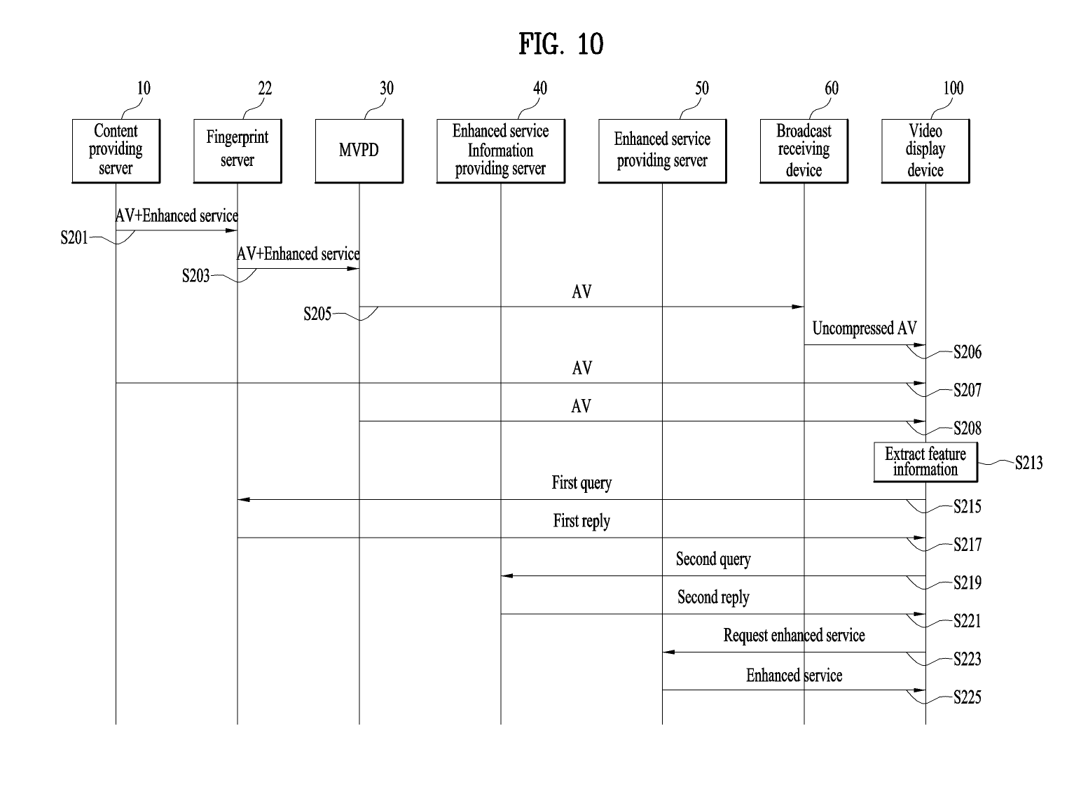

FIG. 10 is a ladder diagram illustrating a data flow in a fingerprint based network topology according to an embodiment.

First, the content providing server 10 transmits a broadcast signal including a main AV content and an enhanced service in operation S201.

The fingerprint server 22 receives a broadcast signal that the content providing server 10, extracts a plurality of pieces of feature information from a plurality of frame sections or a plurality of audio sections of the main AV content, and establishes a database for a plurality of query results corresponding to the plurality of feature information in operation S203. The query result may include at least one of content information, enhanced service information, and an available enhanced service.

The MVPD 30 receives broadcast signals including a main AV content and enhanced service and generates a multiplexed signal to provide it to the broadcast receiving device 60 in operation S205. At this point, the multiplexed signal may exclude the received enhanced service or may include new enhanced service.

The broadcast receiving device 60 tunes a channel that a user selects and receives signals of the tuned channel, demodulates the received signals, performs channel decoding and AV decoding on the demodulated signals to generate an uncompressed main AV content, and then, provides the generated uncompressed main AV content to the video display device 100 in operation S206.

Moreover, the content providing server 10 also broadcasts a broadcast signal including a main AV content through a wireless channel in operation S207.

Additionally, the MVPD 30 may directly transmit a broadcast signal including a main AV content to the video display device 100 without going through the broadcast receiving device 60.

The video display device 100 may receive an uncompressed main AV content through the broadcast receiving device 60. Additionally, the video display device 100 may receive a broadcast signal through a wireless channel, and then, may demodulate and decode the received broadcast signal to obtain a main AV content. Additionally, the video display device 100 may receive a broadcast signal from the MVPD 30, and then, may demodulate and decode the received broadcast signal to obtain a main AV content. The video display device 100 extracts feature information from some frames or a section of audio samples of the obtained main AV content in operation S213.

The video display device 100 accesses the fingerprint server 22 corresponding to the predetermined fingerprint server address to transmit a first query including the extracted feature information in operation S215.

The fingerprint server 22 provides a query result as a first reply to the first query in operation S217. If the first reply corresponds to fail, the video display device 100 accesses the fingerprint server 22 corresponding to another fingerprint server address to transmit a first query including the extracted feature information.

The fingerprint server 22 may provide Extensible Markup Language (XML) document as a query result. Examples of the XML document containing a query result will be described.

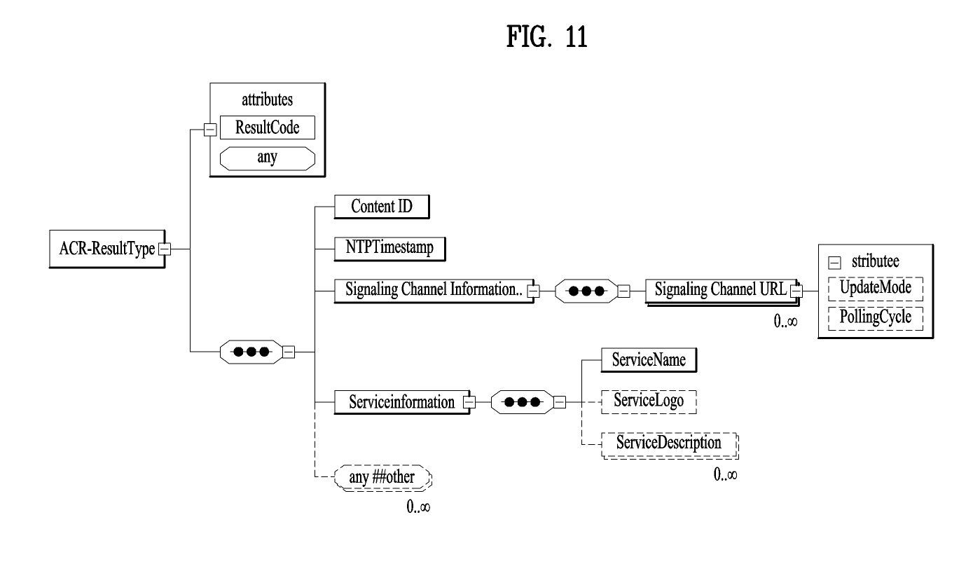

FIG. 11 is a view illustrating an XML schema diagram of ACR-Resulttype containing a query result according to an embodiment.

As shown in FIG. 11, ACR-Resulttype containing a query result includes ResultCode attributes and ContentID, NTPTime stamp, SignalingChannelInformation, and ServiceInformation elements.

For example, if the ResultCode attribute has 200, this may mean that the query result is successful. For example, if the ResultCode attribute has 404, this may mean that the query result is unsuccessful.

The SignalingChannelInformation element includes a SignalingChannelURL, and the SignalingChannelURL element includes an UpdateMode and PollingCycle attributes. The UpdateMode attribute may have a Pull value or a Push value.

The ServiceInformation element includes ServiceName, ServiceLogo, and ServiceDescription elements.

An XML schema of ACR-ResultType containing the query result is illustrated below.

```
TABLE 1
<xs:complexType name=“ACR-ResultType”>
  <xs:sequence>
    <xs:element name=“ContentID” type=“xs:anyURI”/>
    <xs:element name=“NTPTimestamp” type=“xs:unsignedLong”/>
    <xs:element name=“SignalingChannelInformation”>
      <xs:complexType>
        <xs:sequence>
          <xs:element name=“SignalingChannelURL”
          maxOccurs=“unbounded”>
            <xs:complexType>
              <xs:simpleContent>
                <xs:extension base=“xs:anyURI”>
                  <xs:attribute name=“UpdateMode”>
                    <xs:simpleType>
                      <xs:restriction base=“xs:string”>
                        <xs:enumeration value=“Pull”/>
                        <xs:enumeration value=“Push”/>
                      </xs:restriction>
                    </xs:simpleType>
                  </xs:attribute>
                  <xs:attribute name=“PollingCycle”
                  type=“xs:unsignedInt”/>
                </xs:extension>
              </xs:simpleContent>
            </xs:complexType>
          </xs:element>
        </xs:sequence>
      </xs:complexType>
    </xs:element>
    <xs:element name=“ServiceInformation”>
      <xs:complexType>
        <xs:sequence>
          <xs:element name=“ServiceName” type=“xs:string”/>
          <xs:element name=“ServiceLogo” type=“xs:anyURI”
          minOccurs=“0”/>
          <xs:element name=“ServiceDescription” type=“xs:string”
          minOccurs=“0” maxOccurs=“unbounded”/>
        </xs:sequence>
      </xs:complexType>
    </xs:element>
    <xs:any namespace=“##other” processContents=“skip”
    minOccurs=“0” maxOccurs=“unbounded”/>
  </xs:sequence>
  <xs:attribute name=“ResultCode” type=“xs:string” use=“required”/>
  <xs:anyAttribute processContents=“skip”/>
</xs:complexType>
```

As the ContentID element, an ATSC content identifier may be used as shown in table below.

TABLE 2

| Syntax | The Number of bits | format |
|---|---|---|
| ATSC_content_identifier( ){ | | |
| TSID | 16 | uimsbf |
| reserved | 2 | bslbf |
| end_of_day | 5 | uimsbf |
| unique_for | 9 | uimsbf |
| content_id | var | |
| } | | |

As shown in the table, the ATSC content identifier has a structure including TSID and a house number.

The 16 bit unsigned integer TSID carries a transport stream identifier.

The 5 bit unsigned integer end_of_day is set with an hour in a day of when a content_id value can be reused after broadcasting is finished.

The 9 bit unsigned integer unique_for is set with the number of day of when the content_id value cannot be reused.

Content_id represents a content identifier. The video display device 100 reduces unique_for by 1 in a corresponding time to end_of_day daily and presumes that content_id is unique if unique_for is not 0.

Moreover, as the ContentID element, a global service identifier for ATSC-M/H service may be used as described below.

The global service identifier has the following form.

urn:oma:bcast:iauth:atsc:service:<region>:<xsid>:<serviceid>

Here, <region> is an international country code including two characters regulated by ISO 639-2. <xsid> for local service is a decimal number of TSID as defined in <region>, and <xsid> (regional service) (major >69) is “0”. <serviceid> is defined with <major> or <minor>. <major> represent a Major Channel number, and <minor> represents a Minor Channel Number.

Examples of the global service identifier are as follows.

urn:oma:bcast:iauth:atsc:service:us:1234:5.1

urn:oma:bcast:iauth:atsc:service:us:0:100.200

Moreover, as the ContentID element, an ATSC content identifier may be used as described below.

The ATSC content identifier has the following form.

urn:oma:bcast:iauth:atsc:content<region>:<xsidz>:<contentid>:<unique_for>:<end_of_day>

Here, <region> is an international country code including two characters regulated by ISO 639-2. <xsid> for local service is a decimal number of TSID as defined in <region>, and may be followed by “.”<serviceid>. <xsid> for (regional service) (major >69) is <serviceid>. <content_id> is a base64 sign of a content_id field defined in above described table, <unique_for> is a decimal number sign of an unique_for field defined in above described table, and <end_of_day> is a decimal number sign of an end_of_day field defined in above described table.

If the query result does not include an enhanced service address or enhanced service but includes an enhanced service address providing server address, the video display device 100 accesses the enhanced service information providing server 40 corresponding to the obtained enhanced service address providing server address to transmit a second query including content information in operation S219.

The enhanced service information providing server 40 searches at least one available enhanced service relating to the content information of the second query. Later, the enhanced service information providing server 40 provides to the video display device 100 enhanced service information for at least one available enhanced service as a second reply to the second query in operation S221.

If the video display device 100 obtains at least one available enhanced service address through the first reply or the second reply, it accesses the at least one available enhanced service address to request enhanced service in operation S223, and then, obtains the enhanced service in operation S225.

When the UpdateMode attribute has a Pull value, the video display device 100 transmits an HTTP request to the enhanced service providing server 50 through SignalingChannelURL and receives an HTTP reply including a PSIP binary stream from the enhanced service providing server 50 in response to the request. In this case, the video display device 100 may transmit the HTTP request according to a Polling period designated as the PollingCycle attribute. Additionally, the SignalingChannelURL element may have an update time attribute. In this case, the video display device 100 may transmit the HTTP request according to an update time designated as the update time attribute.

If the UpdateMode attribute has a Push value, the video display device 100 may receive update from a server asynchronously through XMLHTTPRequest API. After the video display device 100 transmits an asynchronous request to a server through XMLHTTPRequest object, if there is a change of signaling information, the server provides the signaling information as a reply through the channel. If there is limitation in session standby time, a server generates a session timeout reply and a receiver recognizes the generated timeout reply to transmit a request again, so that a signaling channel between the receiver and the server may be maintained for all time.

FIG. 12 is a block diagram illustrating a watermark and fingerprint based network topology according to an embodiment.

As shown in FIG. 12, the watermark and fingerprint based network topology may further include a watermark server 21 and a fingerprint server 22.

As shown in FIG. 12, the watermark server 21 inserts content provider identifying information into a main AV content. The watermark server 21 may insert content provider identifying information as a visible watermark such as a logo or an invisible watermark into a main AV content.

The fingerprint server 22 does not edit a main AV content, but extracts feature information from some frames or a certain section of audio samples of the main AV content and stores the extracted feature information. Then, when receiving the feature information from the video display device 100, the fingerprint server 22 provides an identifier and time information of an AV content corresponding to the received feature information.

FIG. 13 is a ladder diagram illustrating a data flow in a watermark and fingerprint based network topology according to an embodiment.

First, the content providing server 10 transmits a broadcast signal including a main AV content and an enhanced service in operation S301.

The watermark server 21 receives a broadcast signal that the content providing server 10 provides, inserts a visible watermark such as a logo or watermark information as an invisible watermark into the main AV content by editing the main AV content, and provides the watermarked main AV content and enhanced service to the MVPD 30 in operation S303. The watermark information inserted through an invisible watermark may include at least one of content information, enhanced service information, and an available enhanced service. The content information and enhanced service information are described above.

The MVPD 30 receives broadcast signals including watermarked main AV content and enhanced service and generates a multiplexed signal to provide it to the broadcast receiving device 60 in operation S305. At this point, the multiplexed signal may exclude the received enhanced service or may include new enhanced service.

The broadcast receiving device 60 tunes a channel that a user selects and receives signals of the tuned channel, demodulates the received signals, performs channel decoding and AV decoding on the demodulated signals to generate an uncompressed main AV content, and then, provides the generated uncompressed main AV content to the video display device 100 in operation S306.

Moreover, the content providing server 10 also broadcasts a broadcast signal including a main AV content through a wireless channel in operation S307.

Additionally, the MVPD 30 may directly transmit a broadcast signal including a main AV content to the video display device 100 without going through the broadcast receiving device 60 in operation S308.

The video display device 100 may receive an uncompressed main AV content through the broadcast receiving device 60. Additionally, the video display device 100 may receive a broadcast signal through a wireless channel, and then, may demodulate and decode the received broadcast signal to obtain a main AV content. Additionally, the video display device 100 may receive a broadcast signal from the MVPD 30, and then, may demodulate and decode the received broadcast signal to obtain a main AV content. The video display device 100 extracts watermark information from audio samples in some frames or periods of the obtained main AV content. If watermark information corresponds to a logo, the video display device 100 confirms a watermark server address corresponding to a logo extracted from a corresponding relationship between a plurality of logos and a plurality of watermark server addresses. When the watermark information corresponds to the logo, the video display device 100 cannot identify the main AV content only with the logo. Additionally, when the watermark information does not include content information, the video display device 100 cannot identify the main AV content but the watermark information may include content provider identifying information or a watermark server address. When the watermark information includes the content provider identifying information, the video display device 100 may confirm a watermark server address corresponding to the content provider identifying information extracted from a corresponding relationship between a plurality of content provider identifying information and a plurality of watermark server addresses. In this manner, when the video display device 100 cannot identify a main AV content the video display device 100 only with the watermark information, it accesses the watermark server 21 corresponding to the obtained watermark server address to transmit a first query in operation S309.

The watermark server 21 provides a first reply to the first query in operation S311. The first reply may include at least one of a fingerprint server address, content information, enhanced service information, and an available enhanced service. The content information and enhanced service information are described above.

If the watermark information and the first reply include a fingerprint server address, the video display device 100 extracts feature information from some frames or a certain section of audio samples of the main AV content in operation S313.

The video display device 100 accesses the fingerprint server 22 corresponding to the fingerprint server address in the first reply to transmit a second query including the extracted feature information in operation S315.

The fingerprint server 22 provides a query result as a second reply to the second query in operation S317.

If the query result does not include an enhanced service address or enhanced service but includes an enhanced service address providing server address, the video display device 100 accesses the enhanced service information providing server 40 corresponding to the obtained enhanced service address providing server address to transmit a third query including content information in operation S319.

The enhanced service information providing server 40 searches at least one available enhanced service relating to the content information of the third query. Later, the enhanced service information providing server 40 provides to the video display device 100 enhanced service information for at least one available enhanced service as a third reply to the third query in operation S321.

If the video display device 100 obtains at least one available enhanced service address through the first reply, the second reply, or the third reply, it accesses the at least one available enhanced service address to request enhanced service in operation S323, and then, obtains the enhanced service in operation S325.

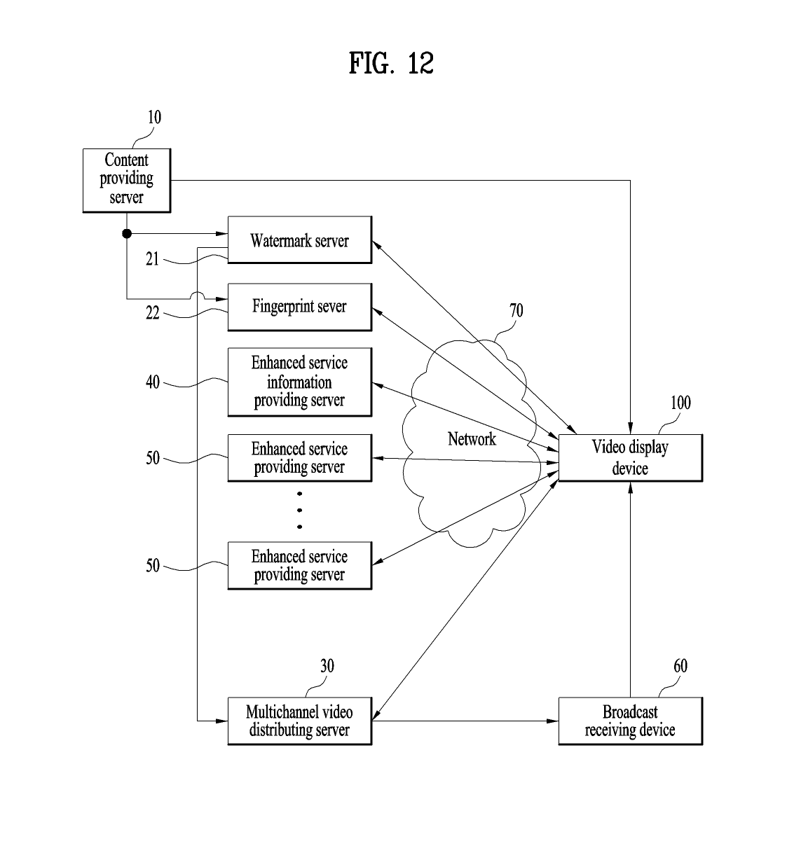

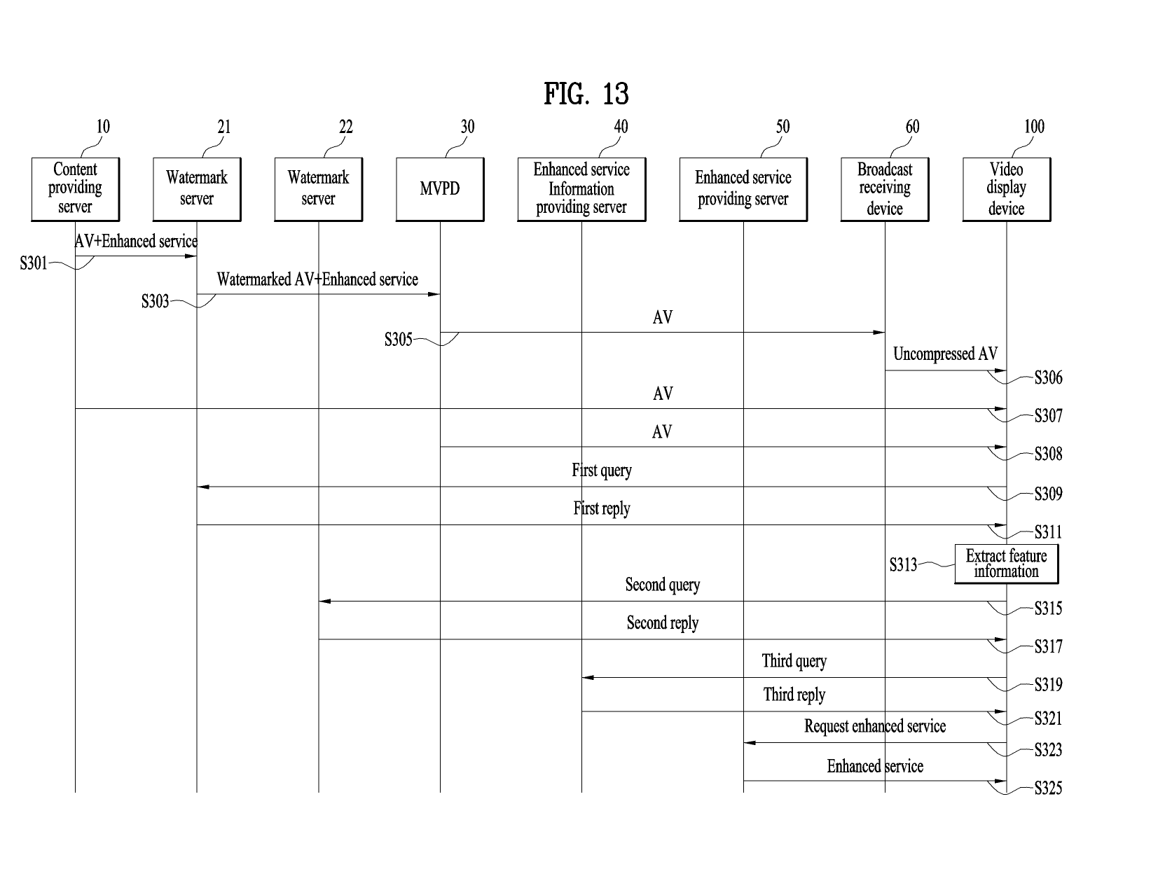

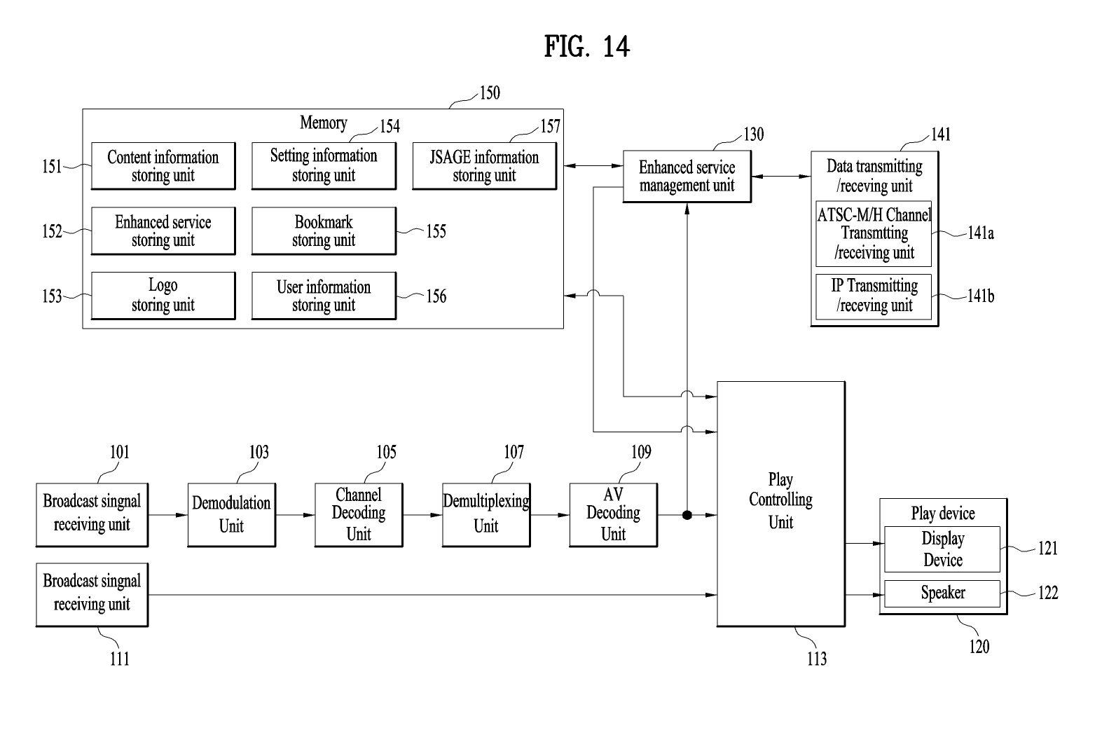

Then, referring to FIG. 14, the video display device 100 will be described according to an embodiment.

FIG. 14 is a block diagram illustrating the video display device according to the embodiment.

As shown in FIG. 14, the video display device 100 includes a broadcast signal receiving unit 101, a demodulation unit 103, a channel decoding unit 105, a demultiplexing unit 107, an AV decoding unit 109, an external input port 111, a play controlling unit 113, a play device 120, an enhanced service management unit 130, a data transmitting/receiving unit 141, and a memory 150.

The broadcast signal receiving unit 101 receives a broadcast signal from the content providing server 10 or MVPD 30.

The demodulation unit 103 demodulates the received broadcast signal to generate a demodulated signal.

The channel decoding unit 105 performs channel decoding on the demodulated signal to generate channel-decoded data.

The demultiplexing unit 107 separates a main AV content and enhanced service from the channel-decoded data. The separated enhanced service is stored in an enhanced service storage unit 152.

The AV decoding unit 109 performs AV decoding on the separated main AV content to generate an uncompressed main AV content.

Moreover, the external input port 111 receives an uncompressed main AV content from the broadcast receiving device 60, a digital versatile disk (DVD) player, a Blu-ray disk player, and so on. The external input port 111 may include at least one of a DSUB port, a High Definition Multimedia Interface (HDMI) port, a Digital Visual Interface (DVI) port, a composite port, a component port, and an S-Video port.

The play controlling unit 113 controls the play device 120 to play at least one of an uncompressed main AV content that the AV decoding unit 109 generates and an uncompressed main AV content received from the external input port 111 according to a user's selection.

The play device 120 includes a display unit 121 and a speaker 123. The display unit 21 may include at least one of a liquid crystal display (LCD), a thin film transistor liquid crystal display (TFT LCD), an organic light-emitting diode (OLED), a flexible display, and a 3D display.

The enhanced service management unit 130 obtains content information of the main AV content and obtains available enhanced service on the basis of the obtained content information. Especially, as described above, the enhanced service management unit 130 may obtain the identification information of the main AV content on the basis of some frames or a certain section of audio samples the uncompressed main AV content. This is called automatic contents recognition (ACR) in this specification.

The data transmitting/receiving unit 141 may include an Advanced Television Systems Committee-Mobile/Handheld (ATSC-M/H) channel transmitting/receiving unit 141a and an IP transmitting/receiving unit 141b.

The memory 150 may include at least one type of storage medium such as a flash memory type, a hard disk type, a multimedia card micro type, a card type memory such as SD or XD memory, Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, and optical disk. The video display device 100 may operate in linkage with a web storage performing a storage function of the memory 150 in the Internet.

The memory 150 may include a content information storage unit 151, an enhanced service storage unit 152, a logo storage unit 153, a setting information storage unit 154, a bookmark storage unit 155, a user information storage unit 156, and a usage information storage unit 157.

The content information storage unit 151 stores a plurality of content information corresponding to a plurality of feature information.

The enhanced service storage unit 152 may store a plurality of enhanced services corresponding to a plurality of feature information or a plurality of enhanced services corresponding to a plurality of content information.

The logo storage unit 153 stores a plurality of logos. Additionally, the logo storage unit 153 may further store content provider identifiers corresponding to the plurality of logos or watermark server addresses corresponding to the plurality of logos.

The setting information storage unit 154 stores setting information for ACR.

The bookmark storage unit 155 stores a plurality of bookmarks.

The user information storage unit 156 stores user information. The user information may include at least one of at least one account information for at least one service, regional information, family member information, preferred genre information, video display device information, and a usage information range. The at least one account information may include account information for a usage information measuring server and account information of social network service such as Twitter and Facebook. The regional information may include address information and zip codes. The family member information may include the number of family members, each member's age, each member's sex, each member's religion, and each member's job. The preferred genre information may be set with at least one of sports, movie, drama, education, news, entertainment, and other genres. The video display device information may include information such as the type, manufacturer, firmware version, resolution, model, OS, browser, storage device availability, storage device capacity, and network speed of a video display device. Once the usage information range is set, the video display device 100 collects and reports main AV content watching information and enhanced service usage information within the set range. The usage information range may be set in each virtual channel. Additionally, the usage information measurement allowable range may be set over an entire physical channel.

The usage information providing unit 157 stores the main AV content watching information and the enhanced service usage information, which are collected by the video display device 100. Additionally, the video display device 100 analyzes a service usage pattern on the basis of the collected main AV content watching information and enhanced service usage information, and stores the analyzed service usage pattern in the usage information storage unit 157.

The enhanced service management unit 130 may obtain the content information of the main AV content from the fingerprint server 22 or the content information storage unit 151. If there is no content information or sufficient content information, which corresponds to the extracted feature information, in the content information storage unit 151, the enhanced service management unit 130 may receive additional content information through the data transmitting/receiving unit 141. Moreover, the enhanced service management unit 130 may update the content information continuously.

The enhanced service management unit 130 may obtain available enhanced service from the enhanced service providing server 50 or the enhanced service storage unit 153. If there is no enhanced service or sufficient enhanced service in the enhanced service storage unit 153, the enhanced service management unit 130 may update enhanced service through the data transmitting/receiving unit 141. Moreover, the enhanced service management unit 130 may update the enhanced service continuously.

The enhanced service management unit 130 may extracts a logo from the main AV content, and then, may make a query to the logo storage unit 155 to obtain a content provider identifier or watermark server address, which is corresponds to the extracted logo. If there is no logo or a sufficient logo, which corresponds to the extracted logo, in the logo storage unit 155, the enhanced service management unit 130 may receive an additional logo through the data transmitting/receiving unit 141. Moreover, the enhanced service management unit 130 may update the logo continuously.

The enhanced service management unit 130 may compare the logo extracted from the main AV content with the plurality of logos in the logo storage unit 155 through various methods. The various methods may reduce the load of the comparison operation.

For example, the enhanced service management unit 130 may perform the comparison on the basis of color characteristics. That is, the enhanced service management unit 130 may compare the color characteristic of the extracted logo with the color characteristics of the logos in the logo storage unit 155 to determine whether they are identical or not.

Moreover, the enhanced service management unit 130 may perform the comparison on the basis of character recognition. That is, the enhanced service management unit 130 may compare the character recognized from the extracted logo with the characters recognized from the logos in the logo storage unit 155 to determine whether they are identical or not.

Furthermore, the enhanced service management unit 130 may perform the comparison on the basis of the contour of the logo. That is, the enhanced service management unit 130 may compare the contour of the extracted logo with the contours of the logos in the logo storage unit 155 to determine whether they are identical or not.

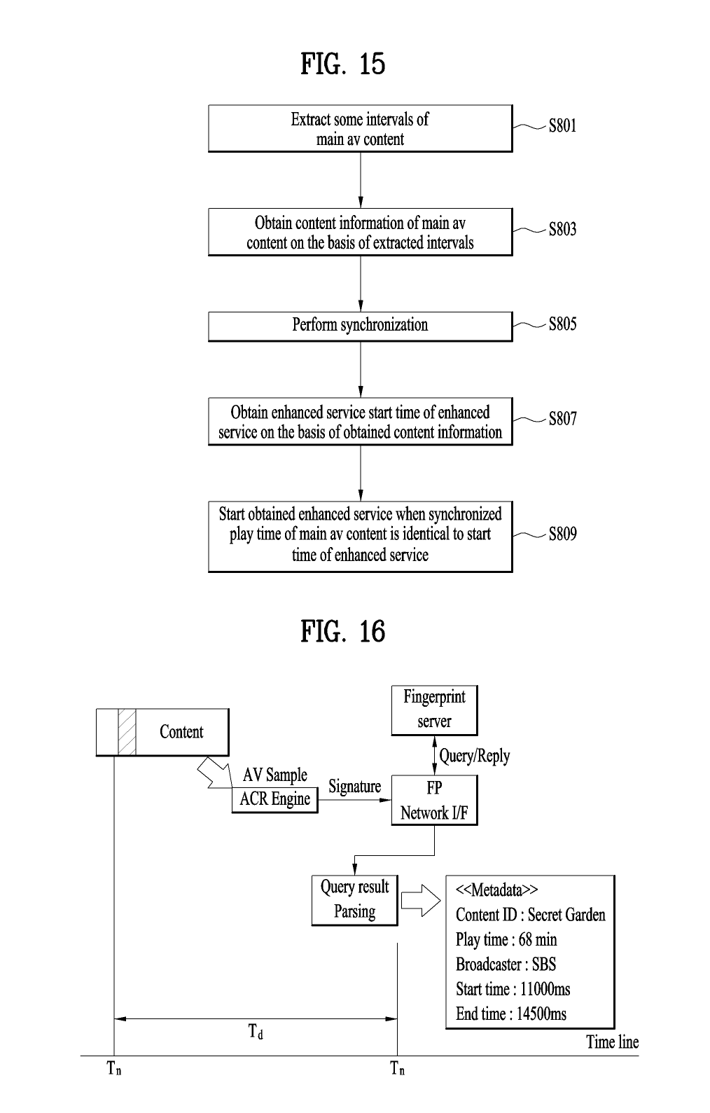

Then, referring to FIGS. 15 and 16, a method of synchronizing a playback time of a main AV content with a playback time of an enhanced service according to an embodiment will be described.

FIG. 15 is a flowchart illustrating a method of synchronizing a playback time of a main AV content with a playback time of an enhanced service according to an embodiment.

Enhanced service information may include a start time of an enhanced service. At this point, the video display device 100 may need to start the enhanced service at the start time. However, since the video display device 100 receives a signal transmitting an uncompressed main AV content with no time stamp, the reference time of a plying time of the main AV content is different from that of a start time of the enhanced service. Although the video display device 100 receives a main AV content having time information, the reference time of a plying time of the main AV content may be different from that of a start time of the enhanced service, like rebroadcasting. Accordingly, the video display device 100 may need to synchronize the reference time of the main AV content with that of the enhanced service. Especially, the video display device 100 may need to synchronize the playback time of the main AV content with the start time of the enhanced service.

First, the enhanced service management unit 130 extracts a certain section of a main AV content in operation S801. The section of the main AV content may include at least one of some video frames or a certain audio section of the main AV content. Time that the enhanced service management unit 130 extracts the section of the main AV content is designated as Tn.

The enhanced service management unit 130 obtains content information of a main AV content on the basis of the extracted section. In more detail, the enhanced service management unit 130 decodes information encoded with invisible watermark in the extracted section to obtain content information. Additionally, the enhanced service management unit 130 may extract feature information in the extracted section, and obtain the content information of the main AV content from the fingerprint server 22 or the content information storage unit 151 on the basis of the extracted feature information. Time that the enhanced service management unit 130 obtains the content information is designated as Tm.

Moreover, the content information includes a start time Ts of the extracted section. After the content information acquisition time Tm, the enhanced service management unit 130 synchronizes the playback time of the main AV content with the start time of the enhanced service on the biases of Ts, Tm, and Tn. In more detail, the enhanced service management unit 130 regards the content information acquisition time Tm as a time Tp, which can be calculated by Tp=Ts+(Tm−Tn).

Additionally, the enhanced service management unit 130 regards a time of when Tx elapses after the content information acquisition time as Tp+Tx.

Then, the enhanced service management unit 130 obtains an enhanced service and its start time Ta on the obtained content information in operation S807.

If the synchronized playback time of the main AV content is identical to the start time Ta of the enhanced service, the enhanced service management unit 130 starts the obtained enhanced service in operation S809. In more detail, the enhanced service management unit 130 may start the enhanced service when Tp+Tx=Ta is satisfied.

FIG. 16 is a conceptual diagram illustrating a method of synchronizing a playback time of a main AV content with a playback time of an enhanced service according to an embodiment.

As shown in FIG. 16, the video display device 100 extracts an AV sample during a system time Tn.

The video display device 100 extracts feature information from the extracted AV sample, and transmits a query including the extracted feature information to the fingerprint server 22 to receive a query result. The video display device 100 confirms whether a start time Ts of the extracted AV sample corresponds to 11000 ms at Tm by parsing the query result.

Accordingly, the video display device 100 regards the time of when the start time of the extracted AV sample is confirmed as Ts+(Tm−Tn), so that, after that, the playback time of the main AV content may be synchronized with the start time of the enhanced service.

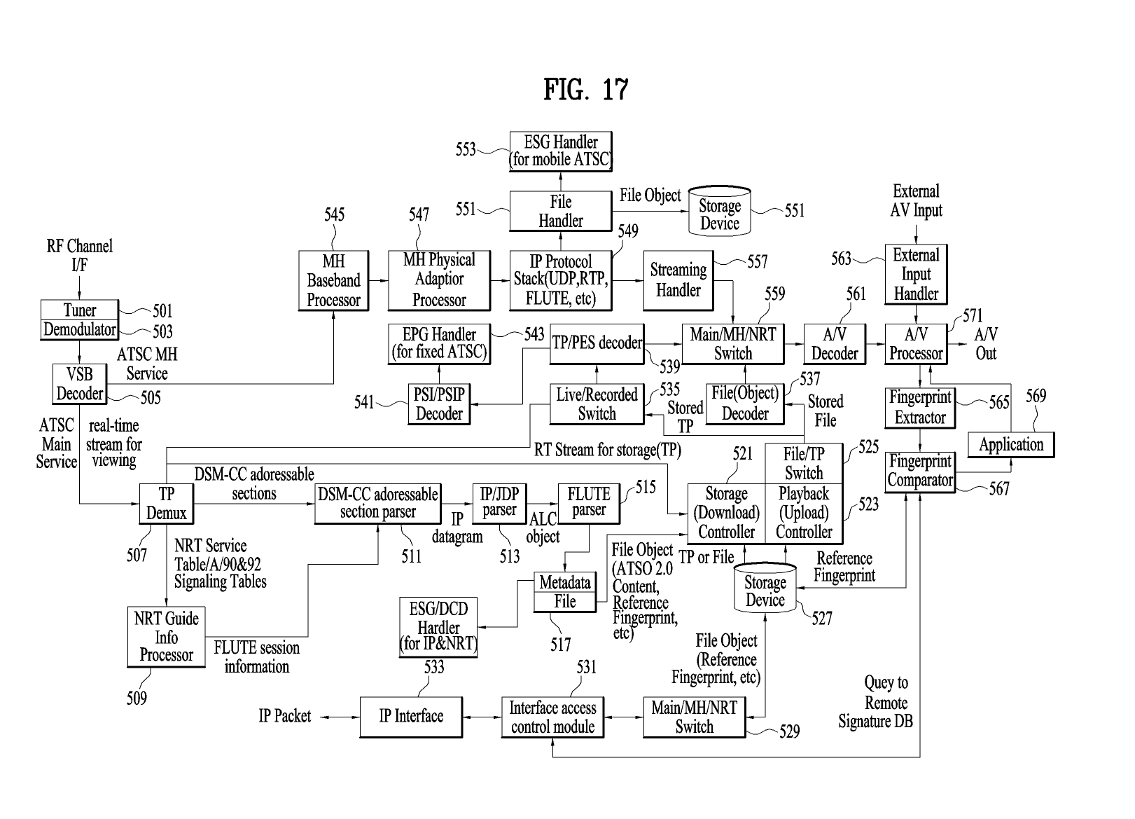

FIG. 17 is a block diagram illustrating a structure of a fingerprint based video display device according to another embodiment.

As shown in FIG. 17, a tuner 501 extracts a symbol from an 8-VSB RF signal transmitted through an air channel.

An 8-VSB demodulator 503 demodulates the 8-VSB symbol that the tuner 501 extracts and restores meaningful digital data.

A VSB decoder 505 decodes the digital data that the 8-VSB demodulator 503 to restore an ATSC main service and ATSC M/H service.

An MPEG-2 TP Demux 507 filters a Transport Packet that the video display device 100 is to process from an MPEG-2 Transport Packet transmitted through an 8-VSB signal or an MPEG-2 Transport Packet stored in a PVR Storage to relay the filtered Transport Packet into a processing module.

A PES decoder 539 buffers and restores a Packetized Elementary Stream transmitted through an MPEG-2 Transport Stream.

A PSI/PSIP decoder 541 buffers and analyzes PSI/PSIP Section Data transmitted through an MPEG-2 Transport Stream. The analyzed PSI/PSIP data are collected by a Service Manager (not shown), and then, is stored in DB in a form of Service Map and Guide data.

A DSMCC Section Buffer/Handler 511 buffers and processes DSMCC Section Data for file transmission through MPEG-2 TP and IP Datagram encapsulation.

An IP/UDP Datagram Buffer/Header Parser 513 buffers and restores IP Datagram, which is encapsulated through DSMCC Addressable section and transmitted through MPEG-2 TP to analyze the Header of each Datagram. Additionally, an IP/UDP Datagram Buffer/Header Parser 513 buffers and restores UDP Datagram transmitted through IP Datagram, and then analyzes and processes the restored UDP Header.

A Stream component handler 557 may include ES Buffer/Handler, PCR Handler, STC module, Descrambler, CA Stream Buffer/Handler, and Service Signaling Section Buffer/Handler.

The ES Buffer/Handler buffers and restores an Elementary Stream such as Video and Audio data transmitted in a PES form to deliver it to a proper A/V Decoder.

The PCR Handler processes Program Clock Reference (PCR) Data used for Time synchronization of Audio and Video Stream.

The STC module corrects Clock values of the A/V decoders by using a Reference Clock value received through PCR Handler to perform Time Synchronization.

When scrambling is applied to the received IP Datagram, the Descrambler restores data of Payload by using Encryption key delivered from the CA Stream Handler.

The CA Stream Buffer/Handler buffers and processes Data such as Key values for Descrambling of EMM and ECM, which are transmitted for a Conditional Access function through MPEG-2 TS or IP Stream. An output of the CA Stream Buffer/Handler is delivered to the Descrambler, and then, the descrambler descrambles MPEG-2 TP or IP Datagram, which carriers A/V Data and File Data.

The Service Signaling Section Buffer/Handler buffers, restores, and analyzes NRT Service Signaling Channel Section Data transmitted in a form of IP Datagram. The Service Manager (not shown) collects the analyzed NRT Service Signaling Channel Section data and stores them in DB in a form of Service Map and Guide data.

The A/V Decoder 561 decodes the Audio/Video data received through an ES Handler to present them to a user.

An MPEG-2 Service Demux (not shown) may include an MPEG-2 TP Buffer/Parser, a Descrambler, and a PVR Storage module.

An MPEG-2 TP Buffer/Parser (not shown) buffers and restores an MPEG-2 Transport Packet transmitted through an 8-VSB signal, and also detects and processes a Transport Packet Header.

The Descrambler restores the data of Payload by using an Encryption key, which is delivered from the CA Stream Handler, on the Scramble applied Packet payload in the MPEG-2 TP.

The PVR Storage module stores an MPEG-2 TP received through an 8-VSB signal at the user's request and outputs an MPEG-2 TP at the user's request. The PVR storage module may be controlled by the PVR manager (not shown).

The File Handler 551 may include an ALC/LCT Buffer/Parser, an FDT Handler, an XML Parser, a File Reconstruction Buffer, a Decompressor, a File Decoder, and a File Storage.

The ALC/LCT Buffer/Parser buffers and restores ALC/LCT data transmitted through a UDP/IP Stream, and analyzes a Header and Header extension of ALC/LCT. The ALC/LCT Buffer/Parser may be controlled by an NRT Service Manager (not shown).

The FDT Handler analyzes and processes a File Description Table of FLUTE protocol transmitted through an ALC/LCT session. The FDT Handler may be controlled by an NRT Service Manager (not shown).

The XML Parser analyzes an XML Document transmitted through an ALC/LCT session, and then, delivers the analyzed data to a proper module such as an FDT Handler and an SG Handler.

The File Reconstruction Buffer restores a file transmitted through an ALC/LCT, FLUTE session.

If a file transmitted through an ALC/LCT and FLUTE session is compressed, the Decompressor performs a process to decompress the file.

The File Decoder decodes a file restored in the File Reconstruction Buffer, a file decompressed in the decompressor, or a film extracted from the File Storage.

The File Storage stores or extracts a restored file if necessary.

The M/W Engine (not shown) processes data such as a file, which is not an A/V Stream transmitted through DSMCC Section and IP Datagram. The M/W Engine delivers the processed data to a Presentation Manager module.

The SG Handler (not shown) collects and analyzes Service Guide data transmitted in an XML Document form, and then, delivers them to the EPG Manager.

The Service Manager (not shown) collects and analyzes PSI/PSIP Data transmitted through an MPEG-2 Transport Stream and Service Signaling Section Data transmitted through an IP Stream, so as to produce a Service Map. The Service Manager (not shown) stores the produced service map in a Service Map & Guide Database, and controls an access to a Service that a user wants. The Service Manager is controlled by the Operation Controller (not shown), and controls the Tuner 501, the MPEG-2 TP Demux 507, and the IP Datagram Buffer/Handler 513.

The NRT Service Manager (not shown) performs an overall management on the NRT service transmitted in an object/file form through a FLUTE session. The NRT Service Manager (not shown) may control the FDT Handler and File Storage.

The Application Manager (not shown) performs overall management on Application data transmitted in a form of object and file.

The UI Manager (not shown) delivers a user input to an Operation Controller through a User Interface, and starts a process for a service that a user requests.

The Operation Controller (not shown) processes a command of a user, which is received through a UI Manager, and allows a Manager of a necessary module to perform a corresponding action.

The Fingerprint Extractor 565 extracts fingerprint feature information from an AV stream.

The Fingerprint Comparator 567 compares the feature information extracted by the Fingerprint Extractor with a Reference fingerprint to find an identical content. The Fingerprint Comparator 567 may use a Reference fingerprint DB stored in local and may query a Fingerprint query server on the internet to receive a result. The matched result data obtained by a comparison result may be delivered to Application and used.

As an ACR function managing module or an application module providing an enhanced service on the basis of ACR, the Application 569 identifies a broadcast content in watching to provide an enhanced service related to it.

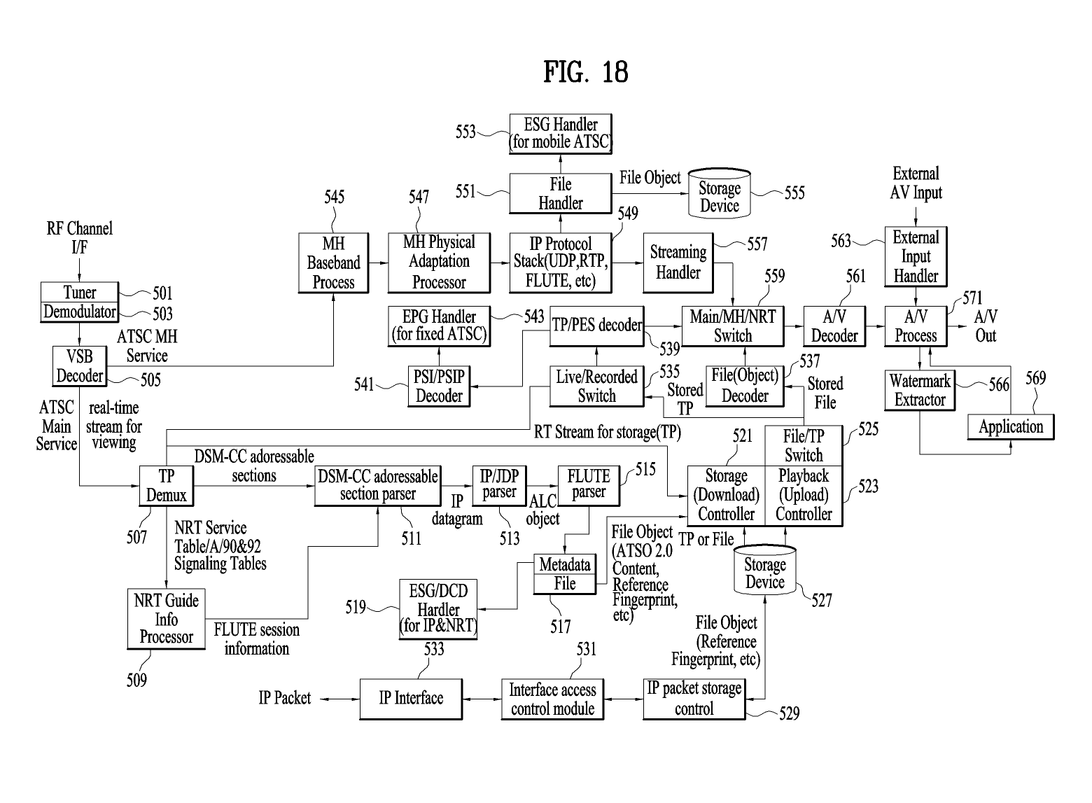

FIG. 18 is a block diagram illustrating a structure of a watermark based video display device according to another embodiment.

Although the watermark based video display device of FIG. 18 is similar to the fingerprint based video display device of FIG. 17, the fingerprint based video display device does not includes the Fingerprint Extractor 565 and the Fingerprint Comparator 567, but further includes the Watermark Extractor 566.

The Watermark Extractor 566 extracts data inserted in a watermark form from an Audio/Video stream. The extracted data may be delivered to an Application and may be used.

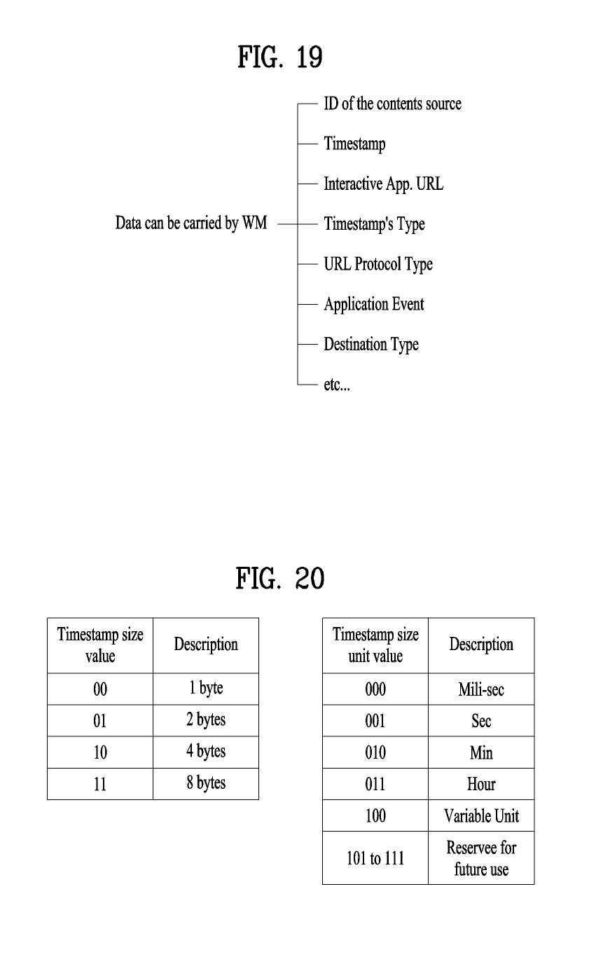

FIG. 19 is a diagram showing data which may be delivered via a watermarking scheme according to one embodiment of the present invention.

As described above, an object of ACR via a WM is to obtain supplementary service related information of content from incompressible audio/video in an environment capable of accessing only incompressible audio/video (that is, an environment in which audio/video is received from a cable/satellite/IPTV, etc.). Such an environment may be referred to as an ACR environment. In the ACR environment, since a receiver receives incompressible audio/video data only, the receiver may not confirm which content is currently being displayed. Accordingly, the receiver uses a content source ID, a current point of time of a broadcast program and URL information of a related application delivered by a WM to identify displayed content and provide an interactive service.

In delivery of a supplementary service related to a broadcast program using an audio/video watermark (WM), all supplementary information may be delivered by the WM as a simplest method. In this case, all supplementary information may be detected by a WM detector to simultaneously process information detected by the receiver.

However, in this case, if the amount of WMs inserted into audio/video data increases, total quality of audio/video may deteriorate. For this reason, only minimum necessary data may be inserted into the WM. A structure of WM data for enabling a receiver to efficiently receive and process a large amount of information while inserting minimum data as a WM needs to be defined. A data structure used for the WM may be equally used even in a fingerprinting scheme which is relatively less influenced by the amount of data.

As shown, data delivered via the watermarking scheme according to one embodiment of the present invention may include an ID of a content source, a timestamp, an interactive application URL, a timestamp's type, a URL protocol type, an application event, a destination type, etc. In addition, various types of data may be delivered via the WM scheme according to the present invention.

The present invention proposes the structure of data included in a WM when ACR is performed via a WM scheme. For shown data types, a most efficient structure is proposed by the present invention.

Data which can be delivered via the watermarking scheme according to one embodiment of the present invention include the ID of the content source. In an environment using a set top box, a receiver (a terminal or TV) may not check a program name, channel information, etc. when a multichannel video programming distributor (MVPD) does not deliver program related information via the set top box. Accordingly, a unique ID for identifying a specific content source may be necessary. In the present invention, an ID type of a content source is not limited. Examples of the ID of the content source may be as follows.

First, a global program ID may be a global identifier for identifying each broadcast program. This ID may be directly created by a content provider or may be created in the format specified by an authoritative body. Examples of the ID may include TMSId of “TMS metadata” of North America, an EIDR ID which is a movie/broadcast program identifier, etc.

A global channel ID may be a channel identifier for identifying all channels. Channel numbers differ between MVPDs provided by a set top box. In addition, even in the same MVPD, channel numbers may differ according to services designated by users. The global channel ID may be used as a global identifier which is not influenced by an MVPD, etc. According to embodiments, a channel transmitted via a terrestrial wave may be identified by a major channel number and a minor channel number. If only a program ID is used, since a problem may occur when several broadcast stations broadcast the same program, the global channel ID may be used to specify a specific broadcast channel.

Examples of the ID of the content source to be inserted into a WM may include a program ID and a channel ID. One or both of the program ID and the channel ID or a new ID obtained by combining the two IDs may be inserted into the WM. According to embodiments, each ID or combined ID may be hashed to reduce the amount of data. The ID of each content source may be of a string type or an integer type. In the case of the integer type, the amount of transmitted data may be further reduced.

In addition, data which can be delivered via the watermarking scheme according to one embodiment of the present invention may include a timestamp. The receiver should know a point of time of currently viewed content. This time related information may be referred to as a timestamp and may be inserted into the WM. The time related information may take the form of an absolute time (UTC, GPS, etc.) or a media time. The time related information may be delivered up to a unit of milliseconds for accuracy and may be delivered up to a smaller unit according to embodiments. The timestamp may have a variable length according to type information of the timestamp.

Data which can be delivered via the watermarking scheme according to one embodiment may include the URL of the interactive application. If an interactive application related to a currently viewed broadcast program is present, the URL of the application may be inserted into the WM. The receiver may detect the WM, obtain the URL, and execute the application via a browser.

FIG. 20 is a diagram showing the meanings of the values of the timestamp type field according to one embodiment of the present invention.

The present invention proposes a timestamp type field as one of data which can be delivered via a watermarking scheme. In addition, the present invention proposes an efficient data structure of a timestamp type field.

The timestamp type field may be allocated 5 bits. The first two bits of the timestamp may mean the size of the timestamp and the next 3 bits may mean the unit of time information indicated by the timestamp. Here, the first two bits may be referred to as a timestamp size field and the next 3 bits may be referred to as a timestamp unit field.

As shown, according to the size of the timestamp and the unit value of the timestamp, a variable amount of real time stamp information may be inserted into the WM. Using such variability, a designer may select a size allocated to the timestamp and the unit thereof according to the accuracy of the timestamp. If accuracy of the timestamp increases, it is possible to provide an interactive service at an accurate time. However, system complexity increases as accuracy of the timestamp increases. In consideration of this tradeoff, the size allocated to the timestamp and the unit thereof may be selected.

If the first two bits of the timestamp type field are 00, the timestamp may have a size of 1 byte. If the first two bits of the timestamp type field are 01, 10 and 11, the size of the timestamp may be 2, 4 and 8 bytes, respectively.

If the last three bits of the timestamp type field are 000, the timestamp may have a unit of milliseconds. If the last three bits of the timestamp type field are 001, 010 and 011, the timestamp may have second, minute and hour units, respectively. The last three bits of the timestamp type field of 101 to 111 may be reserved for future use.

Here, if the last three bits of the timestamp type field are 100, a separate time code may be used as a unit instead of a specific time unit such as millisecond or second. For example, a time code may be inserted into the WM in the form of HH:MM:SS:FF which is a time code form of SMPTE. Here, HH may be an hour unit, MM may be a minute unit and SS may be a second unit. FF may be frame information. Frame information which is not a time unit may be simultaneously delivered to provide a frame accurate service. A real timestamp may have a form of HHMMSSFF excluding colon in order to be inserted into the WM. In this case, a timestamp size value may have 11 (8 bytes) and a timestamp unit value may be 100. In the case of a variable unit, how the timestamp is inserted is not limited by the present invention.

For example, if timestamp type information has a value of 10 and timestamp unit information has a value of 000, the size of the timestamp may be 4 bits and the unit of the timestamp may be milliseconds. At this time, if the timestamp is Ts=3265087, 3 digits 087 located at the back of the timestamp may mean a unit of milliseconds and the remaining digits 3265 may mean a second unit. Accordingly, when this timestamp is interpreted, a current time may mean that 54 minutes 25.087 seconds has elapsed after the program, into which the WM is inserted, starts. This is only exemplary and the timestamp serves as a wall time and may indicate a time of a receiver or a segment regardless of content.

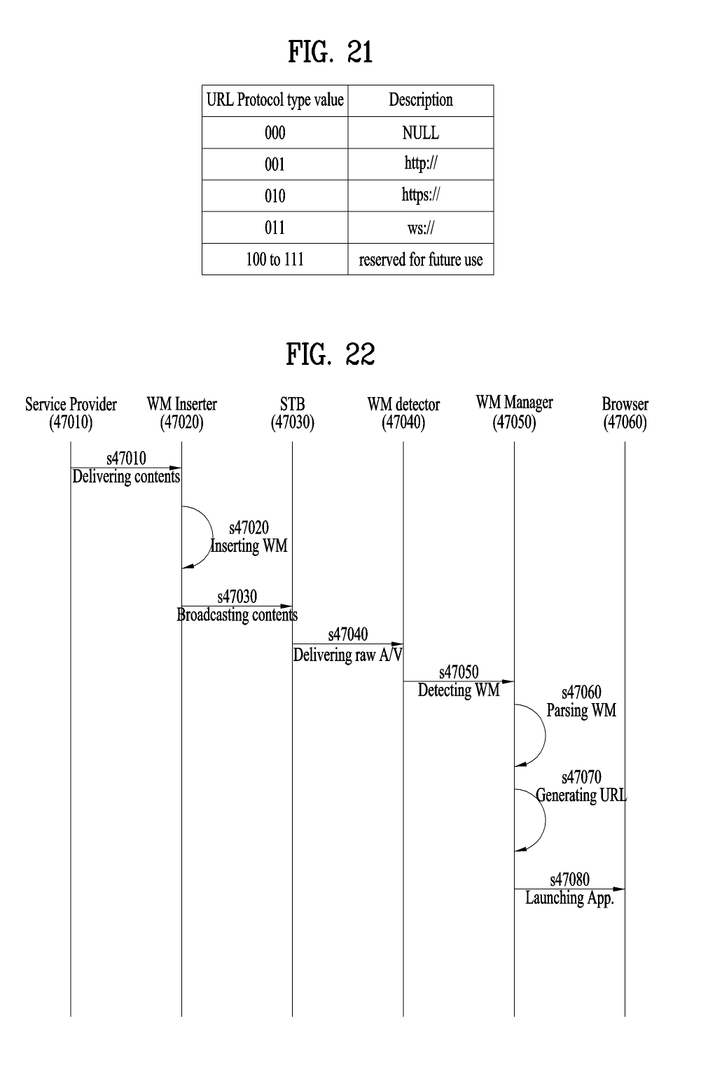

FIG. 21 is a diagram showing meanings of values of a URL protocol type field according to one embodiment of the present invention.

The present invention proposes a URL protocol type field as one of data which can be delivered via a watermarking scheme. In addition, the present invention proposes an efficient data structure of a URL protocol type field.

Among the above-described information, the length of the URL is generally long such that the amount of data to be inserted is relatively large. As described above, as the amount of data to be inserted into the WM decreases, efficiency increases. Thus, a fixed portion of the URL may be processed by the receiver. Accordingly, the present invention proposes a URL protocol type field.

The URL protocol type field may have a size of 3 bits. A service provider may set a URL protocol in a WM using the URL protocol type field. In this case, the URL of the interactive application may be inserted starting from a domain and may be transmitted to the WM.

A WM detector of the receiver may first parse the URL protocol type field, obtain URL protocol information and prefix the protocol to the URL value transmitted thereafter, thereby generating an entire URL. The receiver may access the completed URL via a browser and execute the interactive application.

Here, if the value of the URL protocol type field is 000, the URL protocol may be directly specified and inserted into the URL field of the WM. If the value of the URL protocol type field is 001, 010 and 011, the URL protocols may be http://, https:// and ws://, respectively. The URL protocol type field values of 100 to 111 may be reserved for future use.

The application URL may enable execution of the application via the browser (in the form of a web application). In addition, according to embodiments, a content source ID and timestamp information should be referred to. In the latter case, in order to deliver the content source ID information and the time stamp information to a remote server, a final URL may be expressed in the following form.

Request URL:

In this embodiment, a content source ID may be 123456 and a timestamp may be 5005. cid may mean a query identifier of a content source ID to be reported to the remote server. t may mean a query identifier of a current time to be reported to the remote server.

FIG. 22 is a flowchart illustrating a process of processing a URL protocol type field according to one embodiment of the present invention.

First, a service provider 47010 may deliver content to a WM inserter 47020 (s47010). Here, the service provider 47010 may perform a function similar to the above-described content provision server.

The WM inserter 47020 may insert the delivered content into a WM (s47020). Here, the WM inserter 47020 may perform a function similar to the above-described watermark server. The WM inserter 47020 may insert the above-described WM into audio or video by a WM algorithm. Here, the inserted WM may include the above-described application URL information, content source ID information, etc. For example, the inserted WM may include the above-described timestamp type field, the timestamp, the content ID, etc. The above-described protocol type field may have a value of 001 and URL information may have a value of atsc.org. The values of the field inserted into the WM are only exemplary and the present invention is not limited to this embodiment.

The WM inserter 47020 may transmit content, into which the WM is inserted (s47030). Transmission of the content, into which the WM is inserted, may be performed by the service provider 47010.

An STB 47030 may receive the content, into which the WM is inserted, and output incompressible A/V data (or raw A/V data) (s47040). Here, the STB 47030 may mean the above-described broadcast reception apparatus or the set top box. The STB 47030 may be mounted inside or outside the receiver.

A WM detector 47040 may detect the inserted WM from the received incompressible A/V data (s47050). The WM detector 47040 may detect the WM inserted by the WM inserter 47020 and deliver the detected WM to a WM manager.

The WM manager 47050 may parse the detected WM (s47060). In the above-described embodiment, the WM may have a URL protocol type field value of 001 and a URL value of atsc.org. Since the URL protocol type field value is 001, this may mean that http://protocol is used. The WM manager 47050 may combine http:// and atsc.org using this information to generate an entire URL (s47070).

The WM manager 47050 may send the completed URL to a browser 47060 and launch an application (s47080). In some cases, if the content source ID information and the timestamp information should also be delivered, the application may be launched in the form of.

The WM detector 47040 and the WM manager 47050 of the terminal are combined to perform the functions thereof in one module. In this case, steps s45050, s47060 and s47070 may be processed in one module.

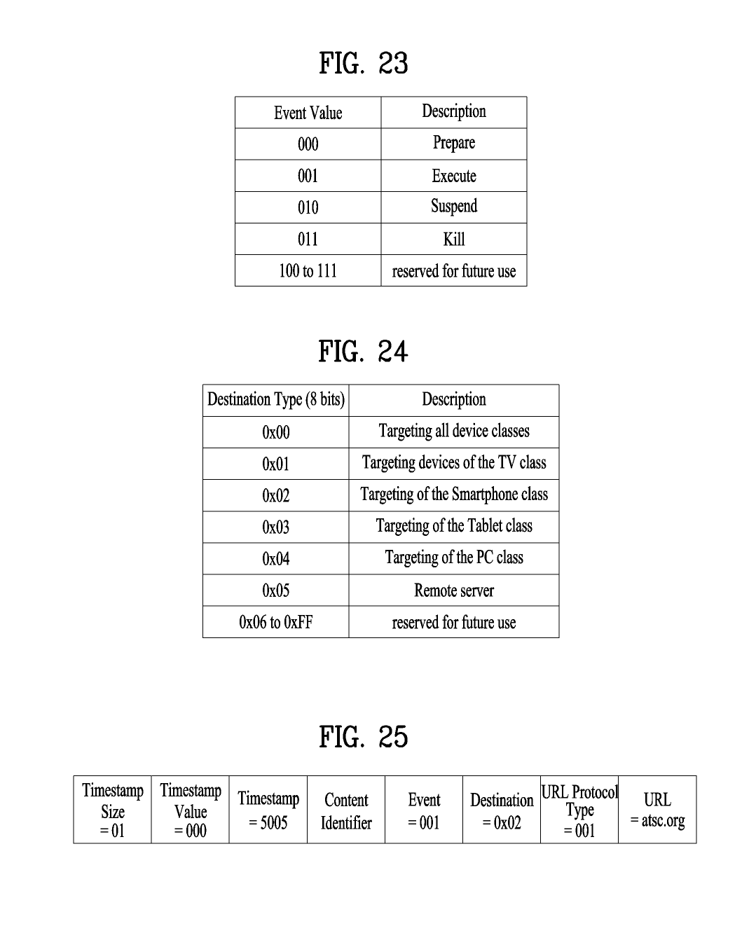

FIG. 23 is a diagram showing the meanings of the values of an event field according to one embodiment of the present invention.

The present invention proposes an event field as one of the data which can be delivered via the watermarking scheme. In addition, the present invention proposes an efficient data structure of an event field.

The application may be launched via the URL extracted from the WM. The application may be controlled via a more detailed event. Events which can control the application may be indicated and delivered by the event field. That is, if an interactive application related to a currently viewed broadcast program is present, the URL of the application may be transmitted and the application may be controlled using events.

The event field may have a size of 3 bits. If the value of the event field is 000, this may indicate a “Prepare” command. Prepare is a preparation step before executing the application. A receiver, which has received this command, may download content items related to the application in advance. In addition, the receiver may release necessary resources in order to execute the application. Here, releasing the necessary resources may mean that a memory is cleaned or other unfinished applications are finished.

If the event field value is 001, this may indicate an “Execute” command. Execute may be a command for executing the application. If the event field value is 010, this may indicate a “Suspend” command. Suspend may mean that the executed application is suspended. If the event field value is 011, this may indicate a “Kill” command. Kill may be a command for finishing the already executed application. The event field values of 100 to 111 may be reserved for future use.

FIG. 24 is a diagram showing the meanings of the values of a destination type field according to one embodiment of the present invention.

The present invention proposes a destination type field as one of data which can be delivered via a watermarking scheme. In addition, the present invention proposes an efficient data structure of a destination type field.

With development of DTV related technology, supplementary services related to broadcast content may be provided by a companion device as well as a screen of a TV receiver. However, companion devices may not receive broadcast programs or may receive broadcast programs but may not detect a WM. Accordingly, among applications for providing a supplementary service related to currently broadcast content, if an application to be executed by a companion device is present, related information thereof should be delivered to the companion device.

At this time, even in an environment in which the receiver and the companion device interwork, it is necessary to know by which device an application or data detected from a WM is consumed. That is, information about whether the application or data is consumed by the receiver or the companion device may be necessary. In order to deliver such information as the WM, the present invention proposes a destination type field.

The destination type field may have a size of 3 bits. If the value of the destination type field is 0x00, this may indicate that the application or data detected by the WM is targeted at all devices. If the value of the destination type field is 0x01, this may indicate that the application or data detected by the WM is targeted at a TV receiver. If the value of the destination type field is 0x02, this may indicate that the application or data detected by the WM is targeted at a smartphone. If the value of the destination type field is 0x03, this may indicate that the application or data detected by the WM is targeted at a tablet. If the value of the destination type field is 0x04, this may indicate that the application or data detected by the WM is targeted at a personal computer. If the value of the destination type field is 0x05, this may indicate that the application or data detected by the WM is targeted at a remote server. Destination type field values of 0x06 to 0xFF may be reserved for future use.

Here, the remote server may mean a server having all supplementary information related to a broadcast program. This remote server may be located outside the terminal. If the remote server is used, the URL inserted into the WM may not indicate the URL of a specific application but may indicate the URL of the remote server. The receiver may communicate with the remote server via the URL of the remote server and receive supplementary information related to the broadcast program. At this time, the received supplementary information may be a variety of information such as a genre, actor information, synopsis, etc. of a currently broadcast program as well as the URL of an application related hereto. The received information may differ according to system.

According to another embodiment, each bit of the destination type field may be allocated to each device to indicate the destination of the application. In this case, several destinations may be simultaneously designated via bitwise OR.

For example, when 0x01 indicates a TV receiver, 0x02 indicates a smartphone, 0x04 indicates a tablet, 0x08 indicates a PC and 0x10 indicates a remote server, if the destination type field has a value of 0x6, the application or data may be targeted at the smartphone and the tablet.

According to the value of the destination type field of the WM parsed by the above-described WM manager, the WM manager may deliver each application or data to the companion device. In this case, the WM manager is a module for processing interworking with the companion device in the receiver and may deliver information related to each application or data.

FIG. 25 is a diagram showing the structure of data to be inserted into a WM according to embodiment #1 of the present invention.

In the present embodiment, data inserted into the WM may have information such as a timestamp type field, a timestamp, a content ID, an event field, a destination type field, a URL protocol type field and a URL. Here, the order of data may be changed and each datum may be omitted according to embodiments.

In the present embodiment, a timestamp size field of the timestamp type field may have a value of 01 and a timestamp unit field may have a value of 000. This may mean that 2 bits are allocated to the timestamp and the timestamp has a unit if milliseconds.

In addition, the event field has a value of 001, which means the application should be immediately executed. The destination type field has a value of 0x02, which may mean that data delivered by the WM should be delivered to the smartphone. Since the URL protocol type field has a value of 001 and the URL has a value of atsc.org, this may mean that the supplementary information or the URL of the application is.

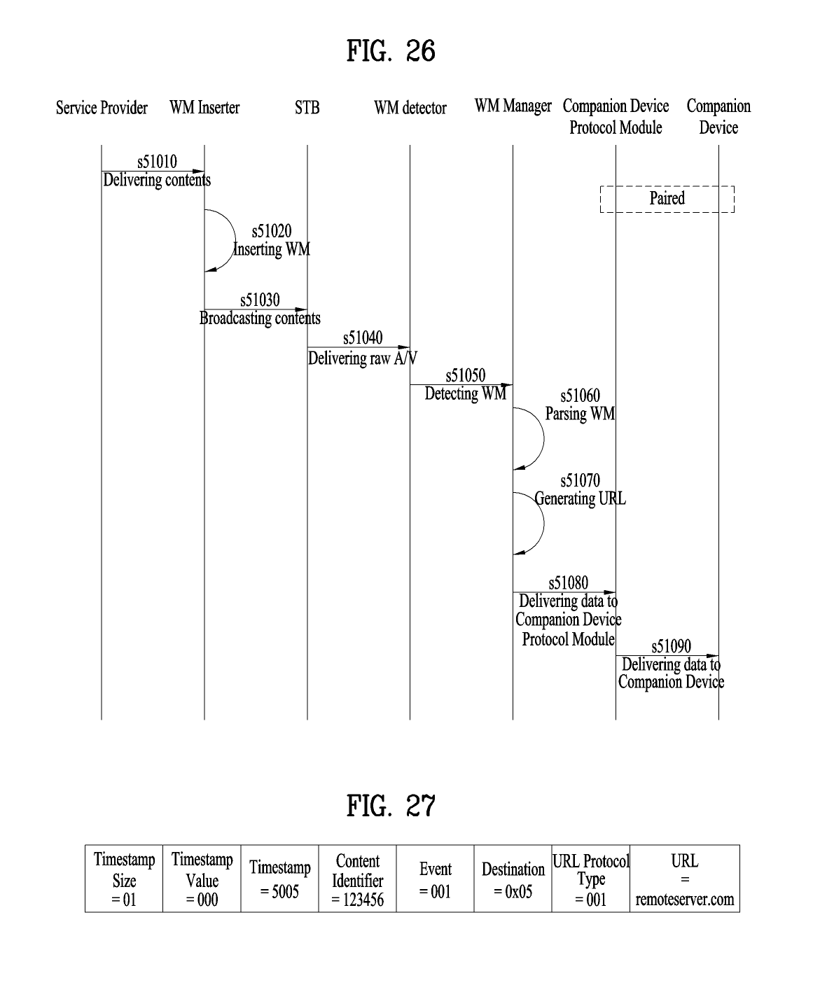

FIG. 26 is a flowchart illustrating a process of processing a data structure to be inserted into a WM according to embodiment #1 of the present invention.

Step s51010 of, at the service provider, delivering content to the WM inserter, step s51020 of, at the WM inserter, inserting the received content into the WM, step s51030 of, at the WM inserter, transmitting the content, into which the WM is inserted, step s51040 of, at the STB, receiving the content, into which the WM is inserted, and outputting the incompressible A/V data, step s51050 of, at the WM detector, detecting the WM, step s51060, at the WM manager, parsing the detected WM and/or step s51070 of, at the WM manager, generating an entire URL may be equal to the above-described steps.

The WM manager is a companion device protocol module in the receiver according to the destination type field of the parsed WM and may deliver related data (s51080). The companion device protocol module may manage interworking and communication with the companion device in the receiver. The companion device protocol module may be paired with the companion device. According to embodiments, the companion device protocol module may be a UPnP device. According to embodiments, the companion device protocol module may be located outside the terminal.

The companion device protocol module may deliver the related data to the companion device according to the destination type field (s51090). In embodiment #1, the value of the destination type field is 0x02 and the data inserted into the WM may be data for a smartphone. Accordingly, the companion device protocol module may send the parsed data to the smartphone. That is, in this embodiment, the companion device may be a smartphone.

According to embodiments, the WM manager or the device protocol module may perform a data processing procedure before delivering data to the companion device. The companion device may have portability but instead may have relatively inferior processing/computing capabilities and a small amount of memory. Accordingly, the receiver may process data instead of the companion device and deliver the processed data to the companion device.

Such processing may be implemented as various embodiments. First, the WM manager or the companion device protocol module may select only data required by the companion device. In addition, according to embodiments, if the event field includes information indicating that the application is finished, the application related information may not be delivered. In addition, if data is divided and transmitted via several WMs, the data may be stored and combined and then final information may be delivered to the companion device. The receiver may perform synchronization using the timestamp instead of the companion device and deliver a command related to the synchronized application or deliver an already synchronized interactive service to the companion device and the companion device may perform display only. Timestamp related information may not be delivered, a time base may be maintained in the receiver only and related information may be delivered to the companion device when a certain event is activated. In this case, the companion device may activate the event according to the time when the related information is received, without maintaining the time base.

Similarly to the above description, the WM detector and the WM manager of the terminal may be combined to perform the functions thereof in one module. In this case, steps s51050, s51060, s51070 and s51080 may be performed in one module.

In addition, according to embodiments, the companion device may also have the WM detector. When each companion device receives a broadcast program, into which a WM is inserted, each companion device may directly detect the WM and then deliver the WM to another companion device. For example, a smartphone may detect and parse a WM and deliver related information to a TV. In this case, the destination type field may have a value of 0x01.

FIG. 27 is a diagram showing the structure of data to be inserted into a WM according to embodiment #2 of the present invention.

In the present embodiment, data inserted into the WM may have information such as a timestamp type field, a timestamp, a content ID, an event field, a destination type field, a URL protocol type field and a URL. Here, the order of data may be changed and each datum may be omitted according to embodiments.

In the present embodiment, a timestamp size field of the timestamp type field may have a value of 01 and a timestamp unit field may have a value of 000. This may mean that 2 bits are allocated to the timestamp and the timestamp has a unit of milliseconds. The content ID may have a value of 123456.

In addition, the event field has a value of 001, which means the application should be immediately executed. The destination type field has a value of 0x05, which may mean that data delivered by the WM should be delivered to the remote server. Since the URL protocol type field has a value of 001 and the URL has a value of remoteserver.com, this may mean that the supplementary information or the URL of the application is.

As described above, if the remote server is used, supplementary information of the broadcast program may be received from the remote server. At this time, the content ID and the time stamp may be inserted into the URL of the remote server as parameters and requested from the remote server. According to embodiments, the remote server may obtain information about a currently broadcast program via support of API. At this time, the API may enable the remote server to acquire the content ID and the timestamp stored in the receiver or to deliver related supplementary information.

In the present embodiment, if the content ID and the timestamp are inserted into the URL of the remote server as parameters, the entire URL may be. Here, cid may mean a query identifier of a content source ID to be reported to the remote server. Here, t may mean a query identifier of a current time to be reported to the remote server.

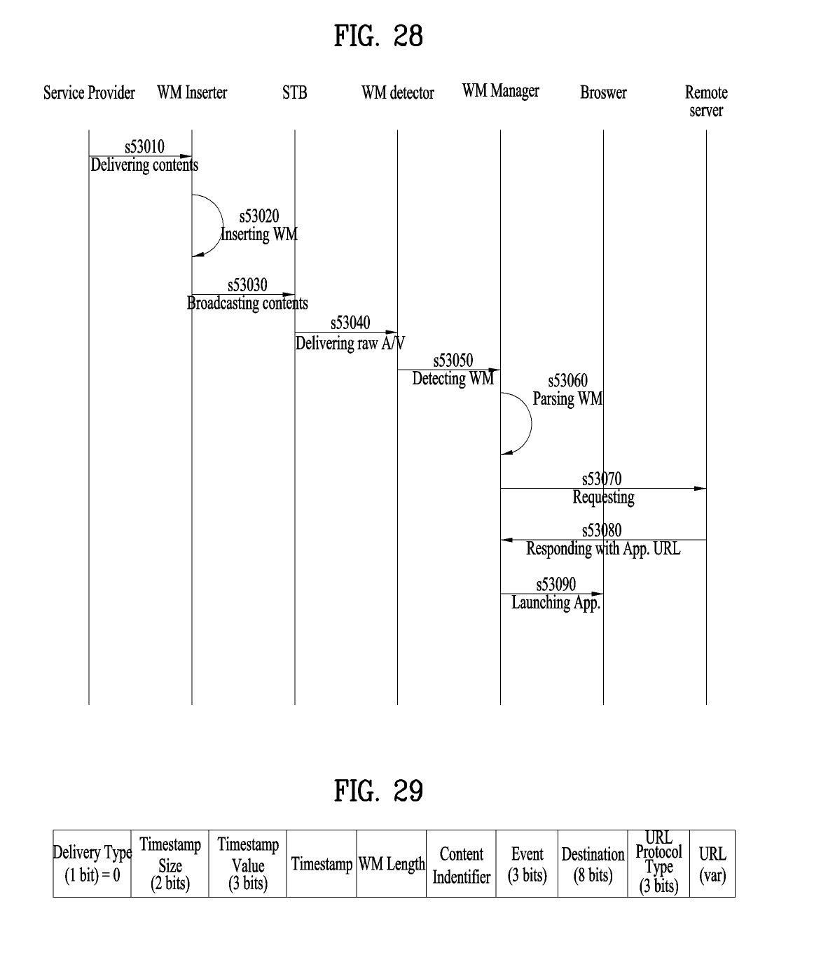

FIG. 28 is a flowchart illustrating a process of processing a data structure to be inserted into a WM according to embodiment #2 of the present invention.

Step s53010 of, at the service provider, delivering content to the WM inserter, step s53020 of, at the WM inserter, inserting the received content into the WM, step s53030 of, at the WM inserter, transmitting the content, into which the WM is inserted, step s53040 of, at the STB, receiving the content, into which the WM is inserted, and outputting the incompressible A/V data, step s53050 of, at the WM detector, detecting the WM, and step s53060, at the WM manager, parsing the detected WM may be equal to the above-described steps.

The WM manager may communicate with the remote server via the parsed destination type field 0x05. The WM manager may generate a URL using the URL protocol type field value and the URL value. In addition, a URL may be finally generated using the content ID and the timestamp value. The WM manager may make a request using the final URL (s53070).

The remote server may receive the request and transmit the URL of the related application suitable for the broadcast program to the WM manager (s53080). The WM manager may send the received URL of the application to the browser and launch the application (s53090).

Similarly to the above description, the WM detector and the WM manager of the terminal may be combined to perform the functions thereof in one module. In this case, steps s53050, s53060, s53070 and s53090 may be performed in one module.

FIG. 29 is a diagram showing the structure of data to be inserted into a WM according to embodiment #3 of the present invention.

The present invention proposes a delivery type field as one of data which can be delivered via a watermarking scheme. In addition, the present invention proposes an efficient data structure of a delivery type field.

In order to reduce deterioration in quality of audio/video content due to increase in amount of data inserted into the WM, the WM may be divided and inserted. In order to indicate whether the WM is divided and inserted, a delivery type field may be used. Via the delivery type field, it may be determined whether one WM or several WMs are detected in order to acquire broadcast related information.

If the delivery type field has a value of 0, this may mean that all data is inserted into one WM and transmitted. If the delivery type field has a value of 1, this may mean that data is divided and inserted into several WMs and transmitted.

In the present embodiment, the value of the delivery type field is 0. In this case, the data structure of the WM may be configured in the form of attaching the delivery type field to the above-described data structure. Although the delivery type field is located at a foremost part in the present invention, the delivery type field may be located elsewhere.

The WM manager or the WM detector may parse the WM by referring to the length of the WM if the delivery type field has a value of 0. At this time, the length of the WM may be computed in consideration of the number of bits of a predetermined field. For example, as described above, the length of the event field may be 3 bits. The size of the content ID and the URL may be changed but the number of bits may be restricted according to embodiments.

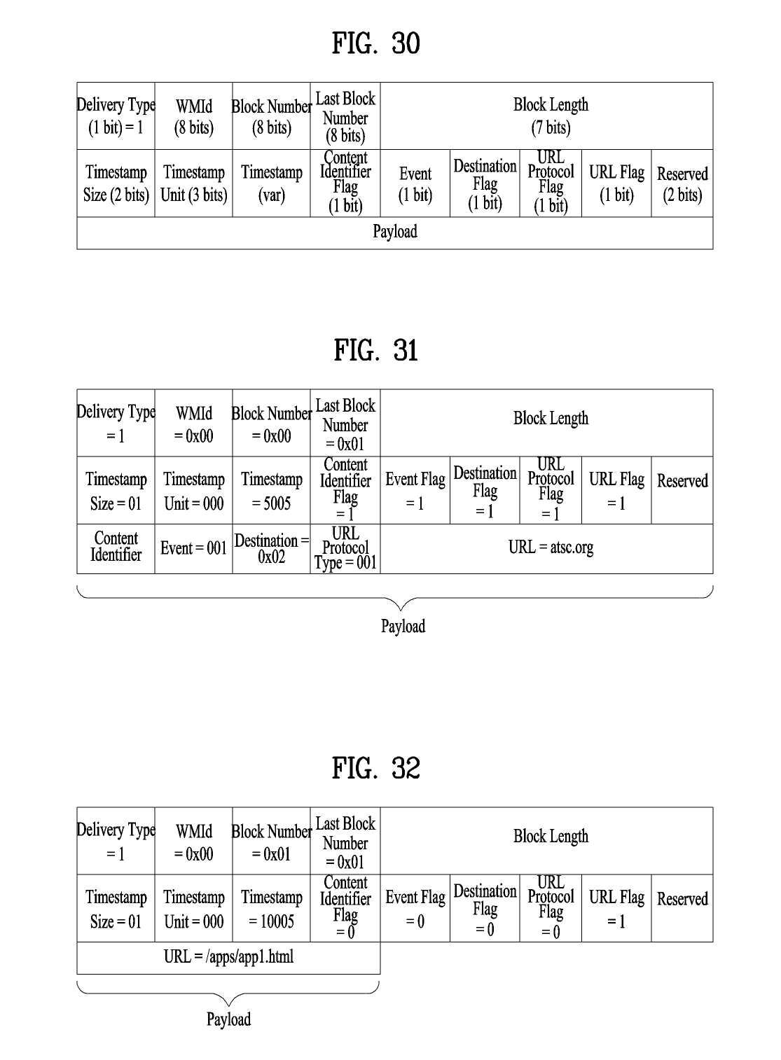

FIG. 30 is a diagram showing the structure of data to be inserted into a WM according to embodiment #4 of the present invention.

In the present embodiment, the value of the delivery type field may be 1. In this case, several fields may be added to the data structure of the WM.

A WMId field serves as an identifier for identifying a WM. If data is divided into several WMs and transmitted, the WM detector needs to identify each WM having divided data. At this time, the WMs each having the divided data may have the same WMId field value. The WMId field may have a size of 8 bits.

A block number field may indicate an identification number of a current WM among the WMs each having divided data. The values of the WMs each having divided data may increase by 1 according to order of transmission thereof. For example, in the case of a first WM among the WMs each having divided data, the value of the block number field may be 0x00. A second WM, a third WM and subsequent WMs thereof may have values of 0x01, 0x02, . . . . The block number field may have a size of 8 bits.

A last block number field may indicate an identification number of a last WM among WMs each having divided data. The WM detector or the WM manager may collect and parse the detected WMs until the value of the above-described block number field becomes equal to that of the last block number field. The last block number field may have a size of 8 bits.

A block length field may indicate a total length of the WM. Here, the WM means one of the WMs each having divided data. The block length field may have a size of 7 bits.

A content ID flag field may indicate whether a content ID is included in payload of a current WM among WMs each having divided data. If the content ID is included, the content ID flag field may be set to 1 and, otherwise, may be set to 0. The content ID flag field may have a size of 1 bit.

An event flag field may indicate whether an event field is included in payload of a current WM among WMs each having divided data. If the event field is included, the event flag field may be set to 1 and, otherwise, may be set to 0. The event flag field may have a size of 1 bit.

A destination flag field may indicate whether a destination type field is included in payload of a current WM among WMs each having divided data. If the destination type field is included, the destination flag field may be set to 1 and, otherwise, may be set to 0. The destination flag field may have a size of 1 bit.

A URL protocol flag field may indicate whether a URL protocol type field is included in payload of a current WM among WMs each having divided data. If the URL protocol type field is included, the URL protocol flag field may be set to 1 and, otherwise, may be set to 0. The URL protocol flag field may have a size of 1 bit.

A URL flag field may indicate whether URL information is included in payload of a current WM among WMs each having divided data. If the URL information is included, the URL flag field may be set to 1 and, otherwise, may be set to 0. The URL flag field may have a size of 1 bit.

The payload may include real data in addition to the above-described fields.

If data is divided into several WMs and transmitted, it is necessary to know information about when each WM is inserted. In this case, according to embodiments, a timestamp may be inserted into each WM. At this time, a timestamp type field may also be inserted into the WM, into which the timestamp is inserted, in order to know when the WM is inserted. Alternatively, according to embodiments, the receiver may store and use WM timestamp type information. The receiver may perform time synchronization based on a first timestamp, a last timestamp or each timestamp.

If data is divided into several WMs and transmitted, the size of each WM may be adjusted using the flag fields. As described above, if the amount of data transmitted by the WM increases, the quality of audio/video content may be influenced. Accordingly, the size of the WM inserted into a frame may be adjusted according to the transmitted audio/video frame. At this time, the size of the WM may be adjusted by the above-described flag fields.

For example, assume that any one of video frames of content has a black screen only. If a scene is switched according to content, one video frame having a black screen only may be inserted. In this video frame, the quality of content may not deteriorate even when a large amount of WMs is inserted. That is, a user does not sense deterioration in content quality. In this case, A WM having a large amount of data may be inserted into this video frame. At this time, most of the values of the flag fields of the WM inserted into the video frame may be 1. This is because the WM have most of the fields. In particular, a URL field having a large amount of data may be included in that WM. Therefore, a relatively small amount of data may be inserted into other video frames. The amount of data inserted into the WM may be changed according to designer's intention.

FIG. 31 is a diagram showing the structure of data to be inserted into a first WM according to embodiment #4 of the present invention.

In the present embodiment, if the value of the delivery type field is 1, that is, if data is divided into several WMs and transmitted, the structure of a first WM may be equal to that shown in the figure.

Among WMs each having divided data, a first WM may have a block number field value of 0x00. According to embodiments, if the value of the block number field is differently used, the shown WM may not be a first WM.

The receiver may detect the first WM. The detected WM may be parsed by the WM manager. At this time, it can be seen that the delivery type field value of the WM is 1 and the value of the block number field is different from that of the last block number field. Accordingly, the WM manager may store the parsed information until the remaining WM having a WMID of 0x00 is received. In particular, atsc.org which is URL information may also be stored. Since the value of the last block number field is 0x01, when one WM is further received in the future, all WMs having a WMID of 0x00 may be received.

In the present embodiment, all the values of the flag fields are 1. Accordingly, it can be seen that information such as the event field is included in the payload of this WM. In addition, since the timestamp value is 5005, a time corresponding to a part, into which this WM is inserted, may be 5.005 seconds.

FIG. 32 is a diagram showing the structure of data to be inserted into a second WM according to embodiment #4 of the present invention.

In the present embodiment, if the value of the delivery type field is 1, that is, if data is divided into several WMs and transmitted, the structure of a second WM may be equal to that shown in FIG. 13.

Among WMs each having divided data, a second WM may have a block number field value of 0x01. According to embodiments, if the value of the block number field is differently used, the shown WM may not be a second WM.

The receiver may detect the second WM. The WM manager may parse the detected second WM. At this time, since the value of the block number field is equal to that of the last block number field, it can be seen that this WM is a last WM of the WMs having a WMId value of 0x00.

Among the flag fields, since only the value of the URL flag is 1, it can be seen that URL information is included. Since the value of the block number field is 0x01, this information may be combined with already stored information. In particular, the already stored atsc.org part and the /apps/app1.html part included in the second WM may be combined. In addition, in the already stored information, since the value of the URL protocol type field is 001, the finally combined URL may be. This URL may be launched via this browser.

According to the second WM, a time corresponding to a part, into which the second WM is inserted, may be 10.005 seconds. The receiver may perform time synchronization based on 5.005 seconds of the first WM or may perform time synchronization based on 10.005 seconds of the last WM. In the present embodiment, the WMs are transmitted twice at an interval of 5 seconds. Since only audio/video may be transmitted during 5 seconds for which the WM is not delivered, deterioration in quality of content may be prevented. That is, even when data is divided into several WMs and transmitted, quality deterioration may be reduced. A time when the WM is divided and inserted may be changed according to embodiments.

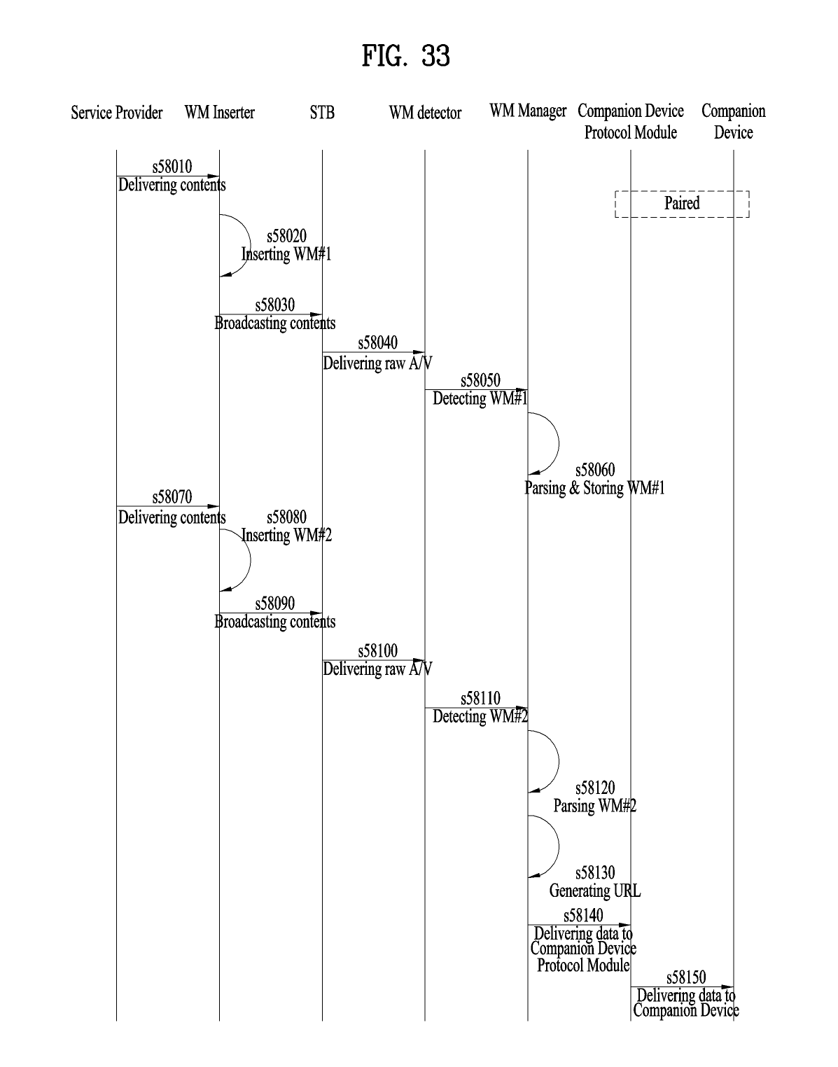

FIG. 33 is a flowchart illustrating a process of processing the structure of data to be inserted into a WM according to embodiment #4 of the present invention.

Step s58010 of, at the service provider, delivering content to the WM inserter, step s58020 of, at the WM inserter, inserting the received content into the WM #1, step s58030 of, at the WM inserter, transmitting the content, into which the WM #1 is inserted, step s58040 of, at the STB, receiving the content, into which the WM #1 is inserted, and outputting the incompressible A/V data, and step s58050 of, at the WM detector, detecting the WM #1 may be equal to the above-described steps.

WM #1 means one of WMs into which divided data is inserted and may be a first WM in embodiment #4 of the present invention. As described above, the block number field of this WM is 0x00 and URL information may be atsc.org.

The WM manager may parse and store detected WM #1 (s58060). At this time, the WM manager may perform parsing by referring to the number of bits of each field and the total length of the WM. Since the value of the block number field is different from the value of the last block number field and the value of the delivery type field is 1, the WM manager may parse and store the WM and then wait for a next WM.

Here, step s58070 of, at the service provider, delivering the content to the WM inserter, step s58080 of, at the WM inserter, inserting the received content to WM #2, step s58090 of, at the WM inserter, transmitting the content, into which WM #2 is inserted, step s58100 of, at the STB, receiving the content, into which WM #2 is inserted, and outputting incompressible A/V data and/or step s58110 of, at the WM detector, detecting WM #2 may be equal to the above-described steps.

WM #2 means one of WMs into which divided data is inserted and may be a second WM in embodiment #4 of the present invention. As described above, the block number field of this WM is 0x01 and URL information may be /apps/app1.html.

The WM manager may parse and store detected WM #2 (s58120). The information obtained by parsing WM #2 and the information obtained by parsing already stored WM #1 may be combined to generate an entire URL (s58130). In this case, the entire URL may be as described above.

Step s58140 of, at the WM manager, delivering related data to the companion device protocol module of the receiver according to the destination type field and step s58150 of, at the companion device protocol module, delivering related data to the companion device according to the destination type field may be equal to the above-described steps.

The destination type field may be delivered by WM #1 as described above. This is because the destination flag field value of the first WM of embodiment #4 of the present invention is 1. As described above, this destination type field value may be parsed and stored. Since the destination type field value is 0x02, this may indicate data for a smartphone.

The companion device protocol module may communicate with the companion device to process the related information, as described above. As described above, the WM detector and the WM manager may be combined. The combined module may perform the functions of the WM detector and the WM manager.

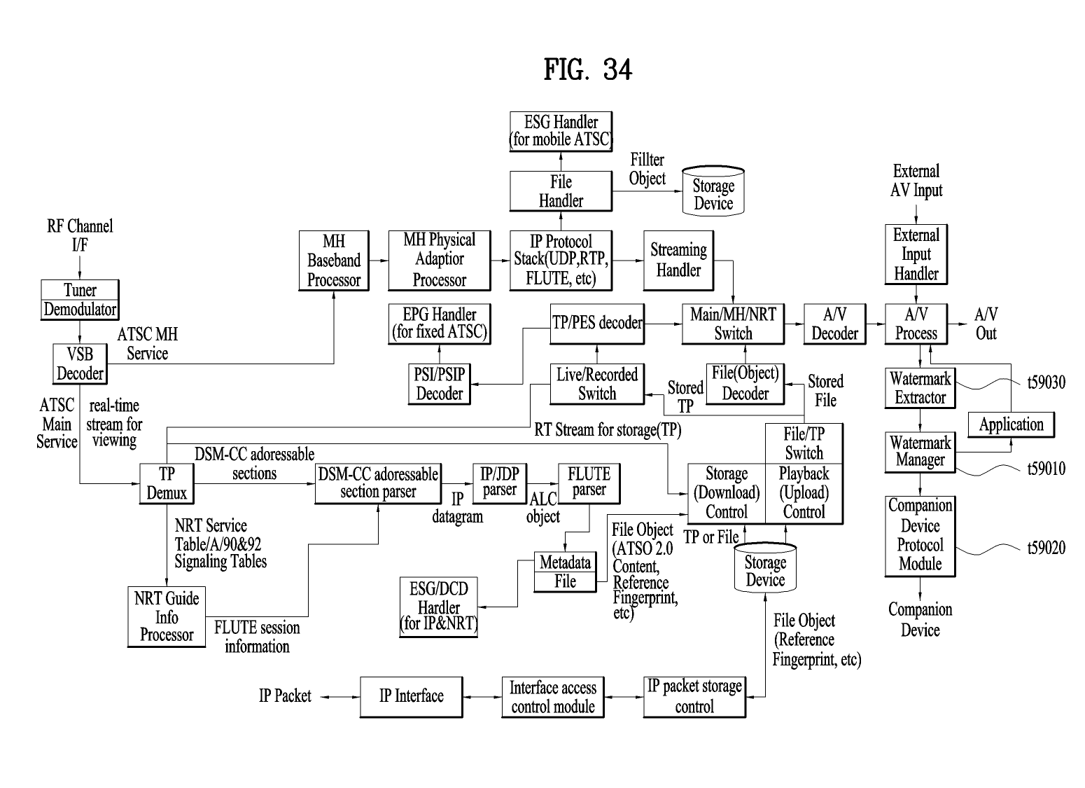

FIG. 34 is a diagram showing the structure of a watermark based image display apparatus according to another embodiment of the present invention.

This embodiment is similar to the structure of the above-described watermark based image display apparatus, except that a WM manager t59010 and a companion device protocol module t59020 are added under a watermark extractor s59030. The remaining modules may be equal to the above-described modules.

The watermark extractor t59030 may correspond to the above-described WM detector. The watermark extractor t59030 may be equal to the module having the same name as that of the structure of the above-described watermark based image display apparatus. The WM manager t59010 may correspond to the above-described WM manager and the companion device protocol module t59020 may correspond to the above-described companion device protocol module. Operations of the modules have been described above.

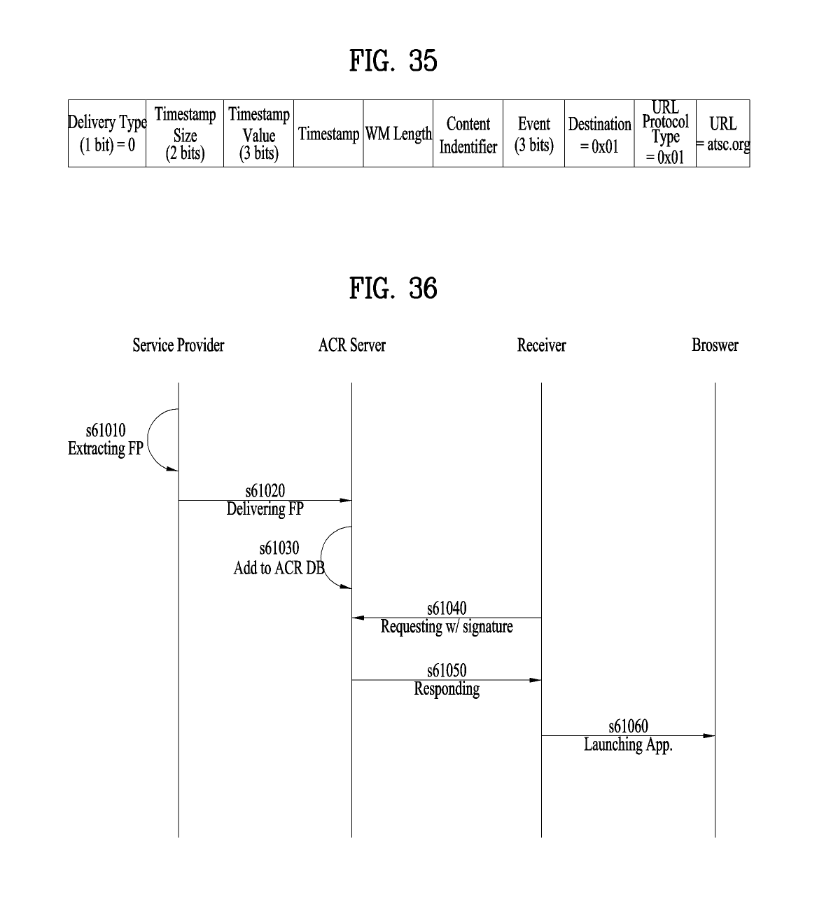

FIG. 35 is a diagram showing a data structure according to one embodiment of the present invention in a fingerprinting scheme.

In the case of a fingerprinting (FP) ACR system, deterioration in quality of audio/video content may be reduced as compared to the case of using a WM. In the case of the fingerprinting ACR system, since supplementary information is received from an ACR server, quality deterioration may be less than that of the WM directly inserted into content.

When information is received from the ACR server, since quality deterioration is reduced as described above, the data structure used for the WM may be used without change. That is, the data structure proposed by the present invention may be used even in the FP scheme. Alternatively, according to embodiments, only some of the WM data structure may be used.

If the above-described data structure of the WM is used, the meaning of the destination type field value of 0x05 may be changed. As described above, if the value of the destination type field is 0x05, the receiver requests data from the remote server. In the FP scheme, since the function of the remote server is performed by the ACR server, the destination type field value 0x05 may be deleted or redefined.

The remaining fields may be equal to the above-described fields.

FIG. 36 is a flowchart illustrating a process of processing a data structure according to one embodiment of the present invention in a fingerprinting scheme.

A service provider may extract a fingerprint (FP) from a broadcast program to be transmitted (s61010). Here, the service provider may be equal to the above-described service provider. The service provider may extract the fingerprint per content using a tool provided by an ACR company or using a tool thereof. The service provider may extract an audio/video fingerprint.

The service provider may deliver the extracted fingerprint to an ACR server (s61020). The fingerprint may be delivered to the ACR server before a broadcast program is transmitted in the case of a pre-produced program or as soon as the FP is extracted in real time in the case of a live program. If the FP is extracted in real time and delivered to the ACR server, the service provider may assign a content ID to content and assign information such as a transmission type, a destination type or a URL protocol type. The assigned information may be mapped to the FP extracted in real time and delivered to the ACR server.

The ACR server may store the received FP and related information thereof in an ACR DB (s61030). The receiver may extract the FP from an externally received audio/video signal. Here, the audio/video signal may be an incompressible signal. This FP may be referred to as a signature. The receiver may send a request to the server using the FP (s61040).

The ACR server may compare the received FP and the ACR DB. If an FP matching the received FP is present in the ACR DB, the content broadcast by the receiver may be recognized. If the content is recognized, delivery type information, timestamp, content ID, event type information, destination type information, URL protocol type information, URL information, etc. may be sent to the receiver (s61050).

Here, each piece of information may be transmitted in a state of being included in the above-described field. For example, the destination type information may be transmitted in a state of being included in the destination type field. When responding to the receiver, the data structure used in the above-described WM may be used as the structure of the delivered data.

The receiver may parse the information received from the ACR server. In the present embodiment, since the value of the destination type field is 0x01, it can be seen that the application of the URL is executed by the TV. A final URL may be generated using the value of the URL protocol type field and the URL information. The process of generating the URL may be equal to the above-described process.

The receiver may execute a broadcast related application via a browser using the URL (s61060). Here, the browser may be equal to the above-described browser. Steps s61040, s614050 and s61060 may be repeated.

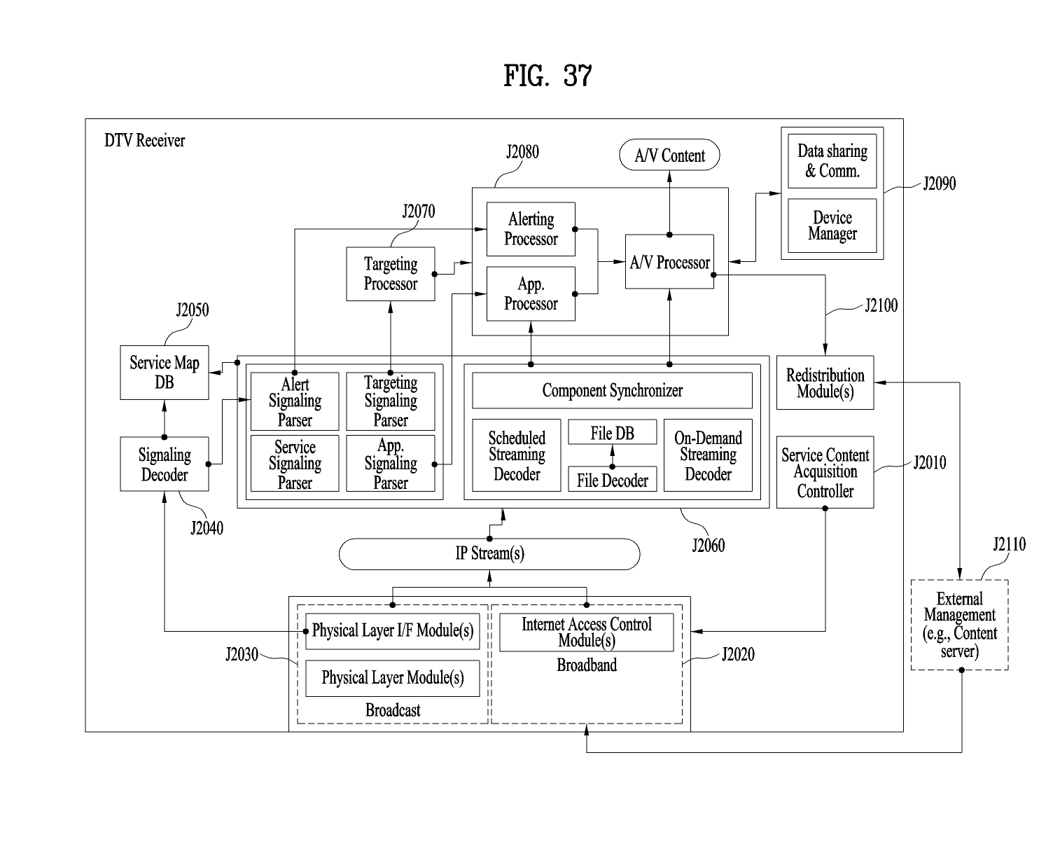

FIG. 37 is a view showing a broadcast receiver according to an embodiment of the present invention.

The broadcast receiver according to an embodiment of the present invention includes a service/content acquisition controller J2010, an Internet interface J2020, a broadcast interface J2030, a signaling decoder J2040, a service map database J2050, a decoder J2060, a targeting processor J2070, a processor J2080, a managing unit J2090, and/or a redistribution module J2100. In the figure is shown an external management device J2110 which may be located outside and/or in the broadcast receiver.

The service/content acquisition controller J2010 receives a service and/or content and signaling data related thereto through a broadcast/broadband channel. Alternatively, the service/content acquisition controller J2010 may perform control for receiving a service and/or content and signaling data related thereto.

The Internet interface J2020 may include an Internet access control module. The Internet access control module receives a service, content, and/or signaling data through a broadband channel. Alternatively, the Internet access control module may control the operation of the receiver for acquiring a service, content, and/or signaling data.

The broadcast interface J2030 may include a physical layer module and/or a physical layer I/F module. The physical layer module receives a broadcast-related signal through a broadcast channel. The physical layer module processes (demodulates, decodes, etc.) the broadcast-related signal received through the broadcast channel. The physical layer I/F module acquires an Internet protocol (IP) datagram from information acquired from the physical layer module or performs conversion to a specific frame (for example, a broadcast frame, RS frame, or GSE) using the acquired IP datagram.

The signaling decoder J2040 decodes signaling data or signaling information (hereinafter, referred to as ‘signaling data’) acquired through the broadcast channel, etc.

The service map database J2050 stores the decoded signaling data or signaling data processed by another device (for example, a signaling parser) of the receiver.

The decoder J2060 decodes a broadcast signal or data received by the receiver. The decoder J2060 may include a scheduled streaming decoder, a file decoder, a file database (DB), an on-demand streaming decoder, a component synchronizer, an alert signaling parser, a targeting signaling parser, a service signaling parser, and/or an application signaling parser.

The scheduled streaming decoder extracts audio/video data for real-time audio/video (A/V) from the IP datagram, etc. and decodes the extracted audio/video data.

The file decoder extracts file type data, such as NRT data and an application, from the IP datagram and decodes the extracted file type data.

The file DB stores the data extracted by the file decoder.

The on-demand streaming decoder extracts audio/video data for on-demand streaming from the IP datagram, etc. and decodes the extracted audio/video data.

The component synchronizer performs synchronization between elements constituting a content or between elements constituting a service based on the data decoded by the scheduled streaming decoder, the file decoder, and/or the on-demand streaming decoder to configure the content or the service.

The alert signaling parser extracts signaling information related to alerting from the IP datagram, etc. and parses the extracted signaling information.

The targeting signaling parser extracts signaling information related to service/content personalization or targeting from the IP datagram, etc. and parses the extracted signaling information. Targeting is an action for providing content or service satisfying conditions of a specific viewer. In other words, targeting is an action for identifying content or service satisfying conditions of a specific viewer and providing the identified content or service to the viewer.

The service signaling parser extracts signaling information related to service scan and/or a service/content from the IP datagram, etc. and parses the extracted signaling information. The signaling information related to the service/content includes broadcasting system information and/or broadcast signaling information.

The application signaling parser extracts signaling information related to acquisition of an application from the IP datagram, etc. and parses the extracted signaling information. The signaling information related to acquisition of the application may include a trigger, a TDO parameter table (TPT), and/or a TDO parameter element.

The targeting processor J2070 processes the information related to service/content targeting parsed by the targeting signaling parser.

The processor J2080 performs a series of processes for displaying the received data. The processor J2080 may include an alert processor, an application processor, and/or an A/V processor.

The alert processor controls the receiver to acquire alert data through signaling information related to alerting and performs a process for displaying the alert data.

The application processor processes information related to an application and processes a state of an downloaded application and a display parameter related to the application.

The A/V processor performs an operation related to audio/video rendering based on decoded audio data, video data, and/or application data.

The managing unit J2090 includes a device manager and/or a data sharing & communication unit.

The device manager performs management for an external device, such as addition/deletion/renewal of an external device that can be interlocked, including connection and data exchange.

The data sharing & communication unit processes information related to data transport and exchange between the receiver and an external device (for example, a companion device) and performs an operation related thereto. The transportable and exchangeable data may be signaling data and/or A/V data.

The redistribution module J2100 performs acquisition of information related to a service/content and/or service/content data in a case in which the receiver cannot directly receive a broadcast signal.

The external management device J2110 refers to modules, such as a broadcast service/content server, located outside the broadcast receiver for providing a broadcast service/content. A module functioning as the external management device may be provided in the broadcast receiver.

The receiving apparatus (or a receiver or an ATSC 3.0 receiver) according to the present embodiment may include the TV receiver or the receiver that processes broadcast signals described with reference to FIGS. 1. The receiving apparatus according to the present embodiment may receive contents received through a broadband channel in addition to broadcast signals transmitted through a broadcast channel. A service provided by the broadcast signals and the contents according to the present embodiment may be referred to as a hybrid broadcast service. The term and definition may be changed by a designer.

Hereinafter, a signaling method via ACR in a multicast environment according to an embodiment of the present invention will be described.

The ACR scheme is used when a SetTopBox (STB) that cannot perform signaling via a broadcast channel is used. In general, information of a currently watched channel or program is acquired via the ACR scheme. Based on the recognition result of the currently watched broadcast channel or program, signaling information may be requested to a separate signaling server through a broadband channel and a unicast form structure can be achieved. However, according to the hybrid broadcast service, a broadcaster may transmit signaling information in multicast through a broadband channel that is not a broadcast network and a receiver may receive and signal the signaling information.

FIG. 38 is a diagram illustrating an ACR transceiving system in a multicast environment according to an embodiment of the present invention.

As described above, in an environment using an STB, a receiver cannot receive signaling information transmitted through a broadcast network. However, when minimum information for acquisition of signaling such as a currently watched channel or program is received via an ACR scheme, signaling can be directly received in multicast without conventionally periodic request and response procedures.

FIG. 38 shows a procedure for receiving signaling information in multicast by a receiver according to an embodiment of the present invention. Operations of blocks illustrated in FIG. 38 are the same as in the above description, and thus an operation of a receiver for receiving the signaling and service of broadcast related information via ACR in a multicast environment will be described.

When the receiver can access a broadband (that is, when the receiver can use the Internet), the receiver may join a multicast session.

Then the receiver may detect a currently received broadcast signal or broadcast information based on A/V transmitted to a STB via the ACR scheme.

Then the receiver may parse required signaling information of signaling information transmitted in multicast using the recognized broadcast information and provide a related service to a user.

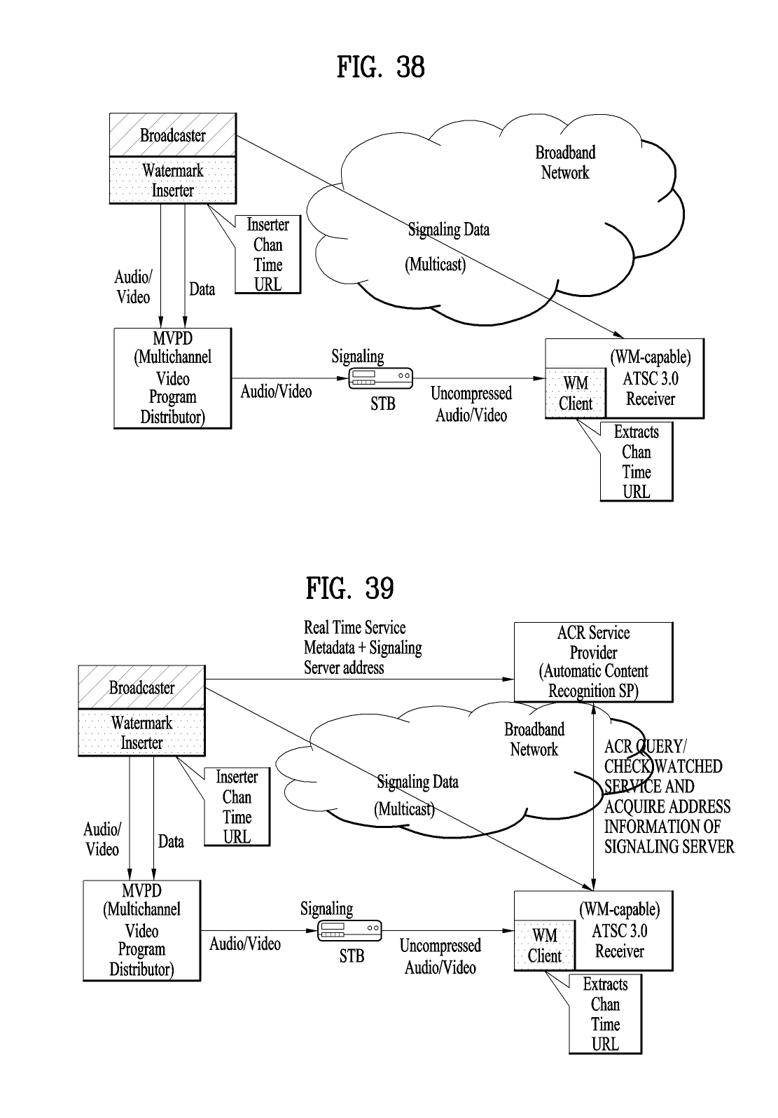

FIG. 39 is a diagram of an ACR transceiving system via a WM in a multicast environment according to an embodiment of the present invention.

An upper portion of the diagram illustrates an ACR transceiving system when a signaling server address is inserted into the WM, and a lower portion of the diagram illustrates an ACR transceiving system when only an ACR server address is inserted into the WM and a receiver acquires a channel, a program, a signaling server address, etc. of currently watched broadcast by requesting and responding the corresponding ACR server.

Operations of blocks illustrated in FIG. 20 are the same as in the above description, and thus an operation of a receiver for receiving signaling and a service of broadcast related information via ACR in a multicast environment will be described below.

In the case of the transceiving system illustrated in the upper portion of the drawing, since the signaling server address is inserted into the WM, the receiver can extract a WM, acquire the corresponding signaling server address, and join a signaling server session to acquire signaling information.

In the case of the transceiving system illustrated in the lower portion of the drawing, since only the ACR server address is inserted into the WM, the receiver can acquire an address of a signaling server from the ACR server.

An operation of a receiver for receiving signaling and a service of broadcast related information via ACR in a multicast environment is the same as in the description of FIG. 38, and thus a detailed description will be omitted herein.

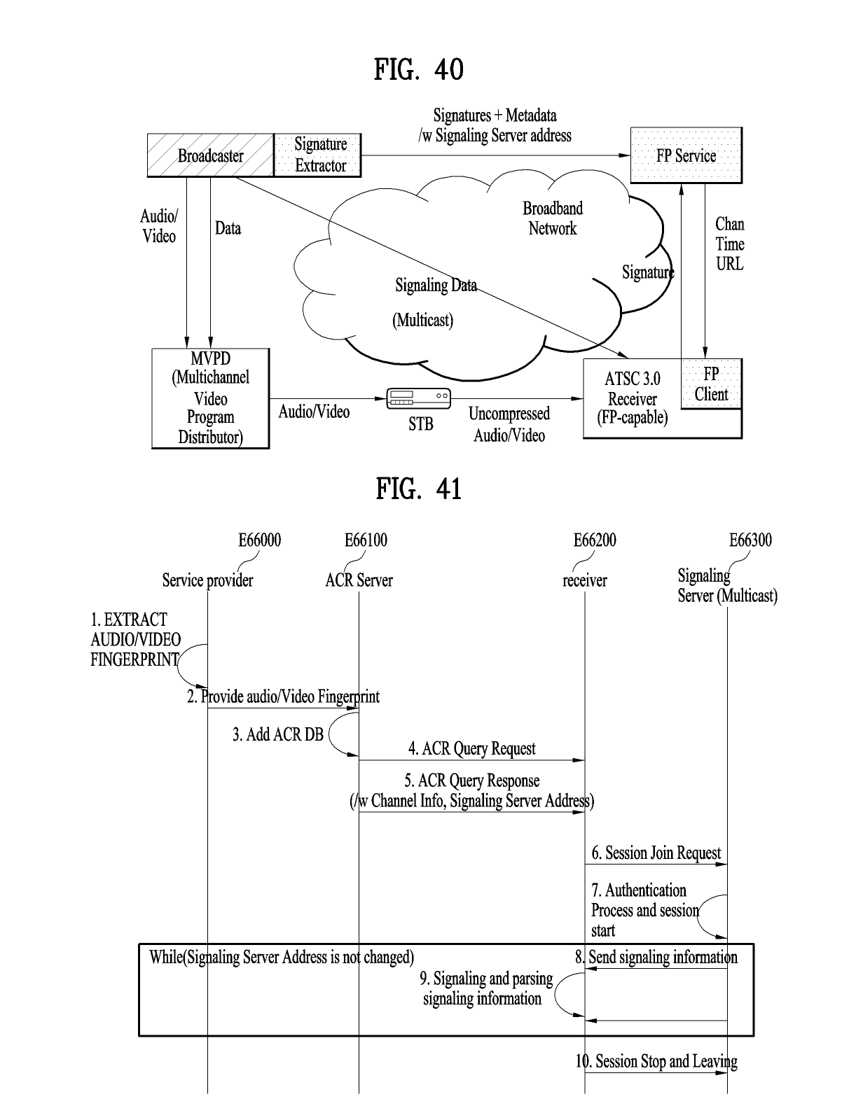

FIG. 40 is a diagram illustrating an ACR transceiving system via an FP scheme in a multicast environment according to an embodiment of the present invention.

As described above, a receiver may extract an FP from an audio/video signal. Then the receiver may transmit the extracted signature (or FP) to an FP server and receive a signaling server address in addition to information of a current channel and program from an FP server. Then the receiver may join a server session and receive signaling information.

An operation of a receiver for receiving signaling and a service of broadcast related information via ACR in a multicast environment is the same as in the description of FIG. 19, and thus a detailed description will be omitted herein.

FIG. 41 is a flowchart of performing of signaling associated with broadcast via an ACR scheme in a multicast environment by a receiver according to an embodiment of the present invention.

A service provider may multicast signaling information associated with broadcast via a broadband channel as well as via a broadcast network. The receiver that receives the signaling information may join a multicast session and perform a communication procedure for receiving corresponding signaling in order to acquire the corresponding signaling information.

The receiver according to an embodiment of the present invention acquires an address of a signaling server (or a multicast server) via the following method.

First Embodiment: Upon receiving a recognition result of a currently watched channel from an ACR server, the receiver may also receive an address (e.g., URL, IP address, etc.,) of a multicast server of the corresponding channel.

Second Embodiment: Upon directly storing multicast server addressees of respective channels in the receiver and receiver a channel recognition result from an ACR server, the receiver may access a multicast server of the corresponding channel.

The aforementioned embodiments may be changed according to a designer's intention.

Hereinafter, a flowchart for performing of signaling associated with broadcast via an ACR scheme in a multicast environment by the receiver illustrated in the diagram in a multicast environment will be described. The ACR scheme of the diagram refers to the case of the aforementioned fingerprinting method.

A service provider E66000 may extract fingerprint for each respective program (content) using a tool provided by an ACR provider. In this case, the service provider E66000 may establish an audio/video fingerprint DB. The service provider E66000 may extract and store both two fingerprints as necessary. The service provider E66000 may transmit the fingerprint extracted from the content to an ACR server E66100. A time point for transmission of a fingerprint may be changed according to the property of a program. In detail, in the case of a pre-manufactured program, the corresponding fingerprint may be transmitted before the corresponding program may be transmitted in broadcast, and in the case of a live program, the corresponding program may be transmitted in real time as soon as the fingerprint is extracted. In this case, the service provider E66000 may previously give information from which content about a program can be recognized, and may map the information to the extracted fingerprint and transmit the information in real time.

The ACR server E66100 may store the received FP and related information in the ACR DB. A detailed description thereof is the same as in the above description of FIG. 36, and thus will be omitted herein.

Then a receiver E66200 may extract a fingerprint from an audio/video signal from an external input and transmit ACR Query Request to the ACR server E66100. The ACR server E66100 may transmit ACR Query Response to the receiver E66200 in response to the received ACR Query Request. In detail, the ACR server E66100 may search ACR DB for content matched with the received fingerprint. Then upon recognizing content, the ACR server E66100 may transmit ACR Query Response. The ACR Query Response may include channel Info, signaling server address (Multicast serve address), etc. of the corresponding content.

Then the receiver E66200 may transmit a multicast session join request to a corresponding signaling server (multicast server) E66300 using a signaling server address included in the received ACR Query Response.

The signaling server address may be configured as a representative address for each respective service provider or configured as a representative address of a specific channel. According to each case, a service provider may perform server management.

In addition, when one service provider owns a plurality of channels and configures a signaling server address as a representative address, the receiver may also transmit channel identification information such as channel ID and perform signaling on a specific channel upon transmitting a request to the corresponding signaling server.

The signaling server E66300 may perform an authentication process on the receiver E66200 in response to the received multicast session join request, may access a session, and maintain the access. When sessions between the receiver E66200 and the signaling server E66300 are connected, the signaling server E66300 may continuously transmit signaling information to the receiver E66200 without special transmission of request and response.

The receiver E66200 may signal and parse the received information. The corresponding operation may be repeatedly performed until the signaling server address is changed. In addition, the receiver E66200 may provide a service of the corresponding channel or program to the user based on the parsing result.

Then when the signaling server address is changed or related signaling information does not have to be parsed, the receiver E66200 may transmit a request for termination of the corresponding session and leave the corresponding session.

In the case of an ACR scheme using WaterMarking, a signaling server address may be inserted during WM insertion and signaling may be performed via the aforementioned process.

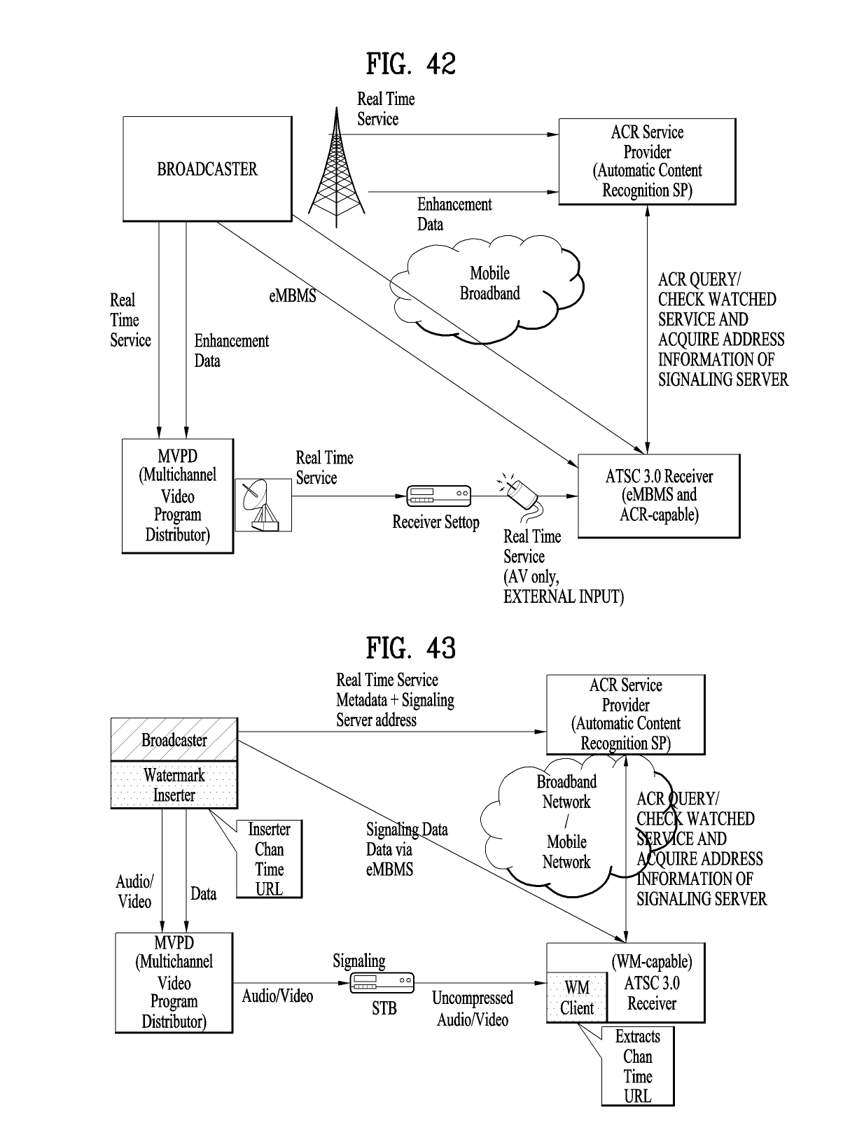

FIG. 42 is a diagram illustrating an ACR transceiving system in a mobile network environment according to an embodiment of the present invention.

An ACR transceiving system in a mobile network environment according to an embodiment of the present invention is a system obtained via combination with an evolved Multimedia Broadcast Multicast Service (eMBMS) of an LTE/LTE-A service. The eMBMS is technology for simultaneously providing a mobile broadcast service in a legacy LTE/LTE-A service. Accordingly, when the eMBMS is used, a broadcast system may be established via a mobile communication network. A future broadcast system can provide a hybrid broadcast service transmitted using both a legacy broadcast network and a mobile communication network (mobile broadband). As a hybrid broadcast service according to an embodiment of the present invention, a base layer component of a corresponding service may be transmitted through a broadcast network and an enhanced layer component for a UHD service, etc. may be transmitted through a mobile broadband. In addition, as a hybrid broadcast service according to an embodiment of the present invention, a service provider may transmit related signaling information to a receiver using a table, etc. used in a conventional eMBMS.

FIG. 42 is a diagram illustrating a process of receiving signaling information through a mobile broadband by a receiver according to an embodiment of the present invention.

FIG. 42 illustrates a process of receiving signaling information or related broadcast information through a mobile broadband by a receiver according to an embodiment of the present invention. Operations of blocks illustrated in FIG. 42 are the same as in the above description, and thus a detailed description thereof will be omitted herein. In addition, the ACR scheme that can be applied to the receiver illustrated in FIG. 42 may be at least one of WM and FP methods.

FIG. 43 is a diagram illustrating a process of receiving signaling information through a mobile broadband by a receiver according to another embodiment of the present invention. FIG. 43 illustrates the case in which the ACR scheme applied to the receiver is a WM method. A detailed operation, etc. are the same as in the above description, and thus a detailed description thereof will be omitted herein.

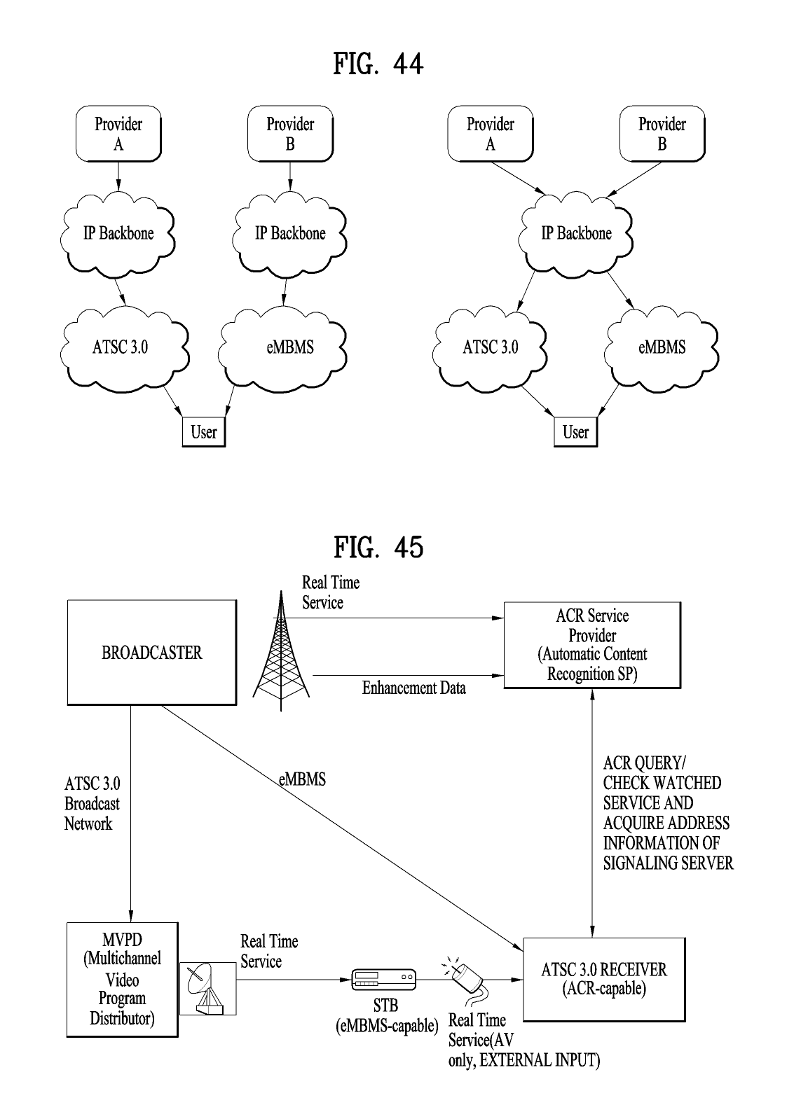

FIG. 44 is a diagram illustrating the concept of a hybrid broadcast service according to an embodiment of the present invention.

A hybrid broadcast service including both the broadcast service according to an embodiment of the present invention described above and the aforementioned eMBMS service may be classified into two services illustrated in the diagram according to a form in which the service is provide to a user.

Blocks illustrated in a left portion of the diagram show a hybrid broadcast service when service providers or contents of broadcast data provided by respective networks are different. Blocks illustrated in a right portion of the diagram show a hybrid broadcast service when service providers simultaneously provide the same content in respective networks.

In the case of the hybrid broadcast service illustrated in the left portion of the diagram, a service through the aforementioned broadcast network and a service provided through an eMBMS are provided through different networks, and thus a receiver may independently acquire a service for each respective network. In addition, receivers between networks may acquire services via respective different procedures.

In detail, a case in which contents provided by respective networks are different according to another embodiment of the present invention may correspond to a case in which a broadcaster (service provider A) provides a service through a broadcast network and a communication company (service provider B) provides a service through a mobile communication network or a case in which respective broadcast content companies subscribe to communication networks and provide services. That is, the case according to another embodiment of the present invention may correspond to a case in which a subject providing a service using a broadcast network and a subject providing a service using a communication network are different or a case in which broadcast data is processed or transmitted via separate systems until the broadcast data is transmitted to a user. In this case, the broadcast service is divided for each respective network and processed and transmitted to the user, and thus the receiver may include a module for processing a service corresponding to each respective network.

In this case, the receiver may receive different channels/program information through two networks and provide the channel/program information to the user. In this case, services transmitted to a broadcast network may be received by the receiver through a STB and a plurality of pieces of signaling information may be transmitted via an ACR scheme. Accordingly, the receiver may acquire signaling information associated with broadcast using the aforementioned methods. However, the channel or program information received through an eMBMS can be directly received by the receiver, and thus can be applied irrespective of an ACR scheme.

In the case of the hybrid broadcast service illustrated in the right portion of the diagram, the service providers A and B simultaneously transmit the same content through respective networks, and thus hybrid broadcast service data may be appropriately divided in an IP backbone network before being transmitted to a broadcast network and an eMBMS network.

In this case, the hybrid broadcast service may be transmitted to respective receivers through a broadcast network and an eMBMS network according to a situation.

In the case of the hybrid broadcast service illustrated in the right portion of the diagram, it is advantageous that a system transmitting broadcast data does not have to be checked while a user receives the broadcast data and various broadcasters and content providing companies can receive broadcast data compared with a conventional broadcast environment. In addition, it is advantageous that a receiver can be easily designed because a user interface (UI) associated with broadcast can be unified and embodied.

In this case, the receiver may receive the same channel or program using different networks and receive signaling information about the corresponding channel or program through an eMBMS. However, it may be confirmed that, when an eMBMS network cannot be temporally or permanently used, the receiver can receive only A/V from a STB and cannot use the eMBMS network. In this case, the receiver may receive signaling information using the aforementioned ACR scheme. A signaling server may transmit signaling information to the receiver using a unicast or multicast method, as described above.

Alternatively, even if the eMBMS network can be used, when A/V of broadcast that a user currently watches is transmitted through a STB, the receiver cannot map the signaling information received through the eMBMS to the currently watched broadcast content. In this case, the receiver may recognize channel or program information of the currently watched broadcast using the ACR scheme and receive the signaling information received through the eMBMS to provide a service based on the channel or program information.

In addition, when data is received through a mobile broadband, the receiver may transmit and receive signaling information through a mobile broadband channel that is not a general broadband channel, which can be changed according to a designer's intention.

FIG. 45 is a diagram illustrating an ACR transceiving system in a mobile network environment according to another embodiment of the present invention.

FIG. 45 illustrates the case in which a STB receives data through two networks and transmits the corresponding data to a receiver through an external input, etc. according to another embodiment of the present invention of the aforementioned hybrid broadcast service.

As illustrated in the diagram, broadcast data transmitted through a broadcast network may be lastly transmitted to the receiver through a STB. In addition, the STB has eMBMS-capable property, and thus can receive broadcast data transmitted through an eMBMS. In this case, a service provider can function as a MVPD.

Accordingly, both A/V and related signaling information transmitted through a broadcast network and an eMBMS can be transmitted to the receiver through a STB, and thus the receiver can provide only the A/V to the user. In this case, the mobile network environment is the same as a basic ACR environment, and thus the receiver may recognize a currently watched channel/program via the ACR scheme and then receive signaling information from a signaling server and provide the service. A detailed description thereof is the same as in the above description, and thus will be omitted herein.

The ACR scheme according to the present invention can be applied to both a WM method and a FP method. In addition, in the case of the WM method, WM inserted into the A/V transmitted by a service provider is not filtered even if the WM is transmitted to the receiver through a STB.

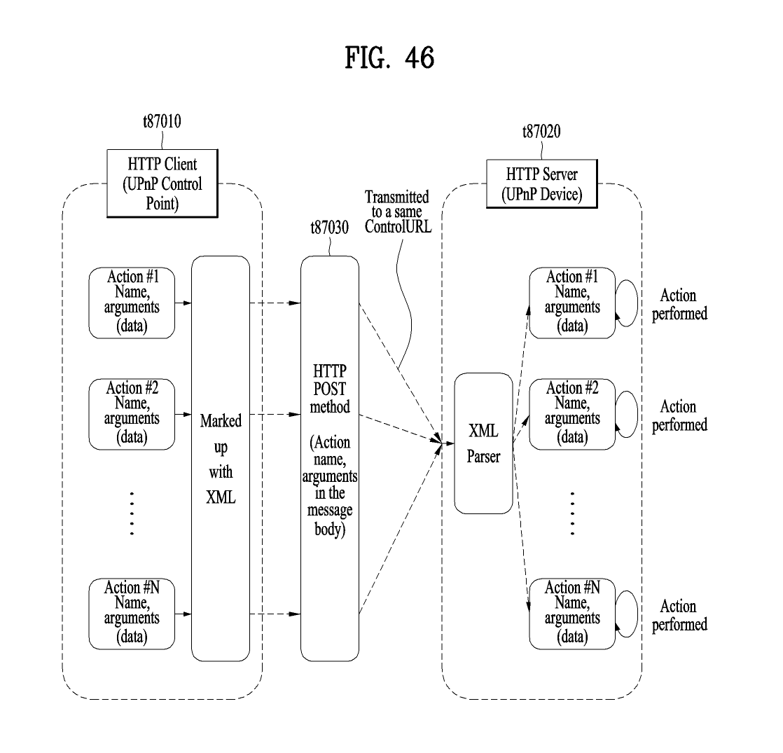

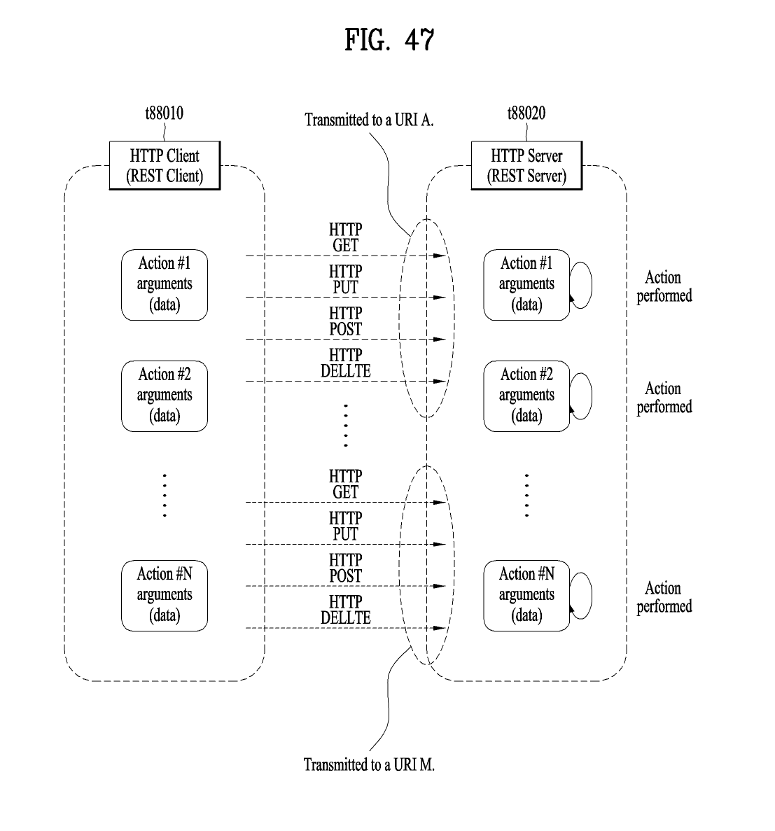

FIG. 46 is a view showing an UPnP type Action mechanism according to an embodiment of the present invention.

First, communication between devices in the present invention will be described.

The communication between devices may mean exchange of a message/command/call/action/request/response between the devices.

In order to stably transmit a message between devices to a desired device, various protocols, such as Internet Control Message Protocol (ICMP) and Internet Group Management Protocol (IGMP), as well as Internet Protocol (IP) may he applied. At this time, the present invention is not limited to a specific protocol.

In order to contain various information in a message used for communication between devices, various protocols, such as Hypertext Transfer Protocol (HTTP), Real-time Transport Protocol (RTP), Extensible Messaging and Presence Protocol (XMPP), and File Transfer Protocol (FTP), may be applied. At this time, the present invention is not limited to a specific protocol.

When a message used for communication between devices is transmitted, various components, such as a message header and a message body, defined by each protocol may be utilized. That is, each message component may he transmitted in a state in which data are stored in each message component and the present invention is not limited to a specific message component. In addition, data transmitted by a message may he transmitted various types (string, integer, floating point, Boolean, character, array, list, etc.) defined by each protocol. In order to structurally express/transmit/store complex data, a Markup scheme, such as Extensible Markup Language (XML), Hypertext Markup Language (HTML), Extensible Hypertext Markup Language (XHTML), and. JavaScript Object Notation (BON), text, or an image format may be applied. At this time, the present invention is not limited to a specific scheme.

In addition, a message used for communication between devices may be transmitted in a state in which data are compressed. The present invention is not limited to application of a specific compression technology.

In the description of the above-described communication between devices in the present invention, one scheme, e.g. a UPnP scheme, will be described. The UPnP scheme may correspond to a case in which IP-TCP/UDP-HTTP protocols are combined in the description of the above-described communication between devices.

The UPnP type Action mechanism according to the embodiment of the present invention shown in the figure may mean a communication mechanism between a UPnP control point and a UPnP device. The UPnP control point t87010 may be an HTTP client and the UPnP device t87020 may be an HTTP server. The UPnP control point t87010 may transmit a kind of message called an action to the UPnP device t87020 such that the UPnP device t87020 can perform a specific action.

The UPnP control point t87010 and the UPnP device t87020 may be paired with each other. Pairing may be performed between the respective devices through a discovery and description transmission procedure. The UPnP control point may acquire a URL through a pairing procedure.

The UPnP control point t87010 may express each action in an XML form. The UPnP control point t87010 may transmit each action to the acquired control URL using a POST method t87030 defined by HTTP. Each action may be data which are to be actually transmitted as a kind of message. This may be transmitted to a HTTP POST message body in an XML form. Each action may include name, arguments, and relevant data. The HTTP POST message body may transmit name and/or arguments of each action.

At this time, each action may be transmitted to the same control URL. The UPnP device t87020 may parse the received action using an XML parser. The UPnP device t87020 may perform a corresponding operation according to each parsed action.

For the UPnP protocol, each action may be defined by name and used. In addition, since the name of the action is also transmitted to the HTTP POST message body, exchange between infinite kinds of actions may be possible even in a case in which only one URL for a target device exists and only one HTTP POST method is used.

FIG. 47 is a view showing a REST mechanism according to an embodiment of the present invention.

In the description of the above-described communication between devices in the present invention, one scheme, e.g. a REST scheme, will be described.

The REST mechanism according to the embodiment of the present invention shown in the figure may mean a communication mechanism between a REST client t88010 and a REST server t88020. The REST client t88010 may be an HTTP client and the REST server t88020 may be an HTTP server. In the same manner as in the above description, the REST client t88010 may transmit a kind of message called an action to the REST server t88020 such that the REST server t88020 can perform a specific action.

In this embodiment, the REST client t88010 may transmit each action to the REST server t88020 through a URI. Action name is not required for each action. Each action may include only arguments and data.

Among HTTP methods, various methods, such as GET, HEAD, PUT, DELETE, TRACE, OPTIONS, CONNECT, and PATCH, as well as POST may be utilized. In addition, a plurality of URIs that will access a target device for communication may be defined. Due to such characteristics, an action may be transmitted without definition of action name. A plurality of URI values necessary for such a REST scheme may be acquired during a discovery or description transmittance procedure.

Data or arguments necessary to be transmitted may be transmitted while being added to a corresponding URL Alternatively, data or arguments may be transmitted while being included in the HTTP body in various forms (XML, JSON, HTML, TEXT, IMAGE, etc.).

The REST server t88020 may perform a specific operation according to the received action.

The above-described communication between devices is only an embodiment and all of the details proposed by the present invention are not limited to the UPnP scheme.

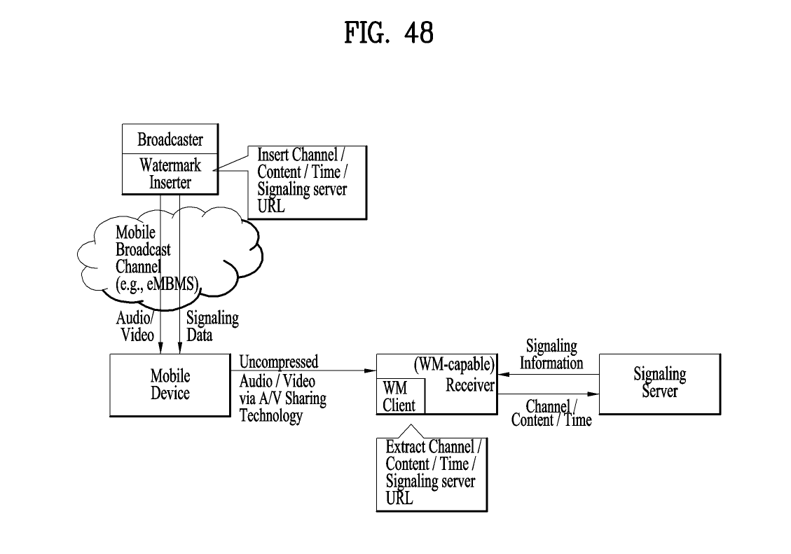

FIG. 48 illustrates an ACR (Auto Content Recognition) procedure using a watermark in an AV (Audio Video) sharing according to an embodiment of the present invention.

LTE/LTE-A are currently provided as fourth generation mobile communication services. LTE/LTE-A services can also provide a mobile broadcast service. Such a mobile broadcast service may be called an eMBMS (evolved Multimedia Broadcast Multicast Service). A broadcast system can be constructed through mobile communication networks using the eMBMS, and various Internet broadcast content can be viewed through mobile devices.

However, viewing environments of mobile devices may be inconvenient due to small screens of the mobile devices. To improve this, AV sharing can be used. AV sharing is a technology for sharing screens of an apparatus having a large screen, such as a TV receiver, and a mobile device. Such AV sharing can be provided by technologies such as UPnP DLNA, WiDi and Miracast.

Only audio/video may be delivered to a fixed device, e.g., a TV receiver, according to AV sharing. That is, signaling information of content or information about additional services (interactive services and the like) may be excluded from a delivery procedure through AV sharing. Such audio/video data may be called uncompressed audio/video data. Further, mobile devices may not receive signaling information or information about additional services from the beginning due to properties of the mobile devices.

To obtain such information, fixed devices having ACR clients may perform ACR. A fixed device can recognize audio/video data delivered from a mobile device and receive related signaling information when reproducing the audio/video data. Additional services or data such as ESG can be provided to users using such signaling information. A watermark and a fingerprint used in the present invention may have watermark/fingerprint structures of the aforementioned various embodiments. That is, the aforementioned URL field, URL protocol field, timestamp related fields may be included in a watermark and information may be divided and included in a plurality of watermarks. A receiving side may recombine such information to obtain the original information. Furthermore, the quantity of data included in a watermark may be controlled depending on the quantity of information contained in frames. Details have been described above.

The illustrated architecture shows a case in which information is directly inserted into a watermark.

First, a broadcaster may broadcast a mobile broadcast through a mobile broadcast network such as the eMBMS. Here, the broadcaster or an additional entity may insert a watermark. The watermark may include the URL of a signaling server, a content ID for identifying the mobile broadcast, time information indicating frames of the mobile broadcast and the like. Here, the time information may be the aforementioned timestamp information. The timestamp information may generate a time base for providing additional services such as the interactive service.

A mobile device may receive the mobile broadcast. In the present embodiment, the mobile device may receive signaling information in addition to audio/video data. However, the mobile device may not receive information such as the signaling information from the beginning.

The mobile device may perform AV sharing with a fixed device such as a TV receiver. When AV sharing is performed, uncompressed audio/video data can be delivered from the mobile terminal to the TV receiver. That is, the signaling information received from the broadcaster may be excluded from this delivery procedure.

The TV receiver has received only the audio/video data. To acquire the signaling information that is not delivered to the TV receiver, the TV receiver may perform an ACR procedure. Here, it is assumed that the TV receiver has a watermark client inside/outside thereof. Since even the uncompressed audio/video data has the watermark inserted thereinto, the watermark client can extract the watermark. Accordingly, the TV receiver can acquire the URL of the signaling server, the content ID, the time information and the like.

The TV receiver may identify the mobile broadcast through the acquired content ID and time information (ACR). In addition, the TV receiver may access the signaling server using the acquired URL of the signaling server. The signaling server can provide the signaling information that is not received by the TV receiver. The signaling server may be the broadcaster or an entity operated by the broadcaster. Here, the TV receiver may transmit the content ID and time information to the signaling server to request signaling information. The signaling server may deliver signaling information corresponding to the corresponding mobile broadcast content to the TV receiver. The TV receiver may perform necessary operations using the signaling information.

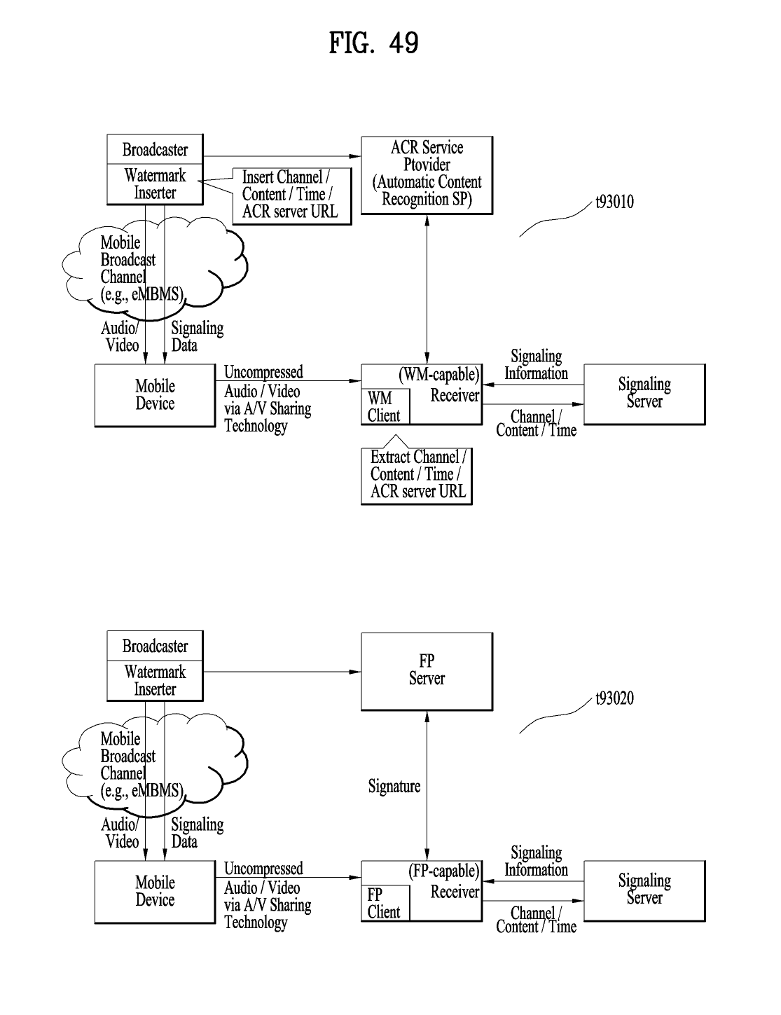

FIG. 49 illustrates an ACR procedure using a watermark/fingerprint in an AV sharing environment according to an embodiment of the present invention.

The first architecture t93010 may be a case in which information is indirectly inserted into a watermark. In this case, the watermark may have only the ID and signature information regarding frames of a mobile broadcast.

A procedure through which a broadcaster broadcasts the mobile broadcast having the watermark inserted thereinto and a mobile device delivers audio/video data of the mobile broadcast to a TV receiver through AV sharing is identical to the aforementioned procedure.

A watermark client of the TV receiver may extract the watermark. The TV receiver may transmit the ID included in the watermark to an ACR service provider. The TV receiver may request content confirmation through such transmission. The ACR service provider is an entity that provides ACR and may be the broadcaster or a separate entity according to embodiments. The broadcaster may deliver metadata about the mobile broadcast, the address of a signaling server and the like to the ACR service provider in real time.

The ACR service provider may recognize the mobile broadcast content currently played through the TV receiver according to AV sharing and deliver the address of the signaling server corresponding to the mobile broadcast content in response to the request from the TV receiver.

The TV receiver can access the signaling server using the delivered signaling server address, content ID and time information to acquire signaling information. This process has been described above. The ACR service provider and the signaling server may be integrated according to an embodiment. In this case, when the ACR service provider receives the ID from the TV receiver for ACR, the ACR service provider may directly deliver related signaling information to the TV receiver in response to the ID. When the ACR service provider serves as the signaling server, an additional signaling server may not be needed.

The second architecture t93020 may be a case in which a fingerprint is used.

The broadcaster may broadcast a mobile broadcast through a mobile broadcast network such as the aforementioned eMBMS. Here, the broadcaster or an additional entity may extract a signature from mobile broadcast content. The signature may be extracted per frame or for frames at specific intervals. The signature may be delivered to a fingerprint (FP) server. Metadata about the mobile broadcast, the address of a signaling server and the like may be delivered along with the signature to the FP server. Here, the signature may be called a fingerprint.

As in the aforementioned embodiment in which the watermark is described, the mobile device may receive the mobile broadcast and perform AV sharing with the TV receiver. Accordingly, the TV receiver can reproduce the mobile broadcast.

A fingerprint (FP) client of the TV receiver may extract the signature (fingerprint) per frame of the mobile broadcast content being reproduced or for frames at specific intervals. An extraction algorithm used here may be identical to an extraction algorithm used on the side of the broadcaster.

The TV receiver may transmit the extracted signatures to the FP server to request ACR. The FP server may recognize the mobile broadcast content currently reproduced in the TV receiver by comparing signatures stored in a fingerprint DB with the received signatures. The FP server may deliver the address of a signaling server related to the recognized mobile broadcast content to the TV receiver (responding).

The TV receiver may access the signaling server using the delivered signaling server address, content ID and time information to acquire signaling information. This process has been described above. The FP server and the signaling server may be integrated according to an embodiment. In this case, when the FP server receives the signatures from the TV receiver for ACR, the FP server may directly deliver related signaling information to the TV receiver in response to the signatures. When the FP server serves as the signaling server, an additional signaling server may not be needed.

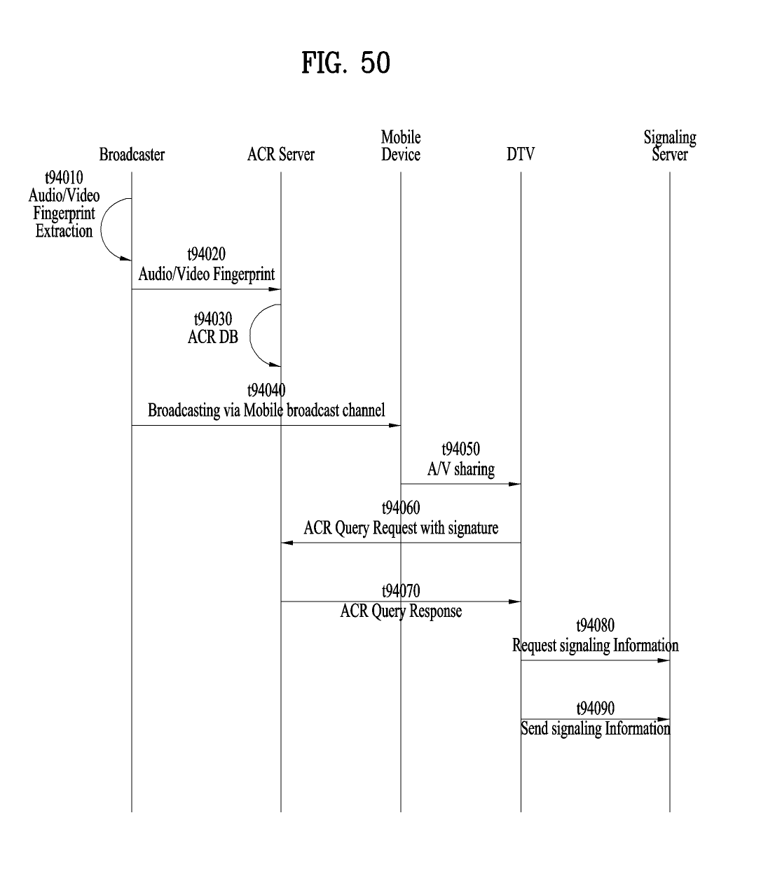

FIG. 50 is a diagram illustrating an ACR procedure using a fingerprint in an AV sharing environment according to an embodiment of the present invention.

The illustrated diagram illustrates the aforementioned architecture when the fingerprint is used in the AV sharing environment. Here, a fixed device is assumed to be a DTV. In addition, it is assumed that a mobile device and the DTV are paired at a specific time prior to AV sharing.

First, a broadcaster may extract a fingerprint per mobile broadcast content (program) using a tool provided by an ACR provider (t94010). The broadcaster may construct a fingerprint DB with respect to audio/video content. The broadcaster may extract and store two fingerprints with respect to audio and video components according to an embodiment.

The broadcaster may deliver extracted fingerprints to an ACR server (the aforementioned FP server or the like) (t94020). The broadcaster may deliver extracted fingerprints prior to transmission of mobile broadcast content in the case of previously produced content and deliver fingerprints to the ACR server in real time upon extraction of the fingerprints in the case of live content. In the case of live content, information for uniquely identifying the content needs to be previously provided, mapped to fingerprints and delivered to the ACR server when the fingerprints are delivered in real time. The ACR server may store the delivered fingerprints and/or content identification information mapped to the fingerprints in an additional ACR DB (t94030).

The broadcaster may broadcast mobile broadcast content to mobile devices through a mobile broadcast channel such as the eMBMS. A mobile device supporting mobile broadcast can receive the mobile broadcast content (t94030). The mobile device can perform AV sharing with a DTV corresponding to a fixed device using an AV sharing technique such as UPnP, DLNA, WiDi or Miracast (t94050).

The DTV may extract fingerprints from shared audio/video signals and send a query request to the ACR server (t94060). The ACR server may compare the received fingerprints with an ACR DB to find matching content. Upon recognition of the content, the ACR server may deliver channel information related to the content, the URL of a signaling server and the like to the DTV (t94070).

The DTV accesses the signaling server using the URL of the signaling server and requests signaling information (t94080). Here, channel information, content information, time information and the like may be used as parameters for request. The signaling server may deliver related signaling information to the DTV according to the parameters (t94090).

The signaling information acquired through the ACR procedure may be delivered to a mobile device having no ACR client according to an embodiment. In this case, the mobile device can perform additional operations with respect to mobile broadcast content reproduced therein using the signaling information. This embodiment may correspond to a case in which the mobile device does not receive the signaling information from the beginning due to mobile broadcast properties.

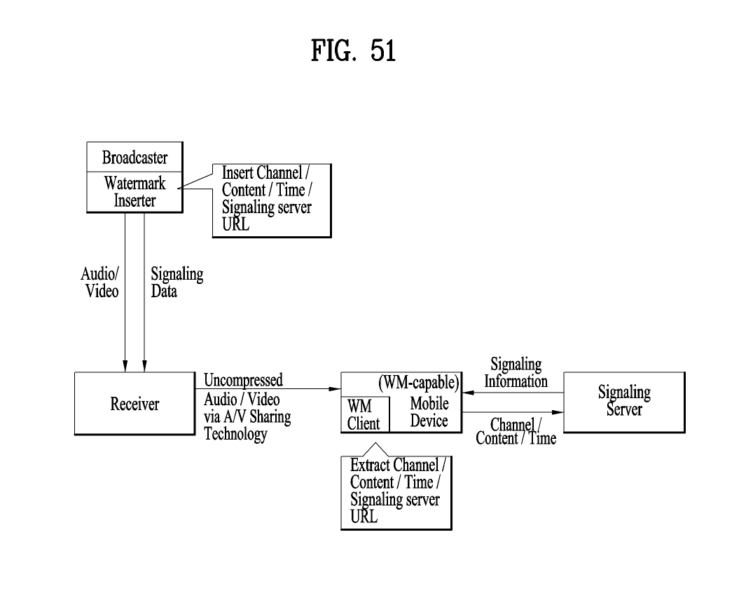

FIG. 51 illustrates an ACR procedure using a watermark in an AV sharing environment according to another embodiment of the present invention.

The situation in which the mobile device receiving mobile broadcast performs AV sharing of the mobile broadcast content with a fixed device has been described. Conversely, it is possible to perform AV sharing of broadcast content received through a fixed device with a mobile device. This is useful when a user intends to view a broadcast using a personal mobile device instead of a fixed device in a desired place.

As described above, only audio/video data can be delivered to the mobile device through AV sharing, and related signaling information and information about additional services may not be delivered to the mobile devices. In consideration of such an environment, when a mobile device has an ACR client, necessary signaling information may be acquired using the ACR client.

The illustrated architecture may be a case in which information is directly inserted into a watermark.

A broadcaster may broadcast broadcast content having a watermark inserted thereinto. A TV receiver may receive the broadcast content. Details of the watermark and insertion thereof have been described above. The TV receiver may perform AV sharing with a mobile terminal. It is assumed that the two devices have been paired prior to AV sharing.

The mobile device may reproduce uncompressed audio/video data delivered thereto. The mobile device may perform ACR using a watermark client inside/outside thereof. The mobile device may extract watermarks from the uncompressed audio/video data and acquire information of the watermarks. The procedure through which the mobile device acquires signaling information from a signaling server using the information of the watermarks has been described above.

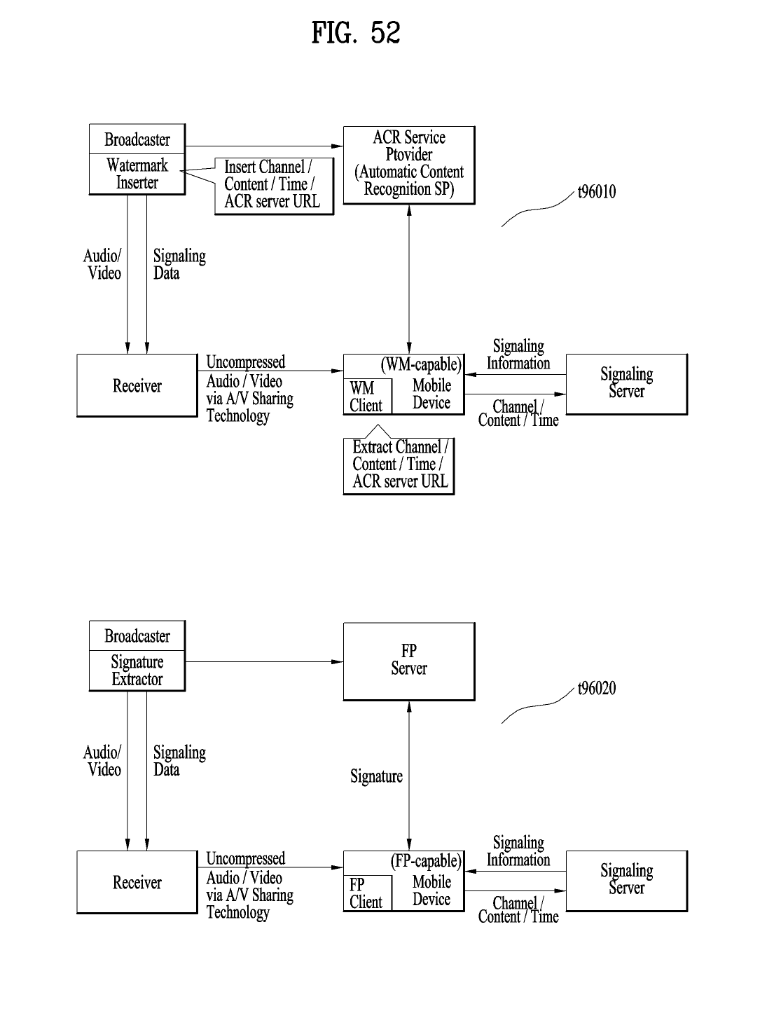

FIG. 52 illustrates an ACR procedure using a watermark/fingerprint in an AV sharing environment according to other embodiments of the present invention.

The illustrated embodiments may correspond to a case (t96010) in which information is indirectly inserted into a watermark and a case (t96020) in which a fingerprint is used. When a watermark is indirectly used, the watermark may include only an ID and signature information about mobile broadcast frames.

In the embodiments, details of the broadcaster, ACR service provider, signaling server and ACR client (watermark client and fingerprint client) are as described above. Operations using a watermark and a fingerprint according to the embodiments are as described above.

In this case, the roles of the TV receiver and the mobile device may be switched. That is, the mobile device can reproduce normal broadcast content received by the TV receiver through AV sharing. The mobile device can acquire additional information such as signaling information that is not received thereby through ACR using a watermark/fingerprint. Accordingly, the mobile device can also perform operations according to signaling information/additional information in addition to simple AV reproduction.

In this case, the ACR service provider or the FP server may serve as the signaling server.

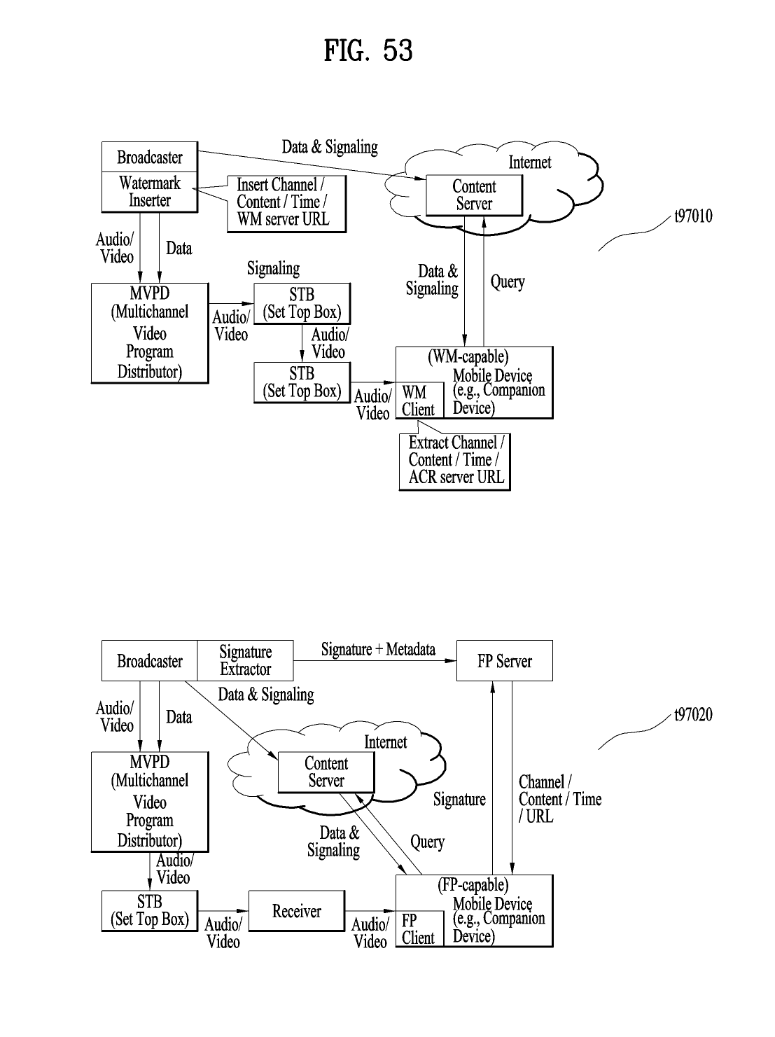

FIG. 53 illustrates an ACR procedure using a watermark/fingerprint in an AV sharing environment according to other embodiments of the present invention.

When a set-top box is used, the TV receiver can receive only audio/video data without signaling information from the beginning. That is, while broadcast content is received through MVPD or the like, signaling information or additional information may be excluded during delivery to the TV receiver through the set-top box.

In this case, a mobile device receives uncompressed audio/video data and performs ACR using a watermark or a fingerprint as in the above embodiments. In the illustrated embodiments (t97010 and t97020), the broadcaster, TV receiver, ACR client, mobile device and FP server are the same as those in the above embodiments. A content server may serve as the aforementioned ACR service provider.

In the present embodiments, the TV receiver also needs to receive signaling information. To this end, the mobile device may deliver signaling information obtained through ACR to the TV receiver. This is more useful when the TV receiver has no ACR client. When the TV receiver has an ACR client, the TV receiver may acquire signaling information by directly performing ACR. To prevent redundant operations, only one of two AV sharing devices may perform the ACR procedure and deliver acquired signaling information to the other device.

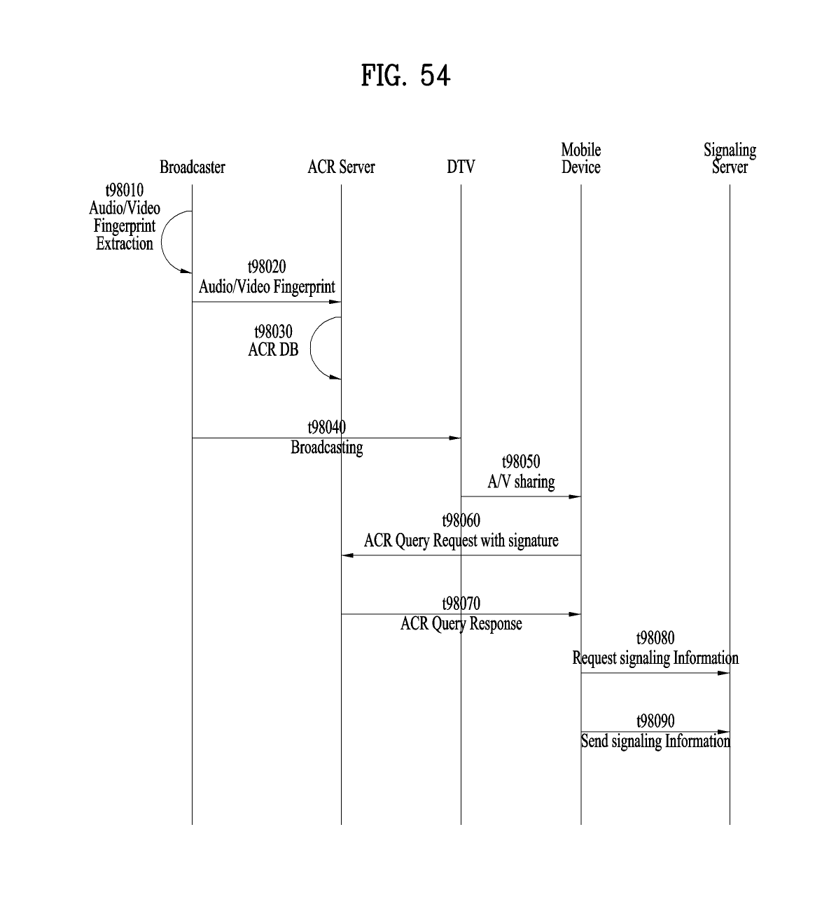

FIG. 54 is a diagram illustrating an ACR procedure using a fingerprint in an AV sharing environment according to another embodiment of the present invention.

The diagram illustrates the aforementioned architecture when a fingerprint is used in an AV sharing environment. Here, it is assumed that the fixed device is a DTV. In addition, it is assumed that a mobile device and the DTV have been paired prior to AV sharing.

The processes t98010 to t98030 in which the broadcaster extracts fingerprints and transmits the fingerprints to the ACR server and the ACR server stores the fingerprints in the DB are as described above. In the present embodiment, the broadcaster can broadcast a normal broadcast to the DTV (t98040).

The DTV may transmit uncompressed audio/video data to the mobile device through AV sharing (t98050) and the mobile device may reproduce the audio/video data and, simultaneously, extract fingerprints and send a request to the ACR server (t98060). The ACR server may transmit the address of a signaling server with respect to the reproduced normal broadcast to the mobile device at the request of the mobile device (t98070).

The mobile device accesses the signaling information and requests signaling information (t98080). Here, information for request may include channel information, content information and time information. The signaling server may deliver related signaling information to the mobile device according to the parameters (t98090).

The mobile device may send the information to a DTV having no ACR client according to an embodiment. In this case, the DTV can perform additional operations with respect to the reproduced broadcast content using the signaling information. This embodiment may correspond to a case in which the DTV receives the broadcast content through a set-to box and does not acquire the signaling information from the beginning.

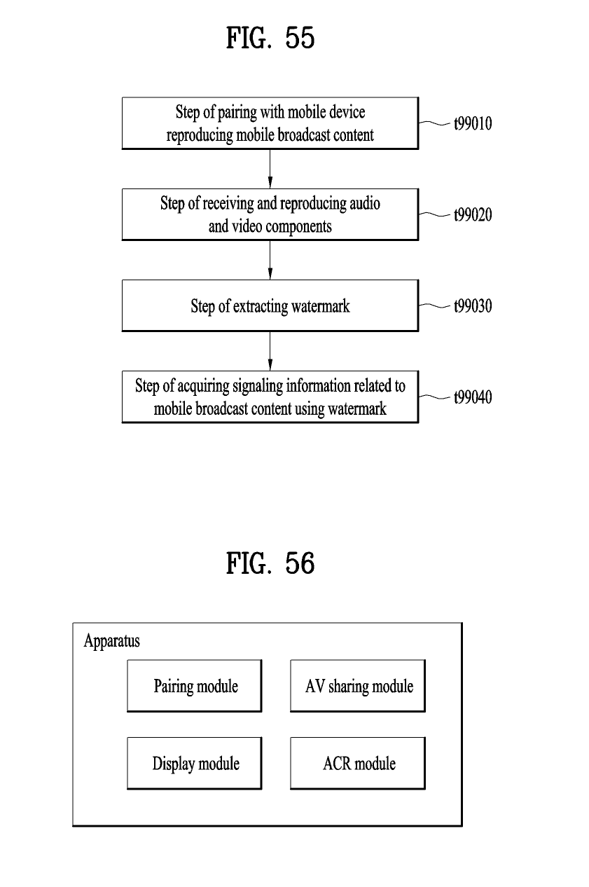

FIG. 55 illustrates a method for providing mobile broadcast services by a TV receiver according to an embodiment of the present invention.

The method for providing mobile broadcast services by the TV receiver according to an embodiment of the present invention may include the steps of pairing with a mobile device that is reproducing mobile broadcast content, receiving audio and video components of the mobile broadcast content from the mobile device and reproducing the audio and video components, extracting a watermark from the audio component or the video component and/or acquiring signaling information related to the mobile broadcast content using the watermark.

The TV receiver (receiver) may pair with the mobile device (t99010). Pairing may be performed by pairing modules included in the TV receiver and the mobile device. Then, the TV receiver may receive the audio and video components of the mobile broadcast content from the mobile device and reproduce the audio and video components (t99020). This corresponds to the aforementioned process of AV sharing the audio/video components of mobile broadcast content. This process may be performed by AV sharing modules included in the TV receiver and the mobile device. According to an embodiment, the AV sharing module may be the same as a pairing module. The operation of receiving the audio/video components may be performed by the AV sharing module and reproduced by a different module (e.g., display module).

The TV receiver may extract a watermark from the audio component or the video component (t99030). This operation may be performed by an ACR module included in the TV receiver. While the present embodiment corresponds to a case in which the TV receiver receives mobile broadcast content, the mobile device may receive normal broadcast content and perform ACR. In this case, an ACR module of the mobile device may perform ACR. ACR may be performed using a fingerprint instead of the watermark according to an embodiment. In this case, the fingerprint may be generated/extracted by the ACR module.

The TV receiver may acquire signaling information related to the received mobile broadcast content using the watermark (t99040). This operation may be performed by the ACR module or a separate network interface module.

In a method for providing mobile broadcast services by a TV receiver according to another embodiment of the present invention, a watermark may include URL information related to a signaling server. The URL information may be part of the URL of the signaling information for regenerating the URL of the signaling information. The present embodiment may correspond to a case in which the URL of the signaling server is directly inserted into the watermark. When the URL is segmented and transmitted through multiple watermarks as described above, such URL information may be combined to regenerate the URL of the signaling server. In this case, the step of acquiring the signaling information using the watermark may further include a step of generating the URL of the signaling server using the URL information. The process of generating the URL may be performed by the aforementioned ACR module.

In a method for providing mobile broadcast services by a TV receiver according to another embodiment of the present invention, the step of acquiring the signaling information using the watermark may further include a step of transmitting a request for signaling information to the signaling server and receiving the signaling information using the generated URL of the signaling server. This operation may be performed by the ACR module. Transmission and reception of the request may be performed by a separate network interface module.

In a method for providing mobile broadcast services by a TV receiver according to another embodiment of the present invention, the watermark may further include the ID of the mobile broadcast content and time information on a frame from which the watermark has been extracted. Here, the ID of the mobile broadcast content may be the aforementioned content ID and the time information may be a timestamp. The signaling information request may include the mobile broadcast content ID and time information.

In a method for providing mobile broadcast services by a TV receiver according to another embodiment of the present invention, the URL information included in the watermark may be a URL field corresponding to part of the signaling server URL or a URL protocol indicating a protocol used for the signaling server URL. Here, the URL field may correspond to the aforementioned URL field and the URL protocol may correspond to the aforementioned URL protocol field (URL protocol). When the watermark is delivered in this manner, a long URL can be efficiently delivered.

In a method for providing mobile broadcast services by a TV receiver according to another embodiment of the present invention, the signaling information may be information for providing interactive services with respect to the mobile broadcast content. The signaling information may be information for activation of app-based services related to the mobile broadcast content or events using a trigger for interactive service provision.

In a method for providing mobile broadcast services by a TV receiver according to another embodiment of the present invention, the time information may generate a time base for providing the interactive services with respect to the mobile broadcast content. Here, the time information is a time stamp and can generate a time base for synchronization of the interactive services with the mobile broadcast content according to an embodiment. In this case, the signaling information may be a time base trigger.

In a method for providing mobile broadcast services by a TV receiver according to another embodiment of the present invention, the watermark may include ID information for identifying a frame from which the watermark has been extracted, and the step of acquiring the signaling information using the watermark may further include a step of transmitting the ID information of the watermark to the ACR server and receiving the ID information. This process may correspond to a case in which information is not directly inserted into the watermark. In this case, the watermark may serve as a frame ID, as described above. In this case, the signaling server may be the ACR server. This process may be performed by the ACR module or the network interface module.

In a method for providing mobile broadcast services by a TV receiver according to another embodiment of the present invention, the acquired signaling information may be delivered to the mobile device again. This operation may be performed by the aforementioned pairing module or AV sharing module.

A description will be given of a method for providing broadcast services by a mobile device according to an embodiment of the present invention. This method is not illustrated.

The method for providing broadcast services by the mobile device according to an embodiment of the present invention may include the steps of pairing with a TV receiver, receiving audio/video components of broadcast content from the TV receiver and reproducing the audio/video components, extracting a watermark from the audio/video components and/or acquiring signaling information related to the broadcast content using the watermark.

In the present embodiment, the watermark may include URL information, content ID, time information of frames, a URL protocol field and the like as in the above embodiments. In addition, the ACR module included in the mobile device may regenerate the URL of the signaling server and request/receive signaling information. Furthermore, the acquired signaling information may be delivered to the TV receiver according to an embodiment.

The above-described steps may be omitted or replaced by other steps performing similar/identical operations according to embodiments.

FIG. 56 illustrates a broadcast reception apparatus providing mobile broadcast services according to an embodiment of the present invention.

The broadcast reception apparatus providing mobile broadcast services according to an embodiment of the present invention may include the aforementioned pairing module, AV sharing module, display module and/or ACR module. In addition, the broadcast reception apparatus may further include a network interface module according to an embodiment. The blocks and modules have been described above.

The broadcast reception apparatus providing mobile broadcast services according to an embodiment of the present invention and the internal modules/blocks thereof may perform the above-described embodiments of the method for providing mobile broadcast services by a TV receiver according to the present invention.

A description will be given of a mobile device providing broadcast services according to an embodiment of the present invention. The mobile device providing broadcast services according to an embodiment of the present invention is not illustrated.

The mobile device providing mobile broadcast services according to an embodiment of the present invention may include the aforementioned pairing module, AV sharing module, display module and/or ACR module. In addition, the mobile device may further include a network interface module according to an embodiment. The blocks and modules have been described above.

The mobile device providing mobile broadcast services according to an embodiment of the present invention and the internal modules/blocks thereof may perform the above-described embodiments of the method for providing mobile broadcast services by a mobile device according to the present invention.

The internal blocks/modules of the aforementioned broadcast reception apparatus and the mobile device may be processors that execute consecutive processes stored in a memory and may be hardware elements provided inside/outside of the apparatus/device according to an embodiment.

The aforementioned modules may be omitted or replaced by other modules performing similar/identical operations.

The module or unit may be one or more processors designed to execute a series of execution steps stored in the memory (or the storage unit). Each step described in the above-mentioned embodiments may be implemented by hardware and/or processors. Each module, each block, and/or each unit described in the above-mentioned embodiments may be realized by hardware or processor. In addition, the above-mentioned methods of the present invention may be realized by codes written in recoding media configured to be read by a processor so that the codes can be read by the processor supplied from the apparatus.

Although the description of the present invention is explained with reference to each of the accompanying drawings for clarity, it is possible to design new embodiment(s) by merging the embodiments shown in the accompanying drawings with each other. And, if a recording medium readable by a computer, in which programs for executing the embodiments mentioned in the foregoing description are recorded, is designed in necessity of those skilled in the art, it may belong to the scope of the appended claims and their equivalents.

An apparatus and method according to the present invention may be non-limited by the configurations and methods of the embodiments mentioned in the foregoing description. And, the embodiments mentioned in the foregoing description can be configured in a manner of being selectively combined with one another entirely or in part to enable various modifications.

In addition, a method according to the present invention can be implemented with processor-readable codes in a processor-readable recording medium provided to a network device. The processor-readable medium may include all kinds of recording devices capable of storing data readable by a processor. The processor-readable medium may include one of ROM, RAM, CD-ROM, magnetic tapes, floppy discs, optical data storage devices, and the like for example and also include such a carrier-wave type implementation as a transmission via Internet. Furthermore, as the processor-readable recording medium is distributed to a computer system connected via network, processor-readable codes can be saved and executed according to a distributive system.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

Both the product invention and the process invention are described in the specification and the description of both inventions may be supplementarily applied as needed.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

### MODE FOR INVENTION

Various embodiments have been described in the best mode for carrying out the invention.

### INDUSTRIAL APPLICABILITY

The embodiments of the present invention are available in a series of broadcast signal provision fields.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A method for providing mobile broadcast services by a TV receiver, comprising:
pairing with a mobile device reproducing mobile broadcast content;
receiving audio and video components of the mobile broadcast content from the mobile device and reproducing the audio and video components;
extracting a watermark from the audio component or the video component; and
acquiring signaling information related to the mobile broadcast content using the watermark.

2. The method according to claim 1, wherein the watermark includes URL information related to a signaling server, and
wherein the acquiring of the signaling information using the watermark comprises generating a URL of the signaling server using the URL information.

3. The method according to claim 2, wherein the acquiring of the signaling information using the watermark comprises:
transmitting a request for signaling information to the signaling server using the generated URL of the signaling server; and
receiving the signaling information from the signaling server.

4. The method according to claim 3, wherein the watermark further includes an ID of the mobile broadest content and time information on a frame from which the watermark has been extracted,
wherein the request for the signaling information includes the ID of the mobile broadcast content and the time information.

5. The method according to claim 2, wherein the URL information of the watermark is a URL field corresponding to part of the signaling server URL or a URL protocol field indicating a protocol used for the signaling server URL.

6. The method according to claim 1, wherein the signaling information is information for providing interactive services with respect to the mobile broadcast content.

7. The method according to claim 4, wherein the time information generates a time base for providing the interactive services with respect to the mobile broadcast content.

8. The method according to claim 1, wherein the watermark includes ID information for identifying a frame from which the watermark has been extracted, and
wherein the acquiring of the signaling information using the watermark comprises:
transmitting the ID information of the watermark to an auto content recognition (ACR) server; and
receiving signaling information related to the mobile broadcast content from the ACR server.

9. The method according to claim 1, further comprising delivering the acquired signaling information to the mobile device.

10. A broadcast reception apparatus comprising:
a pairing module for pairing with a mobile device reproducing mobile broadcast content;
an AV sharing module for receiving audio and video components of the mobile broadcast content from the mobile device;
a display module for reproducing the received audio and video components; and
an ACR module for extracting a watermark from the audio component or the video component,
wherein the ACR module acquires signaling information related to the mobile broadcast content using the watermark.

11. The broadcast reception apparatus according to claim 10, wherein the watermark includes URL information related to a signaling server, and
wherein the ACR module generates a URL of the signaling server using the URL information.

12. The broadcast reception apparatus according to claim 11, wherein the ACR module transmits a request for signaling information to the signaling server using the generated URL of the signaling server and receives the signaling information from the signaling server.

13. The broadcast reception apparatus according to claim 12, wherein the watermark further includes an ID of the mobile broadcast content and time information on a frame from which the watermark has been extracted,
wherein the request for the signaling information includes the ID of the mobile broadcast content and the time information.

14. The broadcast reception apparatus according to claim 11, wherein the URL information of the watermark is a URL field corresponding to part of the signaling server URL or a URL protocol field indicating a protocol used for the signaling server URL.

15. The broadcast reception apparatus according to claim 10, wherein the signaling information is information for providing interactive services with respect to the mobile broadcast content.

16. The broadcast reception apparatus according to claim 13, wherein the time information generates a time base for providing the interactive services with respect to the mobile broadcast content.

17. The broadcast reception apparatus according to claim 10, wherein the watermark includes ID information for identifying a frame from which the watermark has been extracted, and
wherein the ACR module transmits the ID information of the watermark to an auto content recognition (ACR) server and receives signaling information related to the mobile broadcast content from the ACR server.

18. The broadcast reception apparatus according to claim 10, wherein the pairing module delivers the acquired signaling information to the mobile device.
